(19) United States
(12) Patent Application Publication
(10) Pub. No.: US 2012/0227733 A1
(43) Pub. Date: Sep. 13, 2012

(54) HYDROLYSIS SYSTEMS AND METHODS

(75) Inventors: Aharon Meir Eyal, Jerusalem (IL); Robert P. Jansen, Collinsville, IL (US)

(73) Assignee: HCL Clean Tech Ltd. a corporation

(21) Appl. No.: 13/320,535

(22) PCT Filed: Oct. 24, 2011
(86) PCT No.: PCT/US2011/057552

§ 371 Date: Jan. 10, 2012

Related U.S. Application Data
(60) Provisional application No. 61/483,777, filed on May 9, 2011.
(60) Provisional application No. 61/487,319, filed on May 18, 2011.
(60) Provisional application No. 61/545,823, filed on Oct. 11, 2011.

(30) Foreign Application Priority Data
Oct. 24, 2010 (IL) 208901
Feb. 2, 2011 (IL) 211020

(51) Int. Cl. C13K 13/00; B01J 19/00

(52) U.S. Cl. 127/1; 127/37

(57) ABSTRACT

A hydrolysis system comprising: (a) a reactor vessel including a sprinkler at an upper portion thereof and a drain; (b) a pump re-circulating a flow of an acidic reaction liquid from a selected height in said vessel to said sprinkler; (c) an acid supply mechanism delivering a supply of HCl at a concentration≧39% to a lower portion of said reactor vessel; and (d) a flow splitter diverting a portion of the acidic reaction liquid so that a level of liquid in the vessel remains in a predetermined range.

### RELATED APPLICATIONS

In accord with the provisions of 35 U.S.C. §119(e) and §363, this application claims the benefit of:

U.S. 61/483,777 filed May 9, 2011 by Robert JANSEN et al. and entitled “HYDROLYSIS SYSTEMS AND METHODS”; and

U.S. 61/487,319 filed May 18, 2011 by Robert JANSEN et al. and entitled “HYDROLYSIS SYSTEMS AND METHODS”;

U.S. 61/545,823 filed Oct. 11, 2011 by Robert JANSEN et al. and entitled “HYDROLYSIS SYSTEMS AND METHODS”;

each of which is fully incorporated herein by reference; and

In accord with the provisions of 35 U.S.C. §119(a) and/or §365(b), this application claims priority from:

Prior Israeli application IL 208901 filed on 24 Oct. 2010 by Robert JANSEN et al. and entitled “A METHOD FOR THE PRODUCTION OF CARBOHYDRATES” and

Prior Israeli application IL 211020 filed on Feb. 2, 2011 by Robert JANSEN et al. and entitled “A METHOD FOR TREATING A LIGNIN STREAM”;

each of which is fully incorporated herein by reference.

This application is also related to the following co-pending applications, each of which is fully incorporated herein by reference:

Prior PCT application IL2011/000424 filed on Jun. 1, 2011 by Robert JANSEN et al. and entitled “LIGNIN COMPOSITIONS, SYSTEMS AND METHODS FOR PROCESSING LIGNIN AND/OR HCl”

Prior PCT application IL2011/000509 filed on Jun. 26, 2011 by Aharon EYAL et al. and entitled “SUGAR MIXTURES AND METHODS FOR PRODUCTION AND USE THEREOF”;

Prior PCT application IL2011/000517 filed on Jun. 28, 2011 by Aharon EYAL et al. and entitled “METHODS AND SYSTEMS FOR PROCESSING A SUCROSE CROP AND SUGAR MIXTURES”;

Prior PCT application US2011/46153 filed on Aug. 1, 2011 by Robert JANSEN et al. and entitled “METHODS AND SYSTEMS FOR SOLVENT PURIFICATION”;

Prior PCT Application US2011/50435 filed on Sep. 2, 2011 by Robert JANSEN et al. and entitled “METHODS AND SYSTEMS FOR PROCESSING SUGAR MIXTURES AND RESULTANT COMPOSITIONS”

IL209912 filed on Dec. 9, 2010 by Aharon EYAL et al. and entitled “A METHOD FOR TREATING A LIGNOCELLULOSIC FEED CONTAINING ASH AND FATTY ACID”;

U.S. 61/524,350 filed on Aug. 17, 2011 by Aharon EYAL et al. and entitled “METHODS AND SYSTEMS FOR PROCESSING LIGNOCELLULOSIC MATERIALS”;

U.S. 61/528,257 filed on Aug. 28, 2011 by Aharon EYAL et al. and entitled “METHODS AND SYSTEMS FOR PROCESSING LIGNOCELLULOSIC MATERIALS”

U.S. 61/539,196 filed on Sep. 26, 2011 by Aharon EYAL et al. and entitled “METHODS AND SYSTEMS FOR PROCESSING LIGNOCELLULOSIC MATERIALS”;

U.S. 61/539,239 filed on Sep. 26, 2011 by Aharon EYAL et al. and entitled “METHODS AND SYSTEMS FOR PROCESSING LIGNOCELLULOSIC MATERIALS”

U.S. 61/539,272 filed on Sep. 26, 2011 by Aharon EYAL et al. and entitled “METHODS AND SYSTEMS FOR PROCESSING LIGNOCELLULOSIC MATERIALS”

### FIELD OF THE INVENTION

This invention relates to hydrolysis systems and methods to release soluble sugars from insoluble carbohydrate polymers.

### BACKGROUND OF THE INVENTION

Currently, about 100 million tons of carbohydrates are fermented annually to provide fuel-grade ethanol.

Millions of tons of carbohydrates are also fermented every year to provide food and feed products, such as citric acid and lysine. In addition, carbohydrates can be fermented to industrial products, such as monomers for the polymer industry, e.g. lactic acid for the production of polylactide.

Carbohydrates are an attractive and environment-friendly substrate since they are obtained from renewable resources. For example sucrose can be produced from sugar canes and glucose can be produced from corn and wheat starches.

However, sugar cane, corn and wheat are produced primarily for human consumption and/or as livestock feed. Increased consumption by industry may impact food costs.

However, many renewable non-food resources are potential sources of soluble carbohydrates. The renewable non-food resources can generally be described as cellulose sources. Cellulose sources include “woody materials” or “lignocellulosic materials” such as wood and by-products of wood processing (e.g. sawdust, shavings) as well as residual plant material from agricultural products. Celluloses sources also include previously processed materials (e.g. paper and cardboard) as well as grasses and leaves.

Residual plant material from agricultural products includes processing by-products and field remains.

Processing by-products includes, but is not limited to, corn cobs, sugar cane bagasse, sugar beet pulp, empty fruit bunches from palm oil production, straw (e.g. wheat or rice), soy bean hulls, residual meals from the vegetable oil industry (e.g. soybean, peanut, corn or rapeseed) wheat bran and fermentation residue from the beer and wine industries.

Field remains includes, but is not limited to, corn stover, post-harvest cotton plants, post-harvest soybean bushes and post-harvest rapeseed plants.

Woody materials also include “energy crops” such as switch grass, which grow rapid and generate low-cost biomass specifically as a source of carbohydrates.

These carbohydrate sources contain cellulose, hemicellulose and lignin as their main components and are also referred to as lignocellulosic material. These carbohydrate sources also contain mineral salts (ashes) and organic compounds, such as tall oils. The degree and type of these non-carbohydrate materials can create technical problems in production of soluble carbohydrates.

Lignocellulosic materials typically contain 65-80% cellulose and hemicelluloses on a dry matter basis. Cellulose and hemicellulose are polysaccharides which can release carbohydrates suitable for fermentation and/or chemical conversion to products of interest if they are hydrolyzed. Lignin is typically resistant to acid hydrolysis.

Hemicellulose is a source of pentoses (e.g. xylose). Cellulose (typically more than 50% of total polysaccharides) is a source of hexoses (e.g. glucose).

Although conversion of lignocellulosic material to carbohydrates via enzyme-catalyzed and/or acid-catalyzed hydrolysis of polysaccharides and pyrolysis has been previously described, industrial scale application of the proposed technologies has presented technical problems which remain to be overcome.

Potential downstream applications of soluble carbohydrates include, but are not limited to, production of bio-fuels (e.g. ethanol), use in the food industry (e.g. conversion of sugars such as glucose and xylose to their corresponding alcohols (sorbitol and xylitol respectively) for use as sweeteners) and industrially useful monomers.

### SUMMARY OF THE INVENTION

One aspect of some embodiments of the invention relates to acid hydrolysis of a cellulose substrate, optionally a “woody material”, in a reaction vessel employing “trickling bed” recirculation of acid on the substrate. In some embodiments, hydrolysis is conducted on a continuous flow of substrate introduced into the vessel.

Another aspect of some embodiments of the invention relates to a reaction vessel having a concurrent flow of acid and substrate in an upper portion and a countercurrent flow of acid and substrate in a lower portion. In some exemplary embodiments of the invention, the countercurrent flow is achieved by introducing concentrated acid at a bottom end of the vessel and withdrawing liquid hydrolyzate for recirculation at a point above the bottom of the vessel. Varying relative sizes of the concurrent and countercurrent portions of the vessel by adjusting a height at which liquid hydrolyzate is withdrawn for recirculation produces additional embodiments of the invention.

In some embodiments, the vessel is divided into two zones by a line through the point above the bottom of the vessel at which liquid hydrolyzate is withdrawn for recirculation. Optionally, little, or even substantially no, liquid crosses this line.

In some exemplary embodiments of the invention, trickling bed recirculation of acid contributes to a lower residence time of acid in the system and/or contributes to an increase in sugar yield per unit of acid introduced into the system. The term “trickling bed” as used in this specification and the accompanying claims refers to movement of a liquid through a bed of substrate particles (e.g. wood chips or other divided solid substrate) while the substrate particles are not submerged in the liquid. In many cases the movement of liquid through the substrate is downwards. According to various exemplary embodiments of the invention, the divided solid substrate can have a greatest dimension of ≦1, ≦1.5, ≦2, ≦2.5 or ≦3 cm. In some embodiments, reduction in greatest dimension contributes to ease of handling Optionally, this ease of handling contributes to compatibility with selected equipment.

In some exemplary embodiments of the invention, recirculation includes removal of a portion of the reaction liquid from the reaction vessel and re-introduction to the vessel as drops above the substrate. According to various exemplary embodiments of the invention the reaction liquid includes less than 10%, less than 5% or less than 2% solids. In some exemplary embodiments of the invention, reduction of a percentage of solids in the reaction liquid when it is removed as hydrolyzate contributes to a reduction of residence time of solids in the reaction vessel.

Alternatively or additionally, recirculation includes removal of a lignin fraction from the reaction vessel and downstream processing of the lignin to recover acid trapped therein. In some exemplary embodiments of the invention, acid recovered from the lignin fraction can be re-introduced to the vessel as drops above the substrate and/or sent to an absorber to generate concentrated HCl.

Alternatively or additionally, recirculation includes downstream processing of the liquid hydrolyzate fraction to recover sugars and yield re-generated acid. In some exemplary embodiments of the invention, acid re-generated from the liquid hydrolyzate fraction can be routed to an absorber to generate concentrated HCl.

According to various exemplary embodiments of the invention concentrated HCl contains ≧39%, in some embodiments ≧40%, in some embodiments ≧41%, in some embodiments ≧42%, in some embodiments ≧45% of HCl/[HCl+water] on a weight basis.

In some exemplary embodiments of the invention, a lignocellulosic substrate is subject to hydration prior to introduction into the reaction vessel. This hydration can be, for example, with liquid hydrolyzate diverted from a re-cycling loop in the reaction vessel. In some exemplary embodiments of the invention, hydration causes a pre-hydrolysis of the substrate. This pre-hydrolysis can release sugars such as xylose, arabinose and mannose from hemicellulose. In some exemplary embodiments of the invention, pre-hydrolysis reduces a residence time of pentoses. According to exemplary embodiments of the invention the liquid hydrolyzate fraction can be routed to downstream processing to recover sugars, such as pentoses and/or hexoses.

In other exemplary embodiments of the invention, hydration occurs in the reactor vessel. In some embodiments, a residence time of solids in the vessel is extended to permit this hydration. According to various exemplary embodiments of the invention this extension can be 1, 2, 3 or 4 hours or intermediate or greater times.

As used herein, the terms “soluble carbohydrates” and “soluble sugars” or grammatical variants thereof are to be taken as specifying monomeric sugars (e.g. glucose, mannose, xylose, arabinose, fructose or galactose) as well dimeric sugars, (e.g. sucrose and lactose), and oligosaccharides up to a degree of polymerization of 10 (e.g., trisaccharides, tetrasaccharides, pentasaccharides and others up to and including decasaccharides) of various degrees of polymerization and combinations thereof. Substantially all such oligomers are water soluble and/or soluble under the acidic condition present in systems and apparatus according to various exemplary embodiments of the invention.

“Soluble”, as used in this context refers to solubility in the acidic reaction liquid which eventually is harvested as liquid hydrolyzate. The liquid hydrolyzate produced according to exemplary systems and methods described herein includes one or more of glucose, mannose, xylose, galactose, arabinose, oligomers thereof and combinations thereof. The exact composition of the hydrolyzate can vary with substrate and/or hydrolysis conditions.

The following description refers to “reaction liquid” and “liquid hydrolyzate”. It is to be appreciated that the “reaction liquid” at various places in the described apparatus and system includes varying amounts of hydrolysis products. Every attempt has been made to use the term “liquid hydrolyzate” to indicate those flow streams which remove a portion of the reaction liquid out of the described system and/or apparatus for downstream processing, however, the distinction between “reaction liquid” and “liquid hydrolyzate” is, to a certain degree, a matter of perception.

As used in this specification and the accompanying claims the term the term “available” in the contexts of sugars in general, a subset of sugaR (e.g. pentoses) or a specific sugaR (e.g. xylose) indicates a theoretical yield based upon knowledge of substrate composition. Sugars which are present as part of a polymeR (e.g. cellulose) are “available” for liberation by hydrolysis and/or removal from the reaction vessel.

One aspect of some embodiments of the invention relates to implementation of a counter current flow plan in which an acid hydrolysis reagent has a shorter residence time in the system than a solid hydrolysis substrate.

Another aspect of some embodiments of the invention relates to formation of an acid concentration gradient in the hydrolysis system. In some exemplary embodiments of the invention, the portion of the substrate most resistant to hydrolysis is exposed to the highest concentration of acid. According to some embodiments, exposure of the resistant portion of the substrate to ≧42% HCl contributes to increased total sugar yields. Alternatively or additionally, the portion of the substrate most resistant to hydrolysis is exposed to the acid for the longest time. According to some embodiments, the substrate encounters progressively more concentrated acid as the amount of time it has been in the system increases.

Another aspect of some embodiments of the invention relates to formation of a gradient of soluble sugars in the hydrolysis system. In some exemplary embodiments of the invention, the sugars accumulate in a portion of the system, where acid concentrations are relatively low (e.g. 37, 35, 33, 32, 31 or 30% or intermediate or lower percentages). In some exemplary embodiments of the invention, accumulation of high concentrations of sugars in relatively low acid concentrations contributes to a reduction in unwanted sugar degradation. In many cases the sugars include monomeric and oligomeric sugars.

Another aspect of some embodiments of the invention relates to implementation of a temperature gradient in the hydrolysis system. In some exemplary embodiments of the invention, ≧42% HCl is cooled to 17, 15 or 12° C. or intermediate or lower temperatures. These relatively low temperatures contribute to a reduction in unwanted sugar degradation in the upstream portion of the system where the acid concentration is high. In some exemplary embodiments of the invention, relatively dilute HCl (e.g. 30%) is allowed to reach temperatures of 20° C. to 25° C., for example 22° C., in downstream portions (with respect to sugars) of the system where sugar concentrations are high. In some embodiments of the invention, this higher temperature improves system performance by contributing to a reduction in viscosity. Alternatively or additionally, operation of the system at relatively low temperatures contributes to a reduction in problems associated with acid fumes. Reducing the temperature in a portion of the system by as little as 10 degrees or even as little as 5 degrees, contributes significantly to a reduction in problems associated with acid fumes.

Another aspect of some embodiments of the invention relates to implementation of trickling bed recirculation of acid on the hydrolysis substrate. In some exemplary embodiments of the invention, trickling bed recirculation of acid contributes to a lower residence time of dissolved sugars in the system and/or contributes to an increase in sugar yield per unit of acid introduced into the system. The term “trickling bed” as used in this specification and the accompanying claims refers to downward movement of a liquid through a bed of substrate particles (e.g. wood chips). On many described embodiments the liquid is re-circulated through the bed.

One aspect of some embodiments of the invention relates to management of temperature during acid hydrolysis. In some exemplary embodiments of the invention, a temperature gradient is applied to a lignocellulosic substrate during hydrolysis. In some embodiments, two temperature gradients are applied.

One aspect of some embodiments of the invention relates to reducing residence time of a liquid hydrolyzate and/or residence time of a solid substrate in an acid hydrolysis system. In some exemplary embodiments of the invention, a lignin rich residue is removed from the reactor less than 20, less than 18, less than 16, less than 14, less than 12, less than 10 hours, or even less than 8 hours after a lignocellulosic substrate is introduced into the reactor. In some exemplary embodiments of the invention, the substrate spends ≧20, ≧25, ≧30, ≧35, or even ≧40% of its total residence time in a trickling bed portion of the reactor. Alternatively or additionally, in some exemplary embodiments of the invention, the lignocellulosic substrate spends ≦60, ≦65, ≦70, ≦75, or ≦% of its total residence time submerged in a liquid hydrolysis medium. Alternatively or additionally, according to various embodiments of the invention ≧10, ≧20, ≧30, ≧40, ≧50, ≧60, ≧70, ≧80, or ≧90%, or intermediate percentages of the height of the reactor is devoted to the trickling bed portion of the hydrolysis treatment.

One aspect of some embodiments of the invention relates to mechanically propelling a lignin substrate upwards through a downward flowing acidic medium. In some exemplary embodiments of the invention, the lignin substrate contains cellulose. In some embodiments of the invention, at least a portion of the cellulose is hydrolyzed by the acidic medium. In some exemplary embodiments of the invention, the acidic medium is provided as a recycled aqueous stream of HCl.

One aspect of some embodiments of the invention relates to propelling a lignin containing substrate upwards through a layer of liquid comprising an S1 solvent.

As used in this specification and the accompanying claims the term “S1” or “S1 solvent” indicates a solvent characterized by a water solubility of less than 15% wt. Alternatively or additionally, the solubility of water in S1 is less than about 20% wt. As used herein, the solubility is measured by the percent weight ratio (wt %) and determined by combining at 25° C. an essentially pure solvent and de-ionized water, and measuring the wt % of the solvent dissolved in the water, or water dissolved in the solvent.

S1 solvents are further characterized by at least one of a delta-P between 5 and 10 MPa^{1/2}, and a delta-H defined hereinbelow between about 5 and 20 MPa^{1/2}.

Delta-P is the polarity related component of Hoy's cohesion parameter and delta-His the hydrogen bonding related component of Hoy's cohesion parameter.

The cohesion parameter, or, solubility parameter, was defined by Hildebrand as the square root of the cohesive energy density:

$$δ = \sqrt{\frac{Δ {E}_{vap}}{V}}$$

where ΔEvap and V are the energy or heat of vaporization and molar volume of the liquid, respectively. Hansen extended the original Hildebrand parameter to a three-dimensional cohesion parameter. According to this concept, the total solubility parameter, delta, is separated into three different components, or, partial solubility parameters relating to the specific intermolecular interactions:

δ²=δ_{d}²+δₚ²+δₕ²

in which delta-D, delta-P and delta-H are the dispersion, polarity, and hydrogen bonding components, respectively. Hoy proposed a system to estimate total and partial solubility parameters. The unit used for those parameters is MPa^{1/2}. A detailed explanation of that parameter and its components can be found in “CRC Handbook of Solubility Parameters and Other Cohesion Parameters”, second edition, pages 122-138. That and other references provide tables with the parameters for many compounds. In addition, methods for calculating those parameters are provided.

According to an exemplary embodiment, the boiling point of S1 is greater than 100° C., greater than 120° C., greater than 140° C., or greater than 160° C. at atmospheric pressure. Alternatively or additionally, the boiling point of S1 can be lower than 250° C., lower than 220° C. or lower than 200° C. at atmospheric pressure.

According to an exemplary embodiment, S1 forms with water a heterogeneous azeotrope. According to a related embodiment, in the heterogeneous azeotrope with water, the first organic solvent to water weight/weight ratio is in the range between 50 and 0.02, or between 5 and 0.2, or between 4 and 0.25, or between 3 and 0.3 or between 2 and 0.5. According to an exemplary embodiment, the boiling point of that heterogeneous azeotrope at atmospheric pressure is less than 100° C.

According to an exemplary embodiment S1 is selected from the group consisting of aliphatic or aromatic alcohols, ketones and aldehydes having at least 5 carbon atoms, e.g. various pentanols, hexanols, heptanols, octanols, nonanols, decanols, methyl-isobutyl-ketone and methyl-butyl-ketone and combinations thereof. As used here, the term alcohols means any of mono-, di- and poly-alcohols, primary, secondary and tertiary ones, straight chain and branched alcohols and any combination of those. According to an exemplary embodiment, S1 is selected from hexanol and 2-ethyl-1-hexanol and a mixture thereof.

In some exemplary embodiments of the invention, the layer of liquid comprising the S1 solvent strips HCl off of the lignin. In some embodiments of the invention, the stripped HCl migrates downwards.

In some exemplary embodiments of the invention, the lignin substrate moves upwards through a headspace above the layer of liquid comprising the S1 solvent. In some embodiments of the invention, liquid containing S1 solvent drains back down from the headspace to the layer of liquid comprising the S1 solvent. In some exemplary embodiments of the invention, the layer of liquid comprising the S1 solvent is not diminished over time. In other exemplary embodiments of the invention, the layer of liquid comprising the S1 solvent is slightly diminished over time and S1 solvent is added to maintain the layer.

In some exemplary embodiments of the invention, HCl and residuals sugars flow from a vessel in which the lignin is mechanically propelled upwards to a countercurrent hydrolysis reactor.

One aspect of some embodiments of the invention relates to use of an S1 solvent to separate lignin from HCl. In some exemplary embodiments of the invention, the S1 solvent includes hexanol and/or 2-ethyl-1-hexanol.

Another aspect of some embodiments of the invention relates to causing lignin to flow through a cushion of S1 containing liquid. The liquid may contain water and/or HCl.

It will be appreciated that the various aspects described above relate to solution of technical problems related to realizing a high yield of soluble sugars in a usable form from the acid hydrolysis reaction.

Alternatively or additionally, it will be appreciated that the various aspects described above relate to solution of technical problems related to recycling of HCl in the context of an industrial plant hydrolyzing lignocellulose.

In some exemplary embodiments of the invention, there is provided a hydrolysis system including: (a) a reactor vessel including a sprinkler at an upper portion thereof and a drain; (b) a pump re-circulating a flow of an acidic reaction liquid from a selected height in the vessel to the sprinkler; (c) an acid supply mechanism delivering a supply of HCl at a concentration≧39% to a lower portion of the reactor vessel; and (d) a flow splitter diverting a portion of the acidic reaction liquid so that a level of liquid in the vessel remains within a predetermined range.

Optionally, the system includes a substrate delivery module delivering a hydrolysis substrate to the vessel.

Optionally, the system includes a cooling module to cool the supply of HCl. Optionally, the cooling module cools the supply of HCl to ≦18° C.

Optionally, the system includes a controller adapted to maintain a maximum temperature in the vessel in a predetermined range.

Optionally, the predetermined range includes only temperatures≧20° C.

In some exemplary embodiments of the invention, there is provided a hydrolysis method including: (a) placing a hydrolysis substrate comprising cellulose in a reactor vessel; (b) removing at least 90% of available sugars in said substrate from said vessel in solution with a residence time≦16 hours.

Optionally, the method includes removing residual solids from the vessel with an average residence time≦14 hours.

Optionally, the method includes removing ≧90% of available pentoses in the hydrolysis substrate intact.

Optionally, the method includes removing ≧50% of available glucose in the substrate from the vessel with a residence time≦6 hours.

In some exemplary embodiments of the invention, there is provided an apparatus including: (a) a reactor vessel comprising a sprinkler at an upper portion thereof; (b) a substrate delivery module adapted to deliver a hydrolysis substrate to the vessel; (c) a recirculation pump configured to provide a flow of acidic reaction liquid from a single selected height in the vessel to the sprinkler; and (d) a drain.

Optionally, the apparatus includes an acid delivery system configured to deliver a stream of concentrated HCl to a lower portion of the vessel.

In some exemplary embodiments of the invention, there is provided an apparatus comprising:

(a) a reactor vessel comprising a substrate delivery module adapted to deliver a hydrolysis substrate to an upper portion of the vessel; (b) an acid delivery system configured to deliver a stream of concentrated HCl to a lower portion of the vessel; (c) a recirculation pump configured to provide a flow of acidic reaction liquid from a single selected height in the vessel to a location in the upper portion of the vessel; and (d) a drain.

In some embodiments, the flow from the recirculation pump is directed to a sprinkler.

Optionally, the apparatus includes a flow splitter which directs a portion of the flow to a downstream processing module.

Optionally, the apparatus includes a cooling module adapted to cool the stream of concentrated HCl.

Optionally, the cooling module is adapted to cool the stream of HCl to ≦18° C.

Optionally, the cooling module is adapted to cool the stream of HCl to ≦15° C.

Optionally, the drain includes a drainage flow regulator.

Optionally, the drainage flow regulator provides a constant outlet flow from the drain.

Optionally, the drainage flow regulator provides an intermittent outlet flow from the drain.

Optionally, the acid delivery system comprises an inlet port at the lower portion.

Optionally, the inlet port includes an inlet flow regulator.

Optionally, the inlet flow regulator provides a constant inlet flow to the vessel.

Optionally, the inlet flow regulator provides an intermittent inlet flow to the vessel.

Optionally, the apparatus includes a controller adapted to regulate the substrate delivery module and the drain to maintain an amount of substrate in the vessel in a pre-determined range.

Optionally, the apparatus includes a controller adapted to maintain a maximum temperature in the vessel in a predetermined range.

Optionally, the predetermined range includes only temperatures≧20° C.

Optionally, the predetermined range includes only temperatures≦50° C.

Optionally, the apparatus includes an upstream hydration module.

In some embodiments, the hydration module is adapted for pre-hydrolysis of a substrate introduced therein.

Optionally, the hydration module is adapted for harvest of hemicellulose sugars released by the pre-hydrolysis.

Optionally, the apparatus includes a substrate controller adapted to control a flow of substrate through the hydration module and the reactor vessel.

Optionally, the apparatus includes an acid flow controller adapted to control a flow of liquid through and between the hydration module and the reactor vessel.

In some exemplary embodiments of the invention, there is provided a hydrolysis method including: (a) moving a hydrolysis substrate through a reactor vessel in a first direction; (b) applying a stream of concentrated HCl, flowing in an opposite direction, so as to flow through a first portion of the substrate to produce an acidic reaction liquid; and (c) re-circulating at least a portion of the acidic reaction liquid through a second portion of the substrate in the first direction.

Some embodiments of the method include, maintaining the second portion of the substrate at a temperature≧20° C.

Some embodiments of the method include, maintaining a temperature of the second portion of the substrate at a temperature≦50° C.

Some embodiments of the method include, cooling the stream of concentrated HCl to a temperature≦15° C.

Optionally, the substrate comprises lignin, and the method includes removing a lignin rich residue from the vessel.

Some embodiments of the method include, routing a portion of the acidic reaction liquid to downstream processing.

Some embodiments of the method include, withdrawing the at least a portion of the acidic reaction liquid from a selected height in the reaction vessel.

Some embodiments of the method include, generating the stream of concentrated HCl by contacting recycled HCl vapors with a recycled liquid stream comprising HCl.

Optionally, the re-circulating creates a trickling bed in at least a portion of the substrate in at least a portion of said substrate in the vessel.

Some embodiments of the method include, regulating a flow of the lignin rich residue.

Optionally, the regulating provides a flow selected from the group consisting of a constant flow and an intermittent flow.

Optionally, the applying of the stream of concentrated HCl occurs via an inlet port at a lower portion of the vessel.

Some embodiments of the method include, controlling the moving of the hydrolysis substrate through the reactor vessel and the removing of a lignin rich residue to maintain an amount of substrate in the vessel in a pre-determined range.

Some embodiments of the method include, hydrating the hydrolysis substrate prior to the moving.

Optionally, the hydrating causes pre-hydrolysis of hemicellulose in the substrate.

Some embodiments of the method include, processing of at least a portion of hemicellulose sugars from the pre-hydrolysis of hemicellulose.

Some embodiments of the method include, controlling a flow of the substrate through the hydration module and the reactor vessel in a coordinated manner

Some embodiments of the method include, controlling a flow of liquid hydrolyzate through and between the hydration module and the reactor vessel in a coordinated manner

Optionally, the stream of concentrated HCl includes acid recovered from the lignin rich residue.

In some exemplary embodiments of the invention, there is provided a method for production of water soluble carbohydrates including: (a) providing a plurality of X reactors (R) in a nominal sequence R(1). R(X) each containing an amount of solids (F) comprising water insoluble polysaccharides (IPS) and a volume of an HCl-comprising liquid (L); (b) hydrolyzing at least a portion of IPS in each of the reactors R(1). R(X) by means of the liquid L to produce an acidic reaction liquid containing water soluble carbohydrates (CH) and residual solids; (c) harvesting at least a portion of CH and L from R(X); (d) transferring at least a portion of CH and L from each of reactors R(1) to R(X−1) to reactors R(2) to R(X) respectively; (e) introducing an additional volume of L into R1; (f) reassigning R(1) to position X in the nominal sequence and reassigning each of R(X) to R(2) to positions (X−1) to 1 respectively in the nominal sequence; and (g) introducing an additional amount of F into R situated in position X.

Some embodiments of the method include, harvesting any solid residue which remains after the solids have progressed sequentially through the reactors from R(X) to R(1).

Some embodiments of the method include, iteratively repeating (d) to (g).

Optionally, the hydrolyzing is conducted for at least 1 hour.

Optionally, the hydrolyzing is conducted for not more than 10 hours.

Optionally, the hydrolyzing is conducted for 3.5 to 4.5 hours.

Optionally, the introducing of L is conducted by applying drops of the HCl-comprising liquid onto F.

In some embodiments of the method, L is recycled through F during the hydrolyzing.

Optionally, the recycling is conducted by applying drops of the HCl-comprising liquid onto F. Optionally, the drops create a trickling bed effect.

Optionally, at least one of the reactors contains L:F at a weight ratio greater than 3 at some point during the hydrolyzing.

Optionally, at least one of R contains L characterized by HCl:(HCl+water) weight ratio≧0.35.

Optionally, the solid residue is characterized by HCl:(HCl+water) weight ratio≧0.40.

Optionally, a CH:solids ratio in the solid residue is ≦0.03 on a weight basis.

Optionally, the hydrolyzing is conducted at a temperature of less than 50° C. throughout all X reactors (R).

Optionally, the hydrolyzing in reactor X is conducted at a temperature≦50° C.

Optionally, the hydrolyzing in reactor 1 is conducted at a temperature below 20° C.

Optionally, there is a gradient of increasing hydrolysis temperatures from R1 to RX.

Optionally, at the end of at least x iterative repetitions, a ratio of CH:(CH+water) in the hydrolyzate in at least one of the reactors is at least 0.20 by weight.

In some exemplary embodiments of the invention, a ratio of CH:furfural is at least 30 on a weight basis in the at least a portion of CH and L harvested from R(X).

In some embodiments, X is less than 15.

In some embodiments, X is greater than 2.

Optionally, X is 3 to 8. Optionally X is 4.

Some embodiments of the method include, using CH and L from R(X) to hydrate the additional amount of F prior to the introducing.

Optionally, a residence time of L is shorter than a residence time of Lignin.

In some exemplary embodiments of the invention, there is provided a system comprising: (a) an acid reservoir; (b) a plurality of X reactors R placed in positions 1 . . . X, each R including an inlet port, an outlet port and a recirculation mechanism; (c) channels of fluid communication arranged to conduct a liquid from the outlet port of one reactor to the inlet port of a different reactor; and (d) a controller adapted to: (i) periodically empty a liquid content of R(X) from its outlet port, and empty liquid contents of R(1) to R(X−1) from their outlet ports and direct the contents to inlet ports of R(2) to R(X) respectively and introduce new acid to the R(1) inlet port; (ii) occasionally move R(1) to position X, and each of R(X). R(2) to positions (X−1) . . . 1 respectively; and (iii) operate the recirculation mechanisms.

Optionally, all of the parts are resistant to 42% HCl.

Optionally, the system includes a solids hopper adapted to deliver solids to R(X).

In some embodiments, the recirculation mechanism includes a sprinkler.

In some embodiments, the system includes a pretreatment vessel adapted for solvent extraction.

In some embodiments, the system includes a hydration vessel adapted for hydration of solids.

Optionally, each of the reactors is characterized by an aspect ratio height:diameter of 4.5 to 5.5.

In some exemplary embodiments of the invention, there is provided a method for production of water soluble carbohydrates including: (a) providing a plurality of X reactors (R) in a nominal sequence R(1) . . . R(X); (b) causing solids (F) comprising water insoluble polysaccharides (IPS) to progress sequentially from R(X) . . . R(1); and (c) causing an HCl-comprising liquid (L) to progress sequentially from R(1) . . . R(X); wherein a rate of progression of L is greater than a rate of progression of F.

In some embodiments, the method includes (d) periodically harvesting at least a portion of water soluble carbohydrates (CH) and L from R(X); (e) periodically transferring at least a portion of CH and L from each of reactors R(1) to R(X−1) to reactors R(2) to R(X) respectively; and (f) introducing an additional volume of L into R1.

In some embodiments, the method includes harvesting any solid residue which remains after the solids have progressed sequentially through the reactors from R(X) to R(1).

In some embodiments, the method includes: iteratively repeating (d) to (f).

In some embodiments, the method includes: reassigning R(1) to position X in the nominal sequence and reassigning each of R(X) to R(2) to positions (X−1) to 1 respectively in the nominal sequence and introducing an additional amount of F into R situated in position X.

In some exemplary embodiments of the invention, there is provided a method comprising: (a) delivering a lignin stream comprising solid lignin in the range of 3% to 30% wt through at least one opening in a lower part of a first reactor; (b) moving the solid lignin upwards towards at least one opening in an upper part of the first reactor; (c) applying a countercurrent flow of recycled HCl to the solid lignin in the lower part of the first reactor; (d) contacting the solid lignin with a light organic liquid phase comprising an S1 solvent, water and HCl in the upper part of the first reactor; and (e) removing at least a fraction of a heavy liquid phase from the bottom portion of the first reactor and at least a portion of the solid lignin from the upper portion of the first reactor.

In some embodiments, the method includes draining at least a portion of the light organic liquid phase from the solid lignin prior to the removing.

In some embodiments, the method includes generating the lignin stream by:

hydrolyzing a lignocellulosic feed in at least one second reactor.

Optionally, the heavy liquid phase comprises HCl/water at a weight/weight ratio greater than 0.5.

Optionally, a weight ratio of carbohydrates to lignin in the removed solid lignin is less than 90% of a same ratio in the delivered lignin stream.

In some embodiments, the hydrolyzing comprises contacting the lignocellulosic feed with a hydrolysis medium in at least one second reactor in a countercurrent mode.

Optionally, the lignocellulosic feed moves down and the hydrolysis medium moves up in the at least one second reactor.

In some embodiments, the method includes using at least a fraction of the removed heavy liquid phase in the hydrolysis medium.

In some embodiments, the method includes de-acidifying the removed solid lignin.

In some embodiments, the method includes conducting the de-acidifying at a pressure greater than 0.7 bar and at a temperature lower than 140° C.

In some embodiments, the method includes de-solventizing the removed solid lignin. In some embodiments, the method includes conducting the de-solventizing at a pressure greater than 0.7 bar and at a temperature lower than 140° C.

An apparatus comprising: (a) a lignin wash vessel comprising a lignin lifting mechanism adapted to convey solid lignin from a lignin introduction port to a lignin evacuation port; (b) a lignin delivery mechanism adapted to convey a lignin stream including the solid lignin into the wash vessel via the lignin introduction port; (c) an acid wash mechanism adapted to cause an acidic wash stream to flow from an acid introduction port to a drain; and (d) a solvent wash layer comprising an S1 solvent above the acid introduction port and below the lignin evacuation port.

In some embodiments, the apparatus is provided as part of a system including a hydrolysis reactor adapted to provide the lignin stream to the lignin delivery mechanism.

In some embodiments, the system includes a recirculation pump which conveys an effluent from the drain to a recirculation port in the hydrolysis reactor.

In some embodiments, the hydrolysis reactor includes a feed mechanism adapted to deliver a lignocellulosic substrate thereto.

In some embodiments, the hydrolysis reactor includes a hydrolysis medium supply mechanism adapted to deliver a flow of ≧35% HCl thereto.

In some exemplary embodiments of the invention, there is provided a hydrolysis method including: (a) moving a hydrolysis substrate downwards through an upper zone and a lower zone of a reactor vessel with a flow rate Fₛ; (b) delivering a stream of concentrated HCl at a temperature≦15° C. to the lower zone so that the stream forms an upwards flowing acidic reaction liquid; and (c) re-circulating at least a portion of the acidic reaction liquid downwards though the substrate in the upper zone with a flow rate faster than Fₛ.

In some exemplary embodiments of the invention, there is provided a hydrolysis method including: (a) delivering a stream of concentrated HCl at a temperature≦15° C. to a lower zone of a reaction vessel; (b) removing HCl liquid at a temperature≧15° C. from a selected height in the vessel; and (c) re-circulating the HCl liquid at a temperature≧15° C. downwards though substrate in an upper zone of the vessel, with a downward flow rate faster than that of the substrate.

In some embodiments, the method includes maintaining a maximum temperature in the vessel in a predetermined range.

In some embodiments, the method includes maintaining a maximum temperature in the vessel ≧20° C.

In some embodiments, the method includes maintaining a maximum temperature in the vessel ≦50° C.

In some embodiments, the method includes removing a portion of the liquid to maintain a residence time (RT) of the liquid in the vessel ≦16 hours.

In some embodiments, the method includes removing a portion of the liquid to maintain a residence time (RT) of the liquid in the vessel ≦14 hours.

In some embodiments, the method includes removing a portion of the liquid to maintain a residence time (RT) of the liquid in the vessel ≦12 hours

In some embodiments, the method includes removing a portion of the liquid to maintain a residence time (RT) of the liquid in the vessel ≦10 hours

In some embodiments, the method includes removing a portion of the liquid to maintain a residence time (RT) of the liquid in the vessel ≦8 hours

In some embodiments, the method includes removing a portion of the liquid to maintain a residence time (RT) of the liquid in the vessel ≦7 hours.

In some embodiments, a residence time (RT) of the liquid in the lower portion (i.e. at or below line S-S) of the vessel is ≦8 hours.

In some embodiments, a residence time (RT) of the liquid in the lower portion of the vessel is ≦7 hours.

In some embodiments, a residence time (RT) of the liquid in the lower portion of the vessel is ≦6 hours.

In some embodiments, the method includes configuring the reactor vessel so that the upper zone occupies ≧50% of a total volume of the reaction vessel.

In some embodiments, the method includes configuring the reactor vessel so that the upper zone occupies ≦50% of a total volume of the reaction vessel.

In some embodiments, the re-circulating is at a rate of ≧80 liters/minute/square meter of an upper surface of the substrate in the upper zone.

In some embodiments, the re-circulating is at a rate of ≧100 liters/minute/square meter of an upper surface of the substrate in the upper zone.

Alternatively or additionally, in some embodiments, the re-circulating is at a rate of ≦120 liters/minute/square meter of an upper surface of the substrate in the upper zone. In some embodiments, the re-circulating is at a rate of ≦110 liters/minute/square meter of an upper surface of the substrate in the upper zone.

Optionally the re-circulating is at a rate of about 108 liters/minute/square meter of an upper surface of the substrate in the upper zone.

In some embodiments, the method includes maintaining a height of the substrate in the lower zone at ≧0.25 of a total substrate height in the reaction vessel.

In some embodiments, the method includes maintaining a height of the substrate in the lower zone at ≧0.35 of a total substrate height in the reaction vessel.

In some embodiments, the method includes maintaining a height of the substrate in the lower zone at ≧0.45 of a total substrate height in the reaction vessel.

In some embodiments, the method includes maintaining a height of the substrate in the lower zone at ≧0.55 of a total substrate height in the reaction vessel.

In some embodiments, the method includes maintaining a height of the substrate in the lower zone at ≦0.75 of a total substrate height in the reaction vessel.

In some embodiments, the method includes maintaining a height of the substrate in the lower zone at ≦0.60 of a total substrate height in the reaction vessel.

In some embodiments, the method includes maintaining a height of the substrate in the lower zone at ≦0.45 of a total substrate height in the reaction vessel. In some embodiments, the method includes maintaining a height of the substrate in the lower zone at ≦0.33 of a total substrate height in the reaction vessel.

In some exemplary embodiments of the invention, there is provided an apparatus including: (a) a cap module adapted to receive a lignocellulosic substrate; (b) a zone interface module including an effluent port; (c) at least one spacer module; and (d) a base module comprising an acid introduction port and a drain; wherein each of the modules is adapted to form an acid impervious connection with an adjacent module.

Optionally, the zone interface module comprises a filtration unit adapted to filter a liquid flowing towards the effluent port.

Optionally, the filtration media lumen comprises filtration media with a molecular weight cutoff≦500 kDa.

Optionally, the cap module is adapted to receive a flow of re-circulated acid.

Optionally, the cap module comprises a sprinkler.

Optionally, the at least one spacer module includes at least two spacer modules.

In some embodiments, acid impervious connection includes contact between flanges provided on the adjacent modules.

Optionally, the flanges comprise corresponding holes adapted to receive connectors.

Optionally, there is a gasket between the flanges.

Optionally, the flanges comprise interlocking surface features.

In some exemplary embodiments of the invention, there is provided a hydrolysis method comprising: (a) placing a hydrolysis substrate comprising hemicellulose in a reactor vessel; and (b) removing at least 90% of available hemicellulose sugars from the vessel in solution with a residence time≦4 hours.

In some exemplary embodiments of the invention, there is provided a hydrolysis method comprising: hydrolyzing a cellulose containing substrate to produce a sugar mixture having less than 100,000 ppm furfural or other sugar degradation products prior to subsequent purification.

According to various exemplary embodiments of the invention the level of furfural or other sugar degradation products prior to subsequent purification is 80,000; 70,000; 60,000; 50,000; 40,000; 30,000; 20,000; 10,000; 5,000; 1,000; 500 or 100 PPM or lower or intermediate concentrations.

In some embodiments, these methods are performed in a reaction vessel without a heater.

In some exemplary embodiments of the invention, there is provided a hydrolyzate including hemicellulose derived sugars as well as furfurals or other sugar degradation products at a concentration≦100,000 ppm.

According to various exemplary embodiments of the invention the level of furfural or other sugar degradation products in the hydrolyzate is 80,000; 70,000; 60,000; 50,000; 40,000; 30,000; 20,000; 10,000; 5,000; 1,000; 500 or 100 PPM or lower or intermediate concentrations.

In some embodiments, the hydrolyzate includes at least one member selected from the group consisting of an acid, an enzyme, and a solvent.

In some exemplary embodiments of the invention, there is provided a method for the high-yield production of carbohydrates from insoluble polysaccharides comprising:

(a) providing a plurality of x reactors R(n), . . . R(n+x−1) ordered in a cyclic sequential order, having a changeable nominal first reactor in the reactor sequence along the cyclic order, wherein x is a predetermined number of reactors and n is a designation of the nominal first reactor, wherein each of the R comprises:

(i) solids designated F(n) . . . F(n+x−1) containing hydrolyzable insoluble polysaccharides designated as IPS(n) . . . IPS(n+x−1) respectively,

(ii) HCl-comprising liquids designated L(n) . . . L(n+x−1) respectively,

(b) performing a reaction step comprising

(i) contacting liquids L(n) . . . L(n+x−1) with the solids F(n) . . . F(n+x−1), in each of the reactors, whereby fractions of the IPS are hydrolyzed into soluble carbohydrates designated CH(n+1), . . . CH(n+x), forming new liquids designated L(n+1), . . . L(n+x), containing less than 2% wt solids, the new liquids comprising hydrochloric acid and the soluble carbohydrates CH(n+1), . . . CH(n+x), and forming new solids designated F1(n−1), . . . F1(n+x−2) in each of the reactors R(n), . . . R(n+x−1), respectively, wherein the new solids comprise insoluble polysaccharides designated IPS1(n−1), . . . IPS1 (n+x−2), respectively;

(c) separating L(n+1) . . . L(n+x) from R(n) . . . R(n+x−1), respectively

(d) removing the solids F1(n−1) from R(n), thereby forming removed solids;

(e) removing the separated new liquids L(n+x) from R(n+x−1) thereby forming a carbohydrate-containing hydrolyzate product and optionally separating carbohydrate from the hydrolyzate product

(f) introducing a new HCl comprising liquid L(n) into the reactor R(n+1) newly designated as new first sequential reactor R1(n) and introducing the separated liquid aliquots L(n+1), . . . L(n+x−1) according to the cyclic order, into the reactors R(n+2), . . . R(n+x−2) and R(n) newly designated as reactors R1(n+1), . . . R1(n+x−1) and R1(n+x−1), respectively;

(g) introducing additional solid designated F1(n+x−1) into the reactor in the cyclic sequence newly designated reactor R1(n+x−1), wherein F1(n+x−1) comprises at least 5% weight solid, the solid containing insoluble hydrolyzable polysaccharides designated as IPS1(n+x−1) and

(h) optionally repeating b;

wherein:

at the end of at least x reactions (b) the weight amounts of insoluble polysaccharides in the reactors are in the sequence IPS1 (n−1)<=IPS1 (n)<= . . . <=IPS1 (n+x−1) and;

wherein at the end of at least x reactions (b), the net weight ratio of the amount of insoluble polysaccharides in IPS1(n+x−1) relative to the amount in IPS1(n−1) is greater than 10.

Optionally, introducing to at least one of the reactors generates an up flow.

Optionally, introducing to at least one of the reactors generates a down flow.

Optionally, the introducing is drop wise. In some exemplary embodiments of the invention, drop-wise introduction contributes to formation of a trickling bed.

Optionally, the method is characterized by liquid total residence time of less than 20 hours.

Optionally, the method is characterized by carbohydrates total residence time of less than 30 hours.

Optionally, the new solid-containing medium comprises lignin, characterized by lignin total residence time of less than 30 hours.

Optionally, the contacting is for a residence time of at least 1 hour.

Optionally, the contacting is for a residence time of not more than 10 hours.

Optionally, the contacting comprises at least one of recycling of the liquid aliquot through the respective reactor, mixing, filtering and centrifugation.

Optionally, the contacting comprises recycling of the liquid through a respective reactor and wherein the recycling is at a rate of 2 to 40, optionally 4 to 32, optionally 8 to 24 ml per square centimeter of cross sectional area per minute.

Optionally, the separating comprises at least one of filtering and centrifuging.

Optionally, during the contacting in at least one of the reactors, the weight ratio between the introduced HCl-comprising liquid and the solid content of the reactor is larger than 3.

Optionally, during the contacting in at least one of the reactors, a top end of the solid is higher than a top end of the liquid.

Optionally, during the contacting in at least one of the reactors, less than 50% of the solid is covered with liquid, optionally less than 40%, optionally less than 20%.

Optionally, the weight/weight ratio of HCl:(HCl+water) in at least one introduced HCl-comprising liquid is at least 0.35.

Optionally, the weight/weight ratio of HCl:(HCl+water) in the removed solid is at least 0.40.

Optionally, the weight/weight ratio of carbohydrates to solids in the removed solid is less than 0.03.

Optionally, the contacting is conducted at a temperature of less than 25° C.

Optionally, the contacting in reactor R(n+x−1) is conducted at a temperature lower than contacting in reactor R(n).

Optionally, the contacting in reactor R(n+x−1) is conducted at a temperature below 18° C., optionally below 15° C., optionally below 13° C.

Optionally, the contacting in reactor R(n) is conducted at a temperature above 16° C., optionally above 18° C., optionally above 20° C.

Optionally, at the end of at least x reaction steps, in the hydrolyzate, the weight/weight ratio of total carbohydrates to (total carbohydrates+water) is at least 0.20.

Optionally, degradation of carbohydrates to hydroxymethyl furfural takes place and wherein, at the end of at least x reaction steps, in the hydrolyzate, the weight/weight ratio of total carbohydrates to hydroxymethylfurfural.

Optionally, degradation of carbohydrates to furfural takes place and wherein, at the end of at least x reaction steps, in the hydrolyzate, the weight/weight ratio of total carbohydrates to furfural is at least 30.

Optionally, the ratio between IPS1 (n−1) and IPS1(n) is in the range between 0.95 and 1.0.

Optionally, after at least x reaction steps the difference between CH(n+x−1) and CH(n+x) is greater than the difference between IPS1(n+x−1) and IPS1(n+x).

Optionally, after at least x reaction steps, for at least one reactors pair {R(n+t), R(n+t+1)}, wherein t ranges from 0 to x−2, the difference between CH (n+t) and CH (n+t+1) is greater than the difference between IPS1(n+t) and IPS (n+t+1)

Optionally, at the end of at least x reaction steps, the amounts of HCl (in the respective liquid aliquot L (n+1) . . . L (n+x−1) is according to the sequence HCl (n+1)>=HCl (n+2)>= . . . >=HCl (n+x−1).

Optionally, at the end of at least x reaction steps, the amounts of carbohydrates in the respective liquid aliquot L (n+1) . . . L (n+x−1) is according to the sequence CH (n+1)<=CH (n+2)<= . . . <=CH (n+x−1)

Optionally, the number of reactors, x, is less than 15.

Optionally, the number of reactors, x, is more than 3.

Optionally, the removed solid has a solid content in the range between 5% wt and 50% wt.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative as opposed limiting.

The phrase “adapted to” as used in this specification and the accompanying claims imposes additional structural limitations on a previously recited component.

As used herein, the terms “comprising” and “including” or grammatical variants thereof are to be taken as specifying inclusion of the stated features, integers, actions or components without precluding the addition of one or more additional features, integers, actions, components or groups thereof.

Percentages (%) of chemicals typically supplied as powders or crystals (e.g. sugars) are W/W (weight per weight) unless otherwise indicated. Percentages (%) of chemicals typically supplied as liquids (e.g. hexanol) are W/W (weight per weight) unless otherwise indicated. HCl concentrations are expressed as HCl/[HCl+water] unless otherwise indicated.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a schematic diagram of a hydrolysis apparatus according to some exemplary embodiments of the invention in cross section;

FIG. 2 is a schematic diagram of a hydration module according to some exemplary embodiments of the invention;

FIG. 3 is a schematic system overview diagram indicating exemplary liquid and solid flows in a system according to some exemplary embodiments of the invention;

FIGS. 4a and 4b are simplified flow diagrams illustrating methods according to some exemplary embodiments of the invention.

FIG. 5a is a flow plan illustrating the introduction of various aliquot into a plurality of reactors;

FIG. 5b is a flow plan illustrating separation of a new aliquot and the removal of products;

FIG. 5c is a flow plan illustrating the introduction of various new aliquots into a plurality of re-designated reactors;

FIGS. 6a, 6b, 6c and 6d are schematic representations of a system according to exemplary embodiments of the invention in various stages of operation;

FIGS. 7a, 7b and 7c are schematic representations of various configurations of a trickling bed reactor suitable for use in some embodiments of the invention;

FIG. 8 is a schematic representation of a system according to exemplary embodiments of the invention including control components;

FIG. 9 is a simplified flow diagram depicting methods according to some embodiments of the invention;

FIG. 10 is a simplified flow diagram depicting methods according to some embodiments of the invention;

FIG. 11 is a schematic diagram of a system according to some exemplary embodiments of the invention;

FIG. 12 is a simplified flow diagram depicting methods according to some embodiments of the invention;

FIG. 13 is a simplified flow diagram depicting methods according to some embodiments of the invention;

FIG. 14 is a plot of sugar concentration as a function of time during hydrolysis of wood in 35% HCl indicating sugars in solution (right vertical axis) and sugars associated with the solid wood (left vertical axis);

FIG. 15 is a plot of un-hydrolyzed sugar concentration as a function of time during hydrolysis of wood in 42% HCl for wood “as is” and wood pre-hydrolyzed in 35% HCl;

FIG. 16 is a plot of un-hydrolyzed sugar concentration as a function of time (left vertical axis) and furfurals concentration in solution (right vertical axis) during hydrolysis of wood in 35% HCl for wood “as is”;

FIG. 17 is an exploded cross sectional view of a hydrolysis reactor vessel according to some exemplary embodiments of the invention;

FIGS. 18a and 18b are schematic representations of exemplary assembly options for a hydrolysis reactor of the type depicted in FIG. 17;

FIG. 19 is a schematic representation of an exemplary implementation strategy for implementation of a trickling bed strategy in a simulated moving bed reactor;

FIGS. 20a, 20b and 20c are schematic cross-sectional representations of exemplary flange configurations according to various exemplary embodiments of the invention;

FIG. 21 is a simplified flow diagram depicting methods according to some embodiments of the invention; and

FIGS. 22a and 22b are a simplified flow diagram illustrating methods according some exemplary embodiments of the invention.

### DETAILED DESCRIPTION OF EMBODIMENTS

Embodiments of the invention relate to hydrolysis systems and methods.

Specifically, some embodiments of the invention can be used to produce soluble sugars from a lignocellulosic substrate (e.g. wood).

The principles and operation of a method and/or system according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways.

In exemplary embodiments of the invention, a lignocellulosic material is provided as a substrate from which soluble carbohydrates are released. The lignocellulosic material comprises hydrolyzable, typically water-immiscible, polysaccharides, mainly cellulose and hemicellulose, lignin and other components.

Any lignocellulosic material is suitable, including softwood, hardwood, agricultural residues, such as corn stover and corn cobs, sugarcane bagasse and oil palm empty fruit bunches, energy crops and recycled waste such as recycled paper.

According to an exemplary embodiment, the polysaccharide comprises hemicellulose and the hemicellulose forms 5%; 10% or 15% or more of the lignocellulosic material feed.

Production of carbohydrates from the lignocellulosic material, e.g. for fermentation, requires hydrolysis of these insoluble polysaccharides. Various methods of hydrolyzing are known, using acid catalysis, enzymatic catalysis and combinations thereof. According to various exemplary embodiments of the invention hydrolysis of polysaccharides is by means of concentrated hydrochloric acid, optionally “fuming hydrochloric acid” i.e. aqueous solutions of >35% HCl, or >38% HCl or even >40% HCl.

Overview of Exemplary Continuous Flow Apparatus:

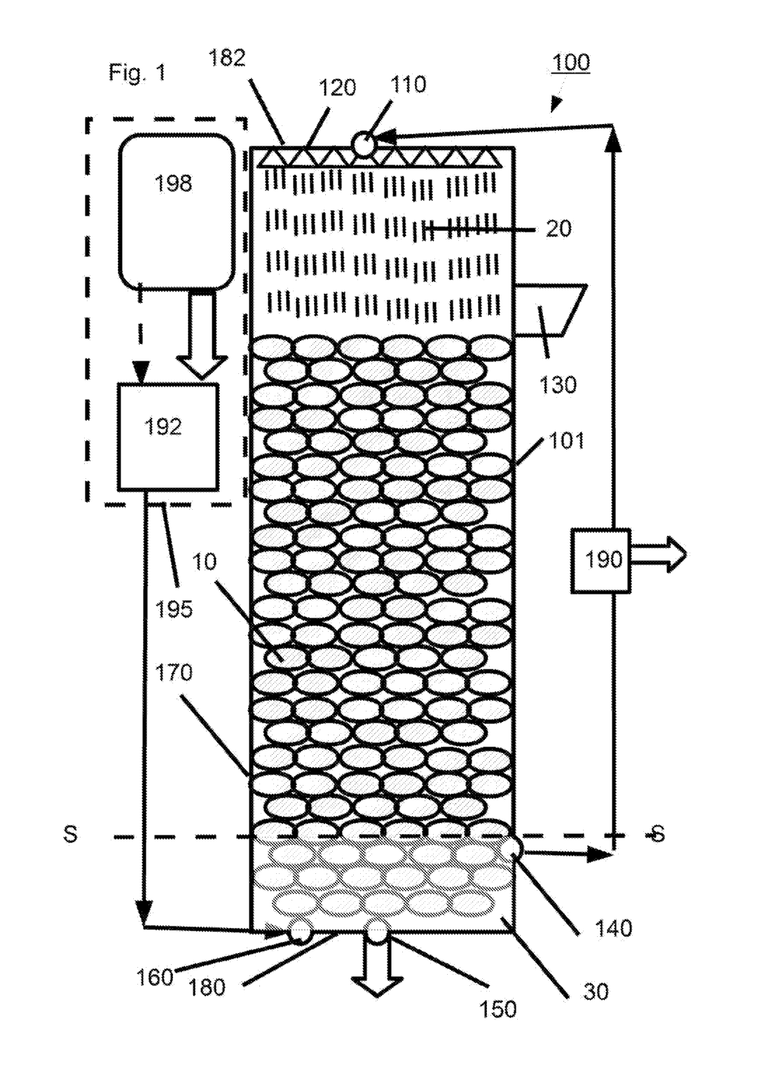

FIG. 1 is a schematic diagram of a hydrolysis apparatus according to some exemplary embodiments of the invention generally indicated as 100.

Depicted exemplary apparatus 100 includes a reactor vessel 101 defined by an outer wall 170, a lower wall 180 and an upper wall 182. In the depicted exemplary embodiment, apparatus 100 includes no heater. Vessel 101 includes a sprinkler 120 at an upper portion thereof. Sprinkler 120 delivers a plurality of drops 20 onto substrate 10 to form a trickling bed reactor. Since the reactor vessel is large, drops 20 may be larger than what is normally regarded as a drop, so long as they are distributed over substrate 10.

Depicted exemplary apparatus 100 includes a substrate delivery module 130 adapted to deliver a flow of hydrolysis substrate 10 to the vessel. Substrate 10 may be, for example, a divided solid such as wood chips. Substrate delivery module 130 is depicted here as a passive intake hopper for simplicity.

According to various exemplary embodiments of the invention substrate delivery module 130 may be an active component including, or fed by, a mechanical delivery mechanism. Mechanical delivery mechanisms include, but are not limited to, conveyor belts, rollers, augers and pumps.

Substrate 10 is depicted as a series of uniform ovals within the vessel for simplicity. Actual size and shape of substrate particles can vary widely depending upon their source and/or optional pre-processing steps and/or the nature of substrate delivery module 130.

Alternatively or additionally, average particle size of substrate 10 may become smaller as substrate 10 flows towards bottom wall 180.

Alternatively or additionally, average density of substrate 10 may change as substrate 10 flows towards bottom wall 180. For example, density of substrate 10 may decrease as hydrolyzable portions of pieces of the substrate are transferred to the reaction liquid. At least in theory, the lignin matrix of a single piece of substrate remains intact so that the pieces are gradually transformed to a filamentous network filled with cavities within the matrix. In practice, these filamentous networks may be broken down to some degree by mechanical disruption as the substrate moves downwards.

Depicted exemplary apparatus 100 also includes a recirculation pump 190 configured to provide a flow of acidic reaction liquid from a single selected height in the vessel to sprinkler 120. The selected height is determined by installation of a recirculation outlet port 140 at, or slightly below, a surface (depicted as line S-S) of accumulated reaction liquid 30 in the bottom of the vessel. In some exemplary embodiments of the invention, the selected height is varied by moving port 140. The single selected height has dimensions which are determined by the size of port 140.

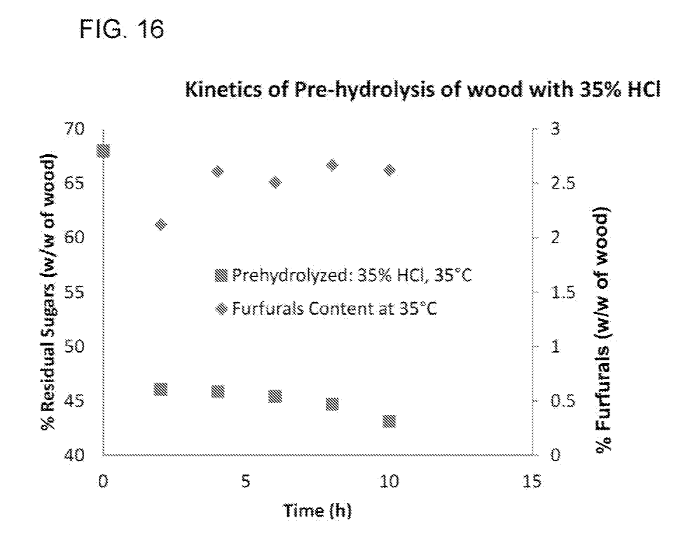

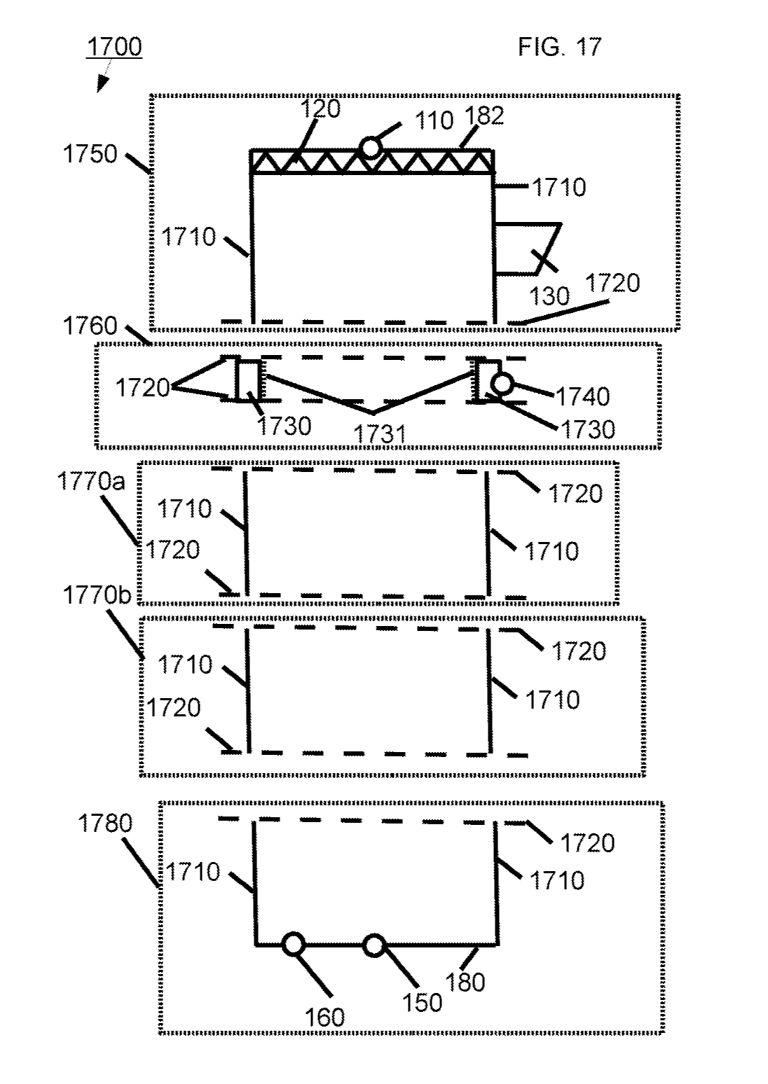

In some embodiments, substantially no liquid crosses line S-S. An exemplary way to achieve this is to distribute port 140 circumferentially around the vessel. An exemplary way to circumferentially distribute the port is described hereinbelow in the context of FIG. 17; items 1740, 1730 and 1731.

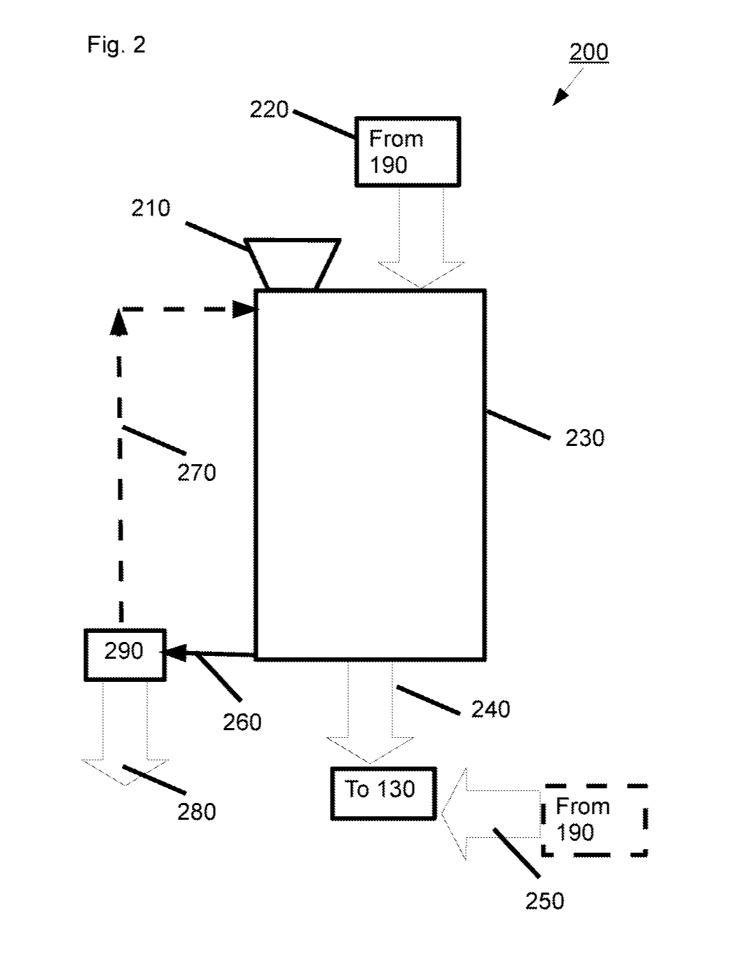

At any given moment reaction liquid 30 contains a mixture of monosaccharides and oligomeric polysaccharides. In some embodiments of the invention, a portion of reaction liquid 30 passing through pump 190 is directed to downstream processing (hollow arrow at 190) to separate soluble sugars from acid and/or water. HCl recovered from this downstream processor can optionally be re-introduced into the apparatus. In some embodiments of the invention, recirculation via pump 190 allows soluble oligosaccharides to undergo further hydrolysis to shorter oligosaccharides and, eventually, monosaccharides. In some embodiments of the invention, at least a portion of this liquid stream passes through a hydration module (200; FIG. 2) prior to downstream processing.

In some embodiments of the invention, pump 190 delivers 5 to 15%, optionally, 8 to 13%, optionally about 10 to 12% of the volume of reaction liquid 30 below line S-S via sprinkler 120 each minute. In some exemplary embodiments of the invention, an amount of hydrolyzate per minute withdrawn via port 140 may be larger in order to compensate for flow diversion to downstream processing by pump 190, or an adjacent flow splitter.

Alternatively or additionally, in order to keep line S-S at the same height, the rate of liquid leaving the system (e.g. rightward pointing hollow arrow at pump 190) should be the substantially the same as the amount of liquid entering the system at port 160. Slight differences may be needed to compensate for loss of liquid volume as water is consumed by hydrolysis on the one hand and to compensate for increases in liquid volume resulting from dissolution of sugars formed by hydrolysis and/or water released from wood into the acidic reaction liquid.

In some exemplary embodiments of the invention, pump 190 delivers 80 to 100, or 90 to 110 (e.g. about 108) liters/minute/square meter of an upper surface of substrate 10 via port 110 and/or sprinkler 120.

Depicted exemplary apparatus 100 also includes a drain 150. Drain 150 is depicted at the bottom of the vessel, although it may optionally be slightly above the bottom of the vessel so long as it is sufficiently low to allow drainage. Drain 150 is used to remove a lignin rich residual fraction of substrate 10. According to various embodiments of the invention the lignin rich residual fraction is at least 70%, or 80% or 90% or 95% or substantially 100% lignin on a dry matter basis.

It follows that, according to various embodiments of the invention, at least 85%, at least 90%, at least 95%, at least 97% or substantially 100% of insoluble polysaccharides (e.g. cellulose and hemicellulose) are hydrolyzed to soluble carbohydrates.

In some embodiments of the invention a ratio of oligomeric to monomeric sugars is in the range of 0.4 to 0.6, for example about 0.5.

In some exemplary embodiments of the invention, the lignin rich residual fraction is routed to downstream processing for acid recovery and/or recovery of additional soluble carbohydrates as indicated by the hollow downward pointing arrow at 150. In some cases, recovered acid is re-introduced into the apparatus as described hereinbelow. Alternatively or additionally, recovered additional carbohydrates may be routed to absorber 192 and re-enter the system at 160.

It is noted that lignin has a high affinity for water so that each ton of lignin removed carries many tons of water. It is believed that the ratio of lignin:water is typically about 1:10 although actual values may vary in the range of about 1:8 to about 1:14. Water associated with lignin carries with it HCl and soluble sugars resulting from hydrolysis of substrate 10. In some exemplary embodiments of the invention, the lignin includes the ratio of HCl:(HCl+water) of about 0.4. In some exemplary embodiments of the invention, these soluble sugars are recovered and harvested in downstream processing and/or re-introduced to the system.

Depicted exemplary apparatus 100 includes, an acid supply system 195 configured to deliver a stream of concentrated HCl to a bottom end of the vessel via acid introduction port 160. In some exemplary embodiments of the invention, the stream of concentrated HCl includes dissolved carbohydrates. Acid supply system 195 includes an HCl absorber 192 connected to one or more downstream processing units 198 which provide HCl vapors (indicated as hollow downward arrow). Downstream processing units 198 can also provide HCl in solution (indicated as downward dashed arrow). Optionally, HCl in solution is provided in a solution with soluble carbohydrates.

Absorber 192 can also include a pump. In some exemplary embodiments of the invention, absorber 192 serves as a cooling module. Alternatively or additionally, a refrigeration unit installed in absorber 192, or between absorber 192 and port 160 can serve as a cooling module. In some exemplary embodiments of the invention, the cooling module is adapted to cool a stream of concentrated HCl to ≦18° C., ≦15° C., or even ≦12° C.

According to various exemplary embodiments of the invention, an HCl concentration at the exit of absorber 192 is higher than an HCl concentration of reaction liquid 30 in proximity to port 160. According to various exemplary embodiments of the invention, an HCl concentration at the exit of absorber 192 is ≧37%, ≧38%, ≧39%, ≧40%, ≧41% or even ≧42%. As the concentration of HCl leaving absorber 192 increases, its ability for incremental hydrolysis of substrate 10 in proximity to bottom wall 180 increases.

Alternatively or additionally, HCl leaves absorber 192 at a temperature of less than 17, less than 15, or even less than 12.5° C. In some exemplary embodiments of the invention, cooling of this highly concentrated HCl contributes to a reduction in unwanted degradation of soluble sugars in the reaction liquid 30 in proximity to port 160 and/or bottom wall 180. Alternatively or additionally, cooling of this highly concentrated HCl contributes to a reduction in vapor pressure within apparatus 100. Optionally, this reduction in vapor contributes to a reduction in technical problems associated with HCl fumes (e.g. venting).

Referring again to FIG. 1, depicted exemplary apparatus 100 can also be described as a reactor vessel including a substrate delivery module 130 adapted to deliver a flow of a divided solid hydrolysis substrate to an upper portion of the vessel.

According to this description, apparatus 100 also includes an acid delivery system 195 configured to deliver a stream of concentrated HCl to a lower portion of the vessel. In the depicted embodiment, acid delivery is via port 160.

According to this description, apparatus 100 also includes a recirculation pump 190 configured to deliver acidic reaction liquid from a single selected height in the vessel to a location above the flow of substrate 10. In the depicted embodiment, the selected height is defined by port 140 at or slightly below a surface (depicted as line S-S) of accumulated reaction liquid 30 in the bottom of the vessel. Dimensions of the single selected height are similar to, optionally smaller than, those of port 140. In the depicted embodiment, delivery of acidic reaction liquid to the location above the flow of substrate 10 is provided by sprinkler 120 which causes drops 20 to rain down on substrate 10.

According to this description, apparatus 100 also includes drain 150 at the bottom of the vessel which functions as described above.

Regardless of the way in which apparatus 100 is described, the apparatus can optionally include a flow splitter (e.g. as part of recirculation pump 190) which directs a portion of the flow to a downstream processing module (indicated by hollow rightwards arrow). Downstream processing 198 can include recovery of soluble sugars and/or recovery of HCl solution and/or separation of HCl from water. Optionally, recovery of sugars and/or recovery of HCl solution includes solvent extraction (e.g. with hexanol or derivatives thereof such as 2-ethyl-1 hexanol). In some exemplary embodiments of the invention, recovered HCl from this downstream processing is re-introduced to apparatus 100 as vapors and/or liquid via absorber 192.

Although apparatus 100 is depicted as a cylindrical tank for simplicity, sidewalls 170 are not vertical in all embodiments of the invention. For example, a CLARICIONE apparatus (CG&I Engineering solutions; Hague, Netherlands) can be used as a reactor vessel according to some embodiments of the invention.

Exemplary Flow Control Mechanisms for Continuous Flow Apparatus:

In some exemplary embodiments of the invention, drain 150 includes a drainage flow regulator. According to various exemplary embodiments of the invention the drainage flow regulator is designed and configured to provide a constant outlet flow or an intermittent outlet flow from the drain.

In some exemplary embodiments of the invention, acid supply system 195 includes inlet port 160 at a bottom end of apparatus 100. Optionally, port 160 includes an inlet flow regulator. According to various exemplary embodiments of the invention the inlet flow regulator is designed and configured to provide a constant inlet flow or an intermittent inlet flow to the vessel.

In those exemplary embodiments of the invention in which substrate delivery module 130 includes an active component including, or fed by, a mechanical delivery mechanism, the mechanical delivery mechanism may be designed and configured to regulate flow. The mechanical delivery mechanisms are optionally designed and configured to provide a constant inlet flow or an intermittent inlet flow of substrate 10 to the vessel.

In cases where an intermittent flow is used, the relevant flow can still be described in terms of an average flow per unit time.

According to various exemplary embodiments of the invention, the relevant flows may be defined in units of volume/time or mass/time.

### Exemplary Continuous Flow Apparatus Control:

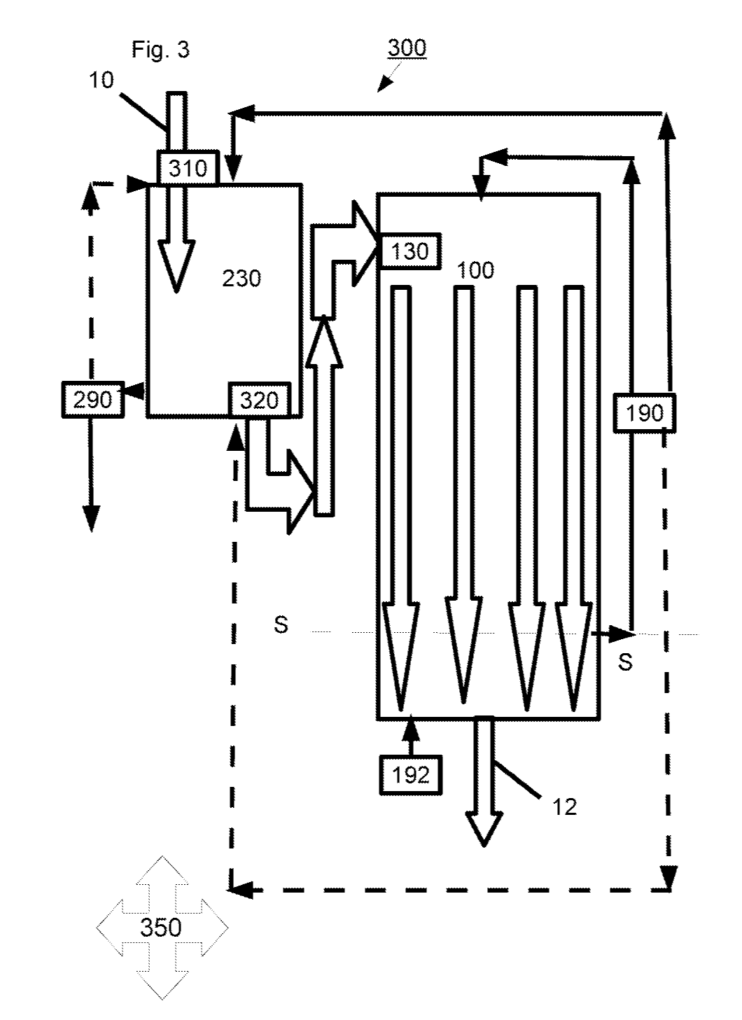

In some exemplary embodiments of the invention, apparatus 100 is equipped with, or in communication with a controller 350 (see FIG. 3) adapted to regulate substrate delivery module 130 and drain 150 to maintain an amount of substrate 10 in the vessel in a pre-determined range.

In some embodiments of the invention, controller 350 controls the relevant flow regulators through a suitable interface. In some exemplary embodiments of the invention, the flow regulators are mechanical and/or electrical and/or electromechanical. In some exemplary embodiments of the invention, controller 350 is electronic. Implementation of control interfaces between electronic controller 350 and one or more non-electronic flow regulators is a routine matter for those of ordinary skill in the art.

Alternatively or additionally, controller 350 is adapted to maintain a maximal temperature in the reaction vessel in a predetermined range. According to various embodiments of the invention the predetermined range includes only temperatures≧20° C., ≧25° C., ≧30° C. or even ≧35° C. Alternatively or additionally, according to various embodiments of the invention the predetermined range includes only temperatures≦50° C., ≦45° C., ≦40° C. or even ≦35° C. In some exemplary embodiments of the invention, the temperature range is from about 25 to 35° C., optionally from about 30 to 35° C., optionally from about 32 to 35° C.

In some embodiments of the invention, controller 350 is operable via a user interface presented on an electronic device such as a computer or mobile digital communication device.

Exemplary Upstream Hydration Module:

Reference is now made to FIG. 2 which is a schematic diagram of an optional hydration module depicted generally as 200 according to some exemplary embodiments of the invention.

In the depicted embodiment, hydration module 200 includes a substrate intake 210 and a hydration vessel 230. Intake 210 is depicted as a funnel for simplicity. In actual practice, substrate intake 210 may include an active component including, or fed by, a mechanical delivery mechanism as described above in the context of substrate intake 130 of apparatus 100.

Substrate intake 210 differs from substrate intake 130 as a result of the substrate to be handled. Optionally, intake 130 is designed and configured to handle a mixture, or slurry, of substrate and an external liquid carrier. Alternatively, intake 210 is designed and configured to handle a divided solid substrate in the absence of an external liquid carrier.

In some exemplary embodiments of the invention, hydration of the substrate (depicted as 10 in FIG. 1) is with a liquid hydrolyzate stream 220 delivered by pump 190. Contacting of substrate 10 with liquid hydrolyzate stream 220 in hydration module 200 can cause pre-hydrolysis of substrate introduced therein.

According to various exemplary embodiments of the invention an amount and/or degree of this pre-hydrolysis can vary with one or more of an amount of hemicellulose present in the substrate, substrate density, average particle size of the substrate, average largest dimension of the substrate particles, average smallest dimension of the substrate particles, acid concentration in stream 220 and contact time of stream 220 with the substrate.

Typically, this pre-hydrolysis adds pentoses to the hydrolyzate since hemicellulose, which is the more easily hydrolyzed component of the substrate, releases pentoses upon hydrolysis.

In some exemplary embodiments of the invention, hydration module 200 includes an upstream entry point 210 with respect to substrate and a downstream exit point 290 for liquid hydrolyzate.

In some embodiments of the invention, hemicellulose sugars (pentoses and/or hexoses) are released by the pre-hydrolysis are harvested by removing a stream of hydrolyzate liquid 260. In some exemplary embodiments of the invention, this removal is aided by a pump 290 which transports the hydrolyzate to downstream processing 280. In some exemplary embodiments of the invention, HCl from processing 280 re-enters apparatus 100 via downstream processing unit 198 and/or absorber 192. In some embodiments of the invention, pump 290 is the main, optionally the only, component which routes liquid hydrolyzate to downstream processing 280.

In some exemplary embodiments of the invention, downstream processing 280 includes separation of soluble carbohydrates from HCl and/or separation of carbohydrates from water and/or separation of HCl from water. In some exemplary embodiments of the invention, downstream processing 280 includes separation of pentoses from hexoses. In some exemplary embodiments of the invention, HCl recovered from downstream processing 280 is re-introduced into apparatus 100 via absorber 192 (FIG. 1).

In some exemplary embodiments of the invention, pump 290 recycles a portion 270 of hydrolyzate liquid 260 to an upper portion of vessel 230. In some exemplary embodiments of the invention, the recycled portion is cooled. This cooling may at least partially offset heat generated by contact of HCl with moisture in the substrate. In some embodiments of the invention, amounts of stream 220, substrate and recycled hydrolyzate portion 270 are controlled so as to produce a trickling bed effect as described in the context of apparatus 100. In some exemplary embodiments of the invention, re-introduction of portion 270 is via a sprinkler (not depicted) similar to 120 of apparatus 100 (FIG. 1).

Hydrated substrate 240 can be withdrawn from vessel 230 and transferred to intake 130 of apparatus 100. In some embodiments of the invention, this transfer is aided by an additional flow 250 of reaction liquid 30 from pump 190 of apparatus 100.

In some exemplary embodiments of the invention, hydration module 200 includes a substrate controller (see 350 in FIG. 3) which controls a flow of substrate through hydration module 200 and reactor vessel 101. According to various exemplary embodiments of the invention the controller may regulate a flow of substrate at intake 210 and/or a flow hydrated substrate 240.

Alternatively or additionally, hydration module 200 includes an acid flow controller (see 350 in FIG. 3) which controls a flow of liquid through and between hydration module 200 and reactor vessel 101.

Exemplary Continuous Flow System:

FIG. 3 is a schematic system overview diagram indicating exemplary liquid and solid flows in a continuous flow system generally indicated as 300 according to some exemplary embodiments of the invention. System 300 includes apparatus 100 and upstream hydration module 200 as described hereinabove. Liquid flow streams are indicated by solid or dashed arrows. Solid flow streams are indicated by hollow arrows. Item 310 indicates an optional substrate supply mechanism as described above in the context of substrate intake 210. Item 320 indicates a substrate transfer mechanism designed and configured to insure a flow of hydrated substrate 240 from hydration module 200 to apparatus 100.

FIG. 3 emphasizes that substrate 10 entering the system at 310 is substantially completely hydrolyzed so that solids remaining to be removed from the bottom of apparatus 100 are substantially only lignin 12. Lignin 12 is sometimes referred to herein as “lignin rich residue”.

It follows that substrate 10 entering the system is characterized by a high concentration of insoluble polymeric polysaccharides, and that this concentration decreases by degrees as substrate 10 moves first downwards in hydration vessel 230 and then in apparatus 100. In some exemplary embodiments of the invention, the concentration of insoluble polymeric polysaccharides approaches 0 as substrate 10 approaches drain 150 (see FIG. 1).

Substrate 10 entering the system also contains mineral components commonly referred to as “ash”. Behavior of ash within system 300 can vary depending upon the specific mineral composition and/or liquid flow rates out of the system and/or the ratio of substrate 10 to reaction liquid 30 in apparatus 100 and/or the ratio of substrate 10 to reaction liquid 30 in hydration module 200.

Due to the complexity of the behavior of ash within system 300, no attempt is made to diagram its flow. Optionally, some residual ash is associated with lignin 12. In some exemplary embodiments of the invention, substrate 10 is pre-treated prior to hydration to eliminate as much ash as possible. Alternatively or additionally, ash is removed in the various downstream processing compartments indicated hereinabove.

Controller 350 has been described in the context of apparatus 100 and hydration module 200 separately. FIG. 3 clarifies that in some embodiments of the invention a single controller 350 coordinates operation of apparatus 100 and hydration module 200. Optionally, controller 350 is programmed with a desired system behavior defined in terms of acceptable ranges for various system parameters and adjusts one or more flows of reaction liquid 30 and/or substrate 10 and/or lignin 12 to keep system parameters in these ranges.

In some exemplary embodiments of the invention, one or more of the system parameters are based upon analyses of downstream processing of liquids and/or solids removed from the system. In some exemplary embodiments of the invention, controller 350 is responsive to data supplied from downstream processing. In some exemplary embodiments of the invention, this data is provided automatically. Automatic data provision can be implemented, for example, via a computer network using known communication protocols.

Referring again to FIGS. 1 and 3, in some embodiments, hydrolysis system 300 includes a reactor vessel including a sprinkler 120 at an upper portion thereof and a drain 150. According to these embodiments, system 300 includes a pump 190 re-circulating a flow of an acidic reaction liquid from a single selected height (S-S) in the vessel to sprinkler 120 and an acid supply mechanism (e.g. 198+192 of FIG. 1) delivering a supply of HCl at a concentration≧39% to a lower portion of the reactor vessel (e.g. via port 160). According to these embodiments, system 300 includes a flow splitteR (depicted as part of pump 190, but optionally provided as a separate unit) diverting a portion of the acidic reaction liquid so that a level of liquid in the vessel remains within a predetermined range. In some embodiments, the range is narrow so that the level remains substantially unchanged. In some embodiments, the level is at or near at selected height S-S.

Optionally, the system includes a substrate delivery module (e.g. 130 or 310 and/or 320) delivering a hydrolysis substrate to the vessel.

In some embodiments, system 300 includes a cooling module to cool the supply of HCl. Function of absorber 192 and/or an adjacent refrigeration unit as a cooling module is described above. According to various exemplary embodiments of the invention the cooling module cools the supply of HCl to ≦18° C. According to various exemplary embodiments of the invention the effect of increased temperature on reducing viscosity is balanced against a desire to reduce sugar degradation by keeping temperatures low.

In some exemplary embodiments of the invention, the cooling module cools the supply of HCl to a temperature of about 13 to 17, or ° C. 14 to 16° C., optionally about 15° C.

In some embodiments, system 300 includes a controller 350 adapted to maintain a maximum temperature in the vessel in a predetermined range. In some embodiments, the predetermined range includes only temperatures≧30° C.

Exemplary Temperature Conditions for Continuous Flow System:

In some exemplary embodiments of the invention, hydrolysis temperature conditions are controlled for example by cooling. For example, concentrated HCl from absorber 192 (FIG. 1) cools reaction liquid 30 in proximity to port 160 where it enters apparatus 100. In some exemplary embodiments of the invention, concentrated HCl is at a lowest temperature within the system as it passes through port 160. This lowest temperature may be, for example, 12° C.

As reaction liquid 30 flows upwards through substrate 10 it may be warmed by heat transfer from substrate 10 and/or addition of warmer reaction liquid 30 trickling down through substrate 10 to line S-S. By way of example, liquid 30 exiting port 140 may be at a temperature of 15 to 18° C., for example. After exit via port 140, liquid 30 is pumped to port 110 and delivered as drops 20 via sprinkler 120 to an upper surface of substrate 110. According to various exemplary embodiments of the invention, liquid 30 may reach a temperature of 20 or even 25° C. by the time it leaves sprinkler 120 as drops 20. In various embodiments of the invention, substrate 110 enters the reactor vessel at a temperature of 20, 25, 30, or even 35° C. or intermediate or higher temperatures. Contact between drops 20 and substrate 110 causes hydrolysis of hemicellulose and/or cellulose in substrate 110 which tends to heat substrate 110 further. In some exemplary embodiments of the invention, a high flow rate of drops 20 insures that the net effect of contact between drops 20 and substrate 110 is to maintain the temperature below 35° C. Optionally, substrate 110 is further cooled by liquid as it is submerged below line S-S. In some exemplary embodiments of the invention, lignin rich residue exits drain 150 at a temperature≦20° C., ≦18° C., or even ≦15° C.

As they flow downwards, drops 20 encounter relatively warm HCl vapors rising upwards. This encounter has a scrubbing effect which reduces the tendency of HCl vapors to reach upper wall 182. Drops 20, and HCl vapors condensed by the scrubbing effect, now begin to trickle downwards though substrate 10. At this stage the temperature of the liquid may be, for example 16 to 20° C.

Alternatively or additionally, additional hydrolysis causes the temperature to further increase as the liquid migrates downwards to line S-S. In some exemplary embodiments of the invention, liquid approaching line S-S is at its maximum temperature within the system. According to various exemplary embodiments of the invention this maximum temperature is less than 35° C., 30° C., less than 27.5° C., less than 26° C. or even 25° C. or less. In other exemplary embodiments of the invention, this maximum temperature is greater than 25° C., 30° C., 35° C., 40° C. or even 45° C.

In some exemplary embodiments of the invention, hydrolysis of cellulose and hemicellulose to soluble carbohydrates, optionally monomeric sugars, approaches 100% while system temperatures are maintained below 35, below 30, or even below 25° C.

Exemplary Sugar Concentrations in Continuous Flow System:

Referring again to FIG. 1; in some exemplary embodiments of the invention, soluble sugar concentration in reaction liquid 30 increases between 110 and line S-S in apparatus 100. Conversely, insoluble polymeric polysaccharide concentration in substrate 10 decreases by a corresponding degree between 110 and line S-S in apparatus 100.

Alternatively or additionally, soluble sugar concentration increases between 210 and 260 in vessel 230 (FIG. 2). In some cases this increase is primarily, in some cases even almost exclusively, due to release of hemicellulose sugars from the substrate during hydration.

Alternatively or additionally, hemicellulose concentration decreases between 310 and 320 in vessel 230 (FIG. 3). From the standpoint of substrate entering the system, vessel 230 is upstream of the main reactor vessel of FIG. 1. Vessel 230 can be described as an upstream hydration module. In some exemplary embodiments of the invention, hydration is with hydrolyzate removed from the main reactor vessel of FIG. 1. Optionally, 40, 50, 60, 70, 80, 90, 95, 97 or even substantially 100% of hemicelluloses entering vessel 230 are converted to soluble sugarss prior to substrate removal at 320. In some exemplary embodiments of the invention, an increase in conversion of hemicellulose to pentoses in this portion of the system contributes to a reduction in RT (Pentoses).

Exemplary Materials:

In some exemplary embodiments of the invention, all of the parts of system 300 are resistant to fuming HCl, optionally resistant to 42% HCl. This resistance can be achieved by construction from resistant materials and/or shielding from contact with the acid.

Resistant materials include but are not limited to stainless steel, glass, and acid resistant plastics. Acid resistant plastics include, but are not limited to polyethylene and polypropylene, FEP (Hexafluoropropylene-tetrafluoroethylene Copolymer), PVDF (Polyvinylidene Difluoride), ECTFE (Ethylene chlorotrifluoroethylene), PCTFE (Polychlorotrifluoroethylene) and PEEK (PolyEtherEtherKetone).

In some exemplary embodiments of the invention, layers of plastic or TEFLON (Dupont) coating are used to impart HCl resistance to other materials that would otherwise be unsuitable for use in the context of embodiments of the invention.

Exemplary Continuous Flow Method:

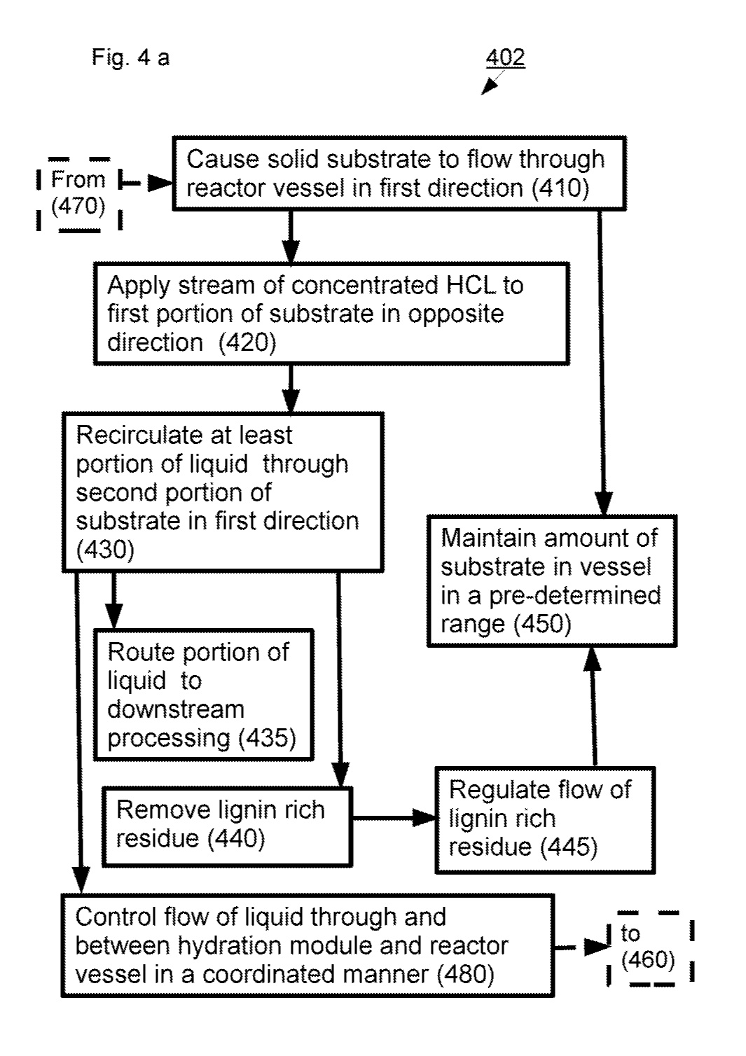

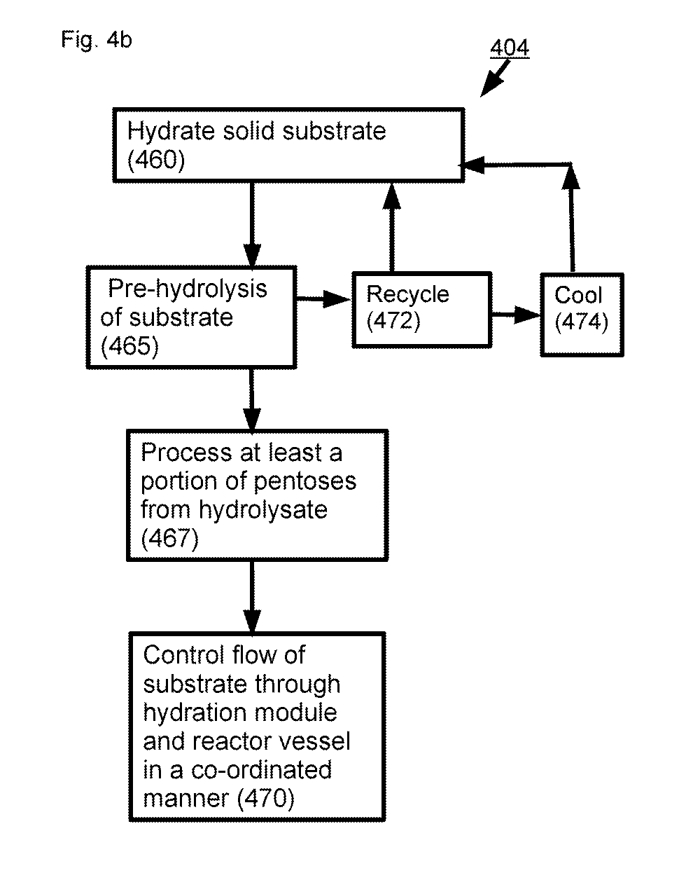

FIGS. 4a and 4b are a simplified flow diagram illustrating methods according some exemplary embodiments of the invention.

FIG. 4a approximately corresponds to apparatus 100 described in terms of a method generally indicated as 402.

FIG. 4b approximately corresponds to hydration module 200 described in terms of a method generally indicated as 404.

FIGS. 4a and 4b together describe what happens during operation of a system 300 of the type depicted in FIG. 3.

Referring now to FIG. 4a, hydrolysis method 402 includes causing 410 a solid substrate to flow through a reactor vessel in a first direction so that the substrate is moving through the reactor in a first direction (downwards in FIG. 1). In the depicted exemplary embodiment, method 402 includes applying 420 a stream of concentrated HCl flowing in an opposite direction (upwards in FIG. 1) to a first portion (below line S-S in FIG. 1) of the substrate. In some exemplary embodiments of the invention, the stream flows through the substrate. In some exemplary embodiments of the invention, this application causes partial hydrolysis of the substrate and produces an acidic reaction liquid. Applying 420 can be, for example via an inlet port at a lower portion of the vessel (e.g. 160 in FIG. 1).

Although the idea of flow of a solid substrate may seem counter intuitive, the flow can be easily comprehended by visualizing introduction of the substrate at inlet 130 of apparatus 100. The introduction of substrate at inlet 130 is responsible for “causing” 410. The rate of introduction contributes to the flow rate.

In some exemplary embodiments of the invention, applying 420 occurs via an inlet port at a lower portion, optionally a bottom end, of the vessel. In some exemplary embodiments of the invention, applying 420 includes flow regulation. Optionally, the regulation produces either an intermittent or a constant flow.

Method 402 also includes re-circulating 430 at least a portion of the liquid through a second portion of the substrate (above line S-S in FIG. 1) in the first direction. In terms of FIG. 1, the first direction is downwards and the opposite direction is upwards. In some exemplary embodiments of the invention, re-circulating 430 creates a trickling bed in at least a portion of substrate in the vessel.

In some exemplary embodiments of the invention, method 402 includes maintaining a temperature of the second portion of the substrate ≧20° C., ≧30° C., ≧35° C., 40° C., or even ≧45° C. Alternatively or additionally, according to various exemplary embodiments of the invention method 402 includes maintaining a temperature of the second portion of the substrate ≦50° C., ≦45° C., ≦40° C. or even ≦35° C. In some exemplary embodiments of the invention, the second portion of the substrate is maintained at a temperature from about 25 to 35° C., from about 30 to 35° C., or even from about 32 to 35° C.

Alternatively or additionally, method 402 may include cooling the stream of concentrated HCl to a temperature≦20° C., ≦18° C., ≦15° C. or even ≦12° C.

Depicted exemplary method 402 includes removing 440 lignin rich residue from the vessel (e.g. via drain 150 in FIG. 1). In some embodiments, method 402 includes regulating 445 a flow of the lignin rich residue. Optional forms of regulation are described hereinabove in the context of drain 150. This regulation can provide a constant flow or an intermittent flow.

Alternatively or additionally, method 402 may include routing 435 a portion of the liquid to downstream processing. In some exemplary embodiments of the invention, re-circulating 430 and routing 435 are handled by a single pump. In some exemplary embodiments of the invention, the downstream processing includes separation of sugars from acid. Optionally, the acid is recycled.

In some exemplary embodiments of the invention, method 402 includes maintaining 450 an amount of substrate in the vessel in a pre-determined range. This, maintaining can be achieved, for example, by controlling causing 410 and/or removing 440.

In some exemplary embodiments of the invention, method 402 includes withdrawing the at least a portion of the acidic reaction liquid which is to be re-circulated from a selected height in the reaction vessel. In some exemplary embodiments of the invention, the selected height is at, or slightly below line S-S in FIG. 1. (See port 140 in FIG. 1)

Referring now to FIG. 4b, depicted exemplary method 404 includes hydrating 460 the solid substrate prior to 410. In some exemplary embodiments of the invention, hydration is with liquid from 420 containing hydrolysis products. In some embodiments of the invention, hydrating 460 causes pre-hydrolysis 465 of the substrate. Typically, pre-hydrolysis 465 add hemicelluloses sugars (e.g. xylose and/or mannose and/or arabinose) to the liquid which already contains hydrolysis products (typically oligosaccharides and hexoses). According to various embodiments of the invention, the amount of hemicellulose sugars added varies with a concentration of hemicellulose present in the substrate. Typically, release of sugars from hemicellulose occurs in a single step without formation of an intermediate oligosaccharide.

In some exemplary embodiments of the invention, the hydration liquid is recycled 472 through the substrate and/or cooled 474. In some exemplary embodiments of the invention, cooling 474 contributes to a reduction in heat generated as HCl in the hydration liquid contacts water in the substrate. In some exemplary embodiments of the invention, recycling 472 and cooling 474 make vessel 230 function as a scrubber.

In some embodiments of the invention, method 404 includes processing 467 of at least a portion of the pentoses from the hydrolyzate. According to various exemplary embodiments of the invention this processing can include separation of pentoses from HCl and/or water and/or hexoses. In some embodiments of the invention, pentoses are initially separated from the hydrolyzate together and then separated from one another.

In some exemplary embodiments of the invention, method 404 includes controlling 470 a flow of the substrate through the hydration module and the reactor vessel in a coordinated manner. In some exemplary embodiments of the invention, this means that solid substrate leaving the hydration module is caused 410 to flow through the reactor vessel as depicted in FIG. 4a.

Alternatively or additionally, method 402 includes controlling 480 a flow of liquid through and between the hydration module and said reactor vessel in a coordinated manner In some exemplary embodiments of the invention, controlling 480 means that reaction liquid 30 is used for hydration 460 and/or that at least a portion of the liquid used in hydration 460 returns to the reactor vessel of apparatus 100. Optionally, this return occurs because causing 410 is carried out on hydrated substrate (See FIG. 2 and accompanying explanation).

Exemplary Residence Time Calculations for Some Continuous Flow Embodiments:

Optionally, residence time (RT) in hours of liquid (L) in the system can be calculated as:

RT (L)=[total volume of (L) system]/[amount of (L) removed/time].

Optionally, residence time (RT) in hours of soluble carbohydrates (CH) in the system can be calculated as:

RT (CH)=[total amount of (CH) system]/[amount of (CH) removed/time].

Optionally, residence time (RT) in hours of Hexoses in the system can be calculated as:

RT (Hexoses)=[total amount of (Hexoses) system]/[amount of (Hexoses) removed/time].

Optionally, residence time (RT) in hours of Pentoses in the system can be calculated as:

RT (Pentoses)=[total amount of (Pentoses) system]/[amount of (Pentoses) removed/time].

Optionally, residence time (RT) in hours of Lignin in the system can be calculated as:

RT (Lignin)=[total amount of Lignin in system]/[amount of Lignin removed/time].

In some exemplary embodiments of the invention RT (L) in apparatus 100 is less than 30 hours. Optionally, for a system with 4 to 10 reactors, RT (L) is in the range of 12 to 20 hours, optionally 15.5 to 16.5 hours, optionally about 16 hours. In other exemplary embodiments of the invention, RT (L) is in the range of greater than 8 and/or less than 12 hours, optionally between 8 and 12 hours. Alternatively or additionally, RT(L) in the portion of the reactor vessel below line S-S can be less than 8, less than 7, or even less than 6 hours in various embodiments of the invention. Alternatively or additionally, RT(L) in the portion of the reactor vessel above line S-S can be less than 2, less than 3 or less than 4 hours, 5 hours, 6 hours according to various embodiments of the invention.

In some exemplary embodiments of the invention RT (CH) in apparatus 100 is similar to or less than RT (L). According to various exemplary embodiments of the invention, RT (CH) is less than 30 hours. In some exemplary embodiments of the invention, RT (CH) is in the range of 10 to 18 hours, for example, 13.5 to 14.5 hours or 8 to 12 hours or 12 to 13 hours.

In some exemplary embodiments of the invention RT (Lignin) in apparatus 100 is greater than 20 hours for example, 20 to 36 hours.

In some exemplary embodiments of the invention RT (Pentoses) in system 300 is less than RT (Hexoses). Optionally, RT (Pentose):RT (Hexose) is ≦0.8, ≦0.6, or even ≦0.5. As this ratio decreases unwanted degradation of pentoses decreases. In some exemplary embodiments of the invention, the decrease in unwanted degradation of pentoses simplifies downstream processing by reducing presence of unwanted degradation products (e.g. furfural) in the hydrolyzate.

Additional Exemplary Continuous Flow System Characteristics:

According to various exemplary embodiments of the invention, a fraction of height of substrate 10 below line S-S is ≦0.5, ≦0.4, ≦0.3, ≦0.2 or even ≦0.1. In some exemplary embodiments of the invention, a fraction of height of substrate 10 below line S-S is between 0.25 and 0.33. In some exemplary embodiments of the invention, decreasing this fraction contributes to a decrease in RT (L).

Alternatively or additionally, decreasing this fraction contributes to a decrease in hydrolysis efficiency.

In some exemplary embodiments of the invention, apparatus 100 and/or system 300 are scaled to process 60 tons of substrate per hour. Optionally, the substrate is wood. Assuming that the retention time of substrate in the system is on the order of 20 hours, the system holds the equivalent of about 1200 tons of wood and corresponding solid remains at various stages of hydrolysis at any given moment. In order to handle this volume of material, apparatus 100 is constructed with a reaction vessel on the order of 30 meters in height.

It is expected that during the life of this patent many acid resistant plastics will be developed and the scope of the invention is intended to include use thereof a priori.

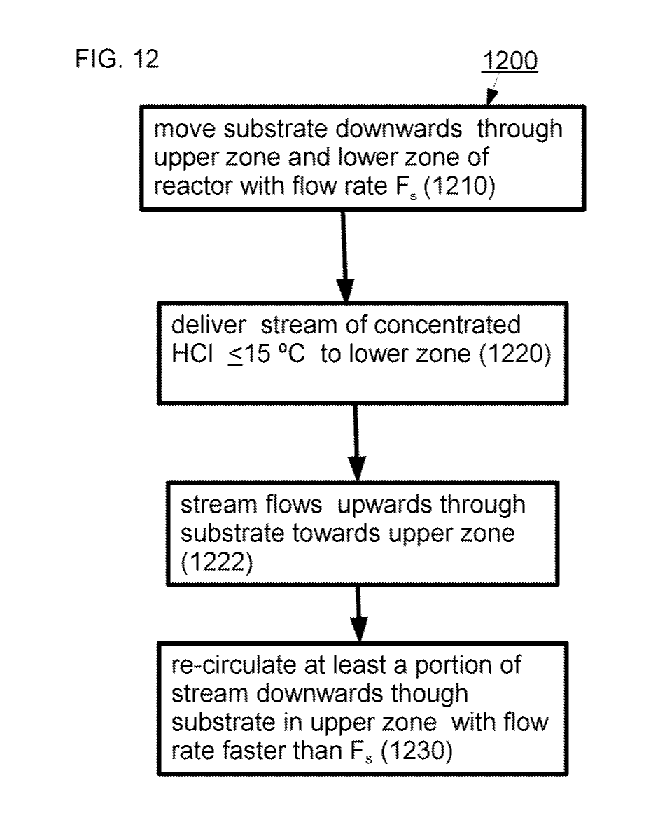

FIG. 12 is a simplified flow diagram of a hydrolysis method according to some exemplary embodiments of the invention indicated generally as 1200. In the depicted exemplary embodiment, method 1200 includes moving 1210 a lignocellulosic substrate downwards through an upper zone and a lower zone of a reactor vessel with a flow rate Fₛ. Referring to FIG. 1, line S-S serves as a line of demarcation between the upper zone and the lower zone.

Depicted exemplary method 1200 includes delivering 1220 a stream of concentrated HCl at a temperature≦15° C., ≦16° C. or ≦18° C. to the lower zone so that the stream flows 1222 upwards through the substrate towards the upper zone.

Depicted exemplary method 1200 also includes re-circulating 1230 at least a portion of the stream downwards though the substrate in the upper zone with a flow rate faster than Fₛ. Recirculation 1230 is depicted in FIG. 1. In some exemplary embodiments of the invention, downwards flow through the portion of the substrate in the upper zone is via a trickling bed mechanism created by delivery of drops 20 from sprinkler 120.

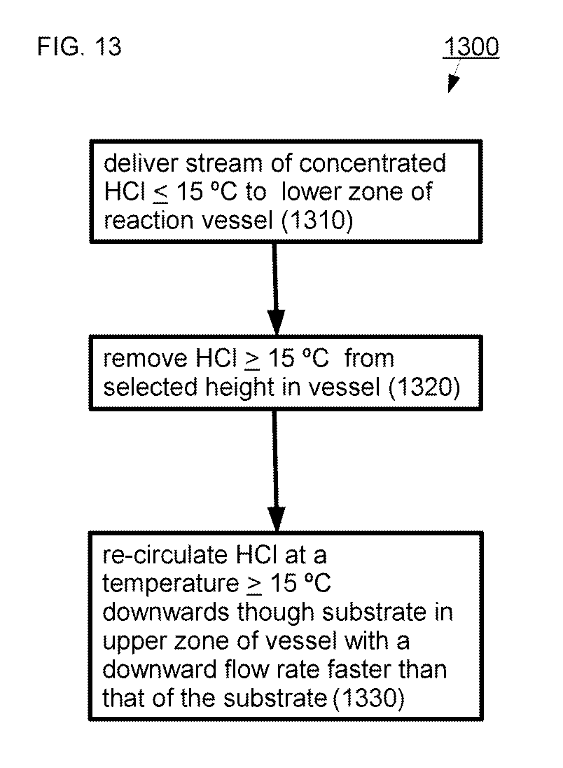

FIG. 13 is a simplified flow diagram of another exemplary hydrolysis method according to some exemplary embodiments of the invention indicated generally as 1300. In the depicted exemplary embodiment, method 1300 includes delivering 1310 a stream of concentrated HCl at a temperature≦15° C. to a lower zone of a reaction vessel.

Depicted exemplary method 1300 includes removing 1320 HCl at a temperature≧15° C. from a selected height in the vessel. Referring again to FIG. 1, the selected height corresponds to the height of port 140. In some exemplary embodiments of the invention, pump 190 may be positioned at or below this height. In some exemplary embodiments of the invention, positioning of pump 190 at or below the height of port 140 can contribute to a reduction in workload on the pump by flooding the pump.

Depicted exemplary method 1300 also includes re-circulating 1330 the HCl at a temperature≧15° C. downwards though substrate in an upper zone of the vessel, with a downward flow rate faster than that of said substrate.

According to various exemplary embodiments of the invention method 1300 includes maintaining a maximum temperature in the vessel ≧25° C., ≧27° C., ≧29° C. or ≧31° C.

Alternatively or additionally, according to various exemplary embodiments of the invention method 1300 includes maintaining a maximum temperature in the vessel ≦35° C., ≦33° C., ≦31° C. or ≦29° C.

In some exemplary embodiments of the invention, the maximum temperature is maintained in the range of 25 to 35, 29 to 35, 31 to 35 or 33 to 35° C.

In some exemplary embodiments of the invention, method 1300 includes removing a portion of said stream (see rightward pointing arrow at 190 in FIG. 1) to maintain a residence time (RT) of the stream in the vessel ≦16 hours, ≦14 hours, ≦12 hours, ≦10 hours, ≦8 hours or ≦7 hours.

Alternatively or additionally, method 1300 includes maintaining a residence time (RT) of the stream in the lower portion of the vessel ≦8 hours, ≦7 hours or ≦6 hours. According to various exemplary embodiments of the invention the height of port 140 relative to floor 180 (FIG. 1) and/or the flow rate of the stream entering port 160 and/or the flow rate of the stream exiting drain 150 and/or the flow rate of the stream exiting port 140 contribute to the RT of the stream in the lower portion of the vessel.

In some exemplary embodiments of the invention, method 1300 includes configuring the reactor vessel so that the upper zone occupies ≧50%, ≧60%, ≧70% or ≧80%, of a total volume of the reaction vessel.

In other exemplary embodiments of the invention, method 1300 includes configuring the reactor vessel so that the upper zone occupies ≦50%, ≦40%, ≦35%, ≦25% or ≦20%, of a total volume of the reaction vessel.

In some exemplary embodiments of the invention, re-circulating 1230 and/or 1330 is at a rate of ≧80 or ≧100 liters/minute/square meter of an upper surface of the substrate in the upper zone. Alternatively or additionally, in some exemplary embodiments of the invention, re-circulating 1230 and/or 1330 is at a rate of ≦120 or ≦110, for example about 108 liters/minute/square meter of an upper surface of the substrate in the upper zone.

In some exemplary embodiments of the invention, method 1300 includes maintaining a height of the substrate in the lower zone at ≧0.25, ≧0.35, ≧0.45 or ≧0.55 of a total substrate height in the reaction vessel. Alternatively or additionally, in some exemplary embodiments of the invention, method 1300 includes maintaining a height of the substrate in the lower zone at ≦0.75, ≦0.60, ≦0.45 or ≦0.33 of a total substrate height in the reaction vessel.

Exemplary Modular Hydrolysis Reaction Vessel

FIG. 17 is an exploded cross-sectional view of an exemplary hydrolysis reactor according to some exemplary embodiments of the invention indicated generally as 1700. Reactor 1700 is similar to the reactor depicted in FIG. 1, but is provided as a plurality of modules which can be assembled in different ways to impart desired properties to the reactor in operation.

In the depicted exemplary embodiment, each module is equipped with flanges 1720 which facilitate connection to an adjacent module. Optionally, at least some of flanges 1720 may be provided with sealing gaskets (not depicted here). Alternatively or additionally, flanges 1720 may have complementary surfaces (e.g. complementary protrusions and indentations; not depicted here) which can contribute to sealing efficiency. In some exemplary embodiments of the invention, flanges 1700 include holes (not diagrammed here) spaced circumferentially around outer wall 1710. In some exemplary embodiments of the invention, these holes are aligned during assembly and joined by a connecting component. Exemplary connecting components include, but are not limited to bolts with corresponding nuts, screws and rivets.

In the depicted exemplary embodiment, 4 module types are shown: cap module 1750, zone interface module 1760, spacer module 1770 (two are depicted; 1770a and 1770b, but varying numbers, including zero, may actually be employed) and base module 1780. Cap module 1750 is similar to the upper portion of the reactor in FIG. 1. Walls 1710 are analogous to walls 170 in FIG. 1 except that they end at flange 1720. Port 110, sprinkler 120 and substrate inlet 130 are identical to those depicted in FIG. 1.

Similarly, base module 1780 is similar to the lower portion of the reactor in FIG. 1. Walls 1710 are analogous to walls 170 in FIG. 1 except that they end at flange 1720. Port 160 and drain 150 are identical to those depicted in FIG. 1.

In the depicted exemplary embodiment, zone interface module 1760 replaces circulation outlet port 140 of FIG. 1. Module 1760 includes a circulation outlet port 1740 which performs a function similar to that of port 140. In the depicted exemplary embodiment, the circumferential wall of module 1760 is configured as a filter deployed between the inner lumen of the (assembled) reactor vessel and port 1740. The circumferential wall of module 1760 includes an inward facing permeable layer 1731 and an outer lumen 1730.

According to the depicted exemplary embodiments of the invention, outer lumen 1730 is serves as a channel of fluid communication between permeable layer 1731 and port 1740. According to various exemplary embodiments of the invention lumen 1730 can be either empty, or filled with a filter media.

In some exemplary embodiments of the invention, permeable layer 1731 is provided as a pre-filter which keeps macro sized substrate particles out of port 1740. For example, permeable layer 1731 may be provided as a 150, 175, 200, 225 or 250 mesh screen. In some exemplary embodiments of the invention, permeable layer 1731 contributes to a reduction in clogging of pump 190 (FIG. 1). In some cases, particles which are sufficiently small to pass through permeable layer 1731 are re-circulated by pump 190 to the trickling bed portion of the reactor via port 110 and/or sprinkler 120. Alternatively or additionally, some particles which are sufficiently small to pass through permeable layer 1731 are diverted to pre-hydrolysis and/or hydrolyzate harvest (rightward pointing arrow from pump 190).

In some exemplary embodiments of the invention, this diverted stream is subject to further filtration. According to various exemplary embodiments of the invention, this further filtration has a molecular weight cut-off ≦500, ≦400, ≦300, ≦250 or ≦200 kDa. In some exemplary embodiments of the invention, this further filtration includes filtration via a filter media including ceramic material and/or diatomaceous earth. In some exemplary embodiments of the invention, a MEMBRALOX ceramic filtration system of the type commercially available from PALL Corporation (Port Washington N.Y.; USA) is used for this further filtration.

In some exemplary embodiments of the invention, this further filtration includes a plurality of parallel filtration units. In order to maintain the units in working order, individual units are periodically taken offline for washing. Washing can be, for example with an alkaline detergent solution (e.g. TIDE detergent manufactured by Proctor and Gamble, Cincinnati Ohio in an NaOH solution).

Due to the high concentrations of acid in the system, an acid resistant housing (e.g. stainless steel) is provided for the filter media for the further filtration in many embodiments.

In some exemplary embodiments of the invention, an intermediate filtration stage with a cut-off of 5, 2.5 or 1 micron is implemented. Such an intermediate filtration stage can contribute to a reduced burden on the further filtration.

Alternatively or additionally, an external filter can be provided between port 1740 and pump 190 (see FIG. 1). In some exemplary embodiments of the invention, this stream is subject to additional filtration, after dilution, for example with a polysulfonic spiral filter membrane (e.g. a HYDRONAUTICS filter available from Nitto Denko Co., Oceanside Ca.; USA).

In some exemplary embodiments of the invention, placement of zone interface module 1760 effectively determines the height of line S-S in FIG. 1 and serves as a line of demarcation between an upper trickling bed zone and a lower zone. In some exemplary embodiments of the invention, the lower zone provides a countercurrent flow of acid hydrolysis media through downward moving substrate.

In some exemplary embodiments of the invention, port 1740 of zone interface module 1760 is connected to a pump (e.g. 190 in FIG. 1) which provides sufficient flow so that substantially all liquid approaching line S-S is pulled outwards through layer 1731, lumen 1730 and port 1740. As explained above in the context of FIG. 1, a portion of this liquid will be re-circulated through substrate residing in the upper trickling bed zone, e.g. via port 110 and/or sprinkler 120. According to these exemplary embodiments of the invention, it is possible to separately regulate residence times of liquids (e.g. HCl stream and/or dissolved sugars) in the upper and lower zones by adjusting the flow rates at ports 160, 1740 and 110.

Alternatively or additionally, a number of spacer modules 1770 and/or their placement can contribute to residence times of liquids and/or solids in the upper and/or lower zones of the reaction vessel. In the depicted exemplary embodiment, two spacer modules 1770a and 1170b are provided below zone interface module 1760. In this configuration the residence time of solids and/or liquids below zone interface module 1760 is long relative to alternative configurations with the same modules. According to this embodiment, the residence time of solids above zone interface module 1760 is relatively short. Optionally, the recirculation rate between port 1740 and port 110 contributes to the residence time of liquids above zone interface module 1760.

Assuming that each of modules 1750, 1770a, 1770b and 1780 have a similar vertical height, about 75% of substrate in the reactor vessel depicted in FIG. 17 will be submerged in reaction liquid in the lower zone at any given moment, and about 25% will be in the upper trickling bed zone.

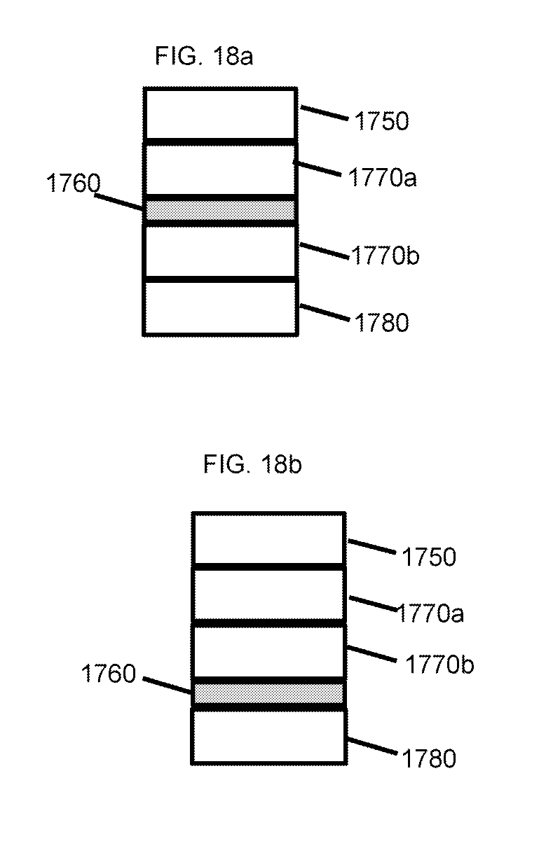

FIG. 18a is a schematic representation of the modules of FIG. 17 assembled in a different order. By placing zone interface module 1760 between spacer modules 1770a and 1170b the configuration is changed so that about 50% of substrate in the reactor vessel depicted in FIG. 17 will be submerged in reaction liquid in the lower zone at any given moment, and about 50% will be in the upper trickling bed zone.

FIG. 18b is a schematic representation of the modules of FIG. 17 assembled in another different order. By placing zone interface module 1760 below both of spacer modules 1770a and 1170b the configuration is changed so that about 25% of substrate in the reactor vessel depicted in FIG. 17 will be submerged in reaction liquid in the lower zone at any given moment, and about 75% will be in the upper trickling bed zone. The arrangement of FIG. 18b is roughly equivalent to the configuration of the reactor vessel in FIG. 1.

Referring again to FIG. 17, some exemplary embodiments of the invention relate to an apparatus 1700 comprising a cap module 1750 adapted to receive a lignocellulosic substrate (e.g. via hopper 130), a zone interface module 1760 including an effluent port 1740; at least one spacer module 1770 (a second spacer module 1770 b is also shown in FIG. 17) and a base module 1780 comprising an acid introduction port 160 and a drain 150. In the depicted embodiment, each of the modules is adapted to form an acid impervious connection with an adjacent module. Optionally, the acid impervious connection includes contact between flanges 1720 provided on adjacent modules.

In some exemplary embodiments of the invention, zone interface module 1760 includes a filtration unit (e.g. 1731 and/or 1730) adapted to filter a liquid flowing towards effluent port 1740. Optionally, the filtration unit includes a lumen 1730. Optionally, lumen 1730 contains filtration media with a molecular weight cutoff ≦500 kDa.

In some exemplary embodiments of the invention, cap module 1750 is adapted to receive a flow of re-circulated acid (e.g. via port 110). Alternatively or additionally, cap module 1750 includes a sprinkler 120.

In some exemplary embodiments of the invention, the at least one spacer module 1770 includes at least two spacer modules (1770a and 1170b are depicted although three, four, five or more spacer modules 1770 may be provided in actual practice).

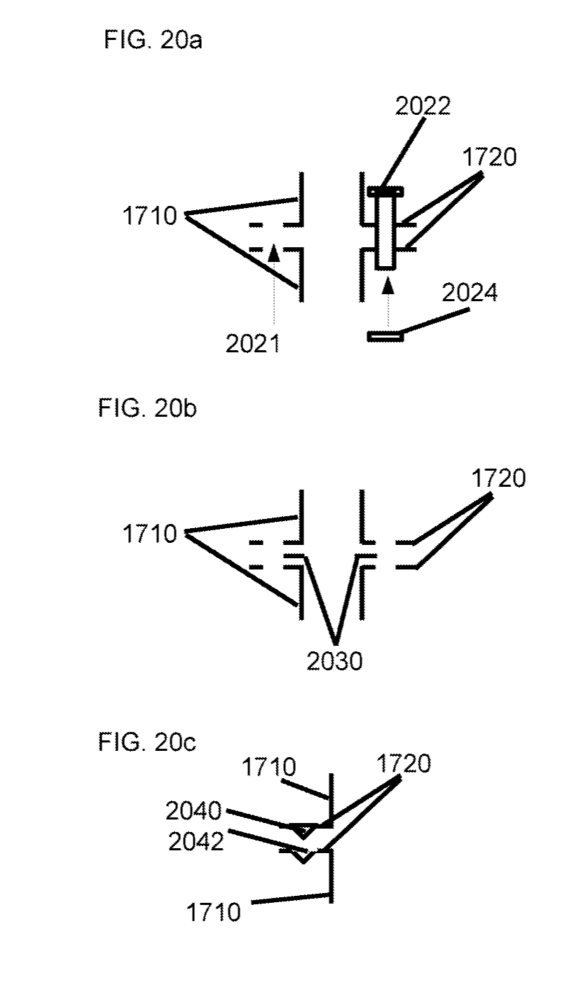

FIGS. 20a, 20b and 20c are schematic cross-sectional representations of exemplary flange configurations according to various exemplary embodiments of the invention.

Referring now to FIG. 20a, in some exemplary embodiments of the invention flanges 1720 include corresponding holes 2021 adapted to receive connectors. In some exemplary embodiments of the invention, the connectors are bolts 2022 with compatible nuts 2024. In other exemplary embodiments of the invention, rivets, screws or cotter pins can serve as connectors.

Referring now to FIG. 20b, alternatively or additionally, in some exemplary embodiments of the invention gaskets 2030 are provided between flanges 1720. Optionally, the gaskets improve the seal.

Referring now to FIG. 20c, alternatively or additionally, in some exemplary embodiments of the invention flanges 1720 include interlocking surface features. For example, one flange 1720 can have a protruding ridge 2040 and an adjacent flange 1720 can have a complementary groove 2042.

Additional Exemplary Methods:

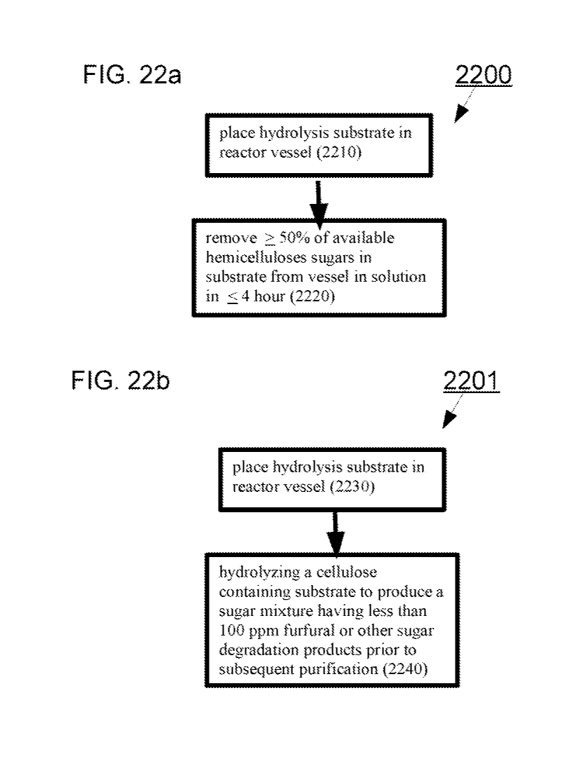

FIGS. 22a and 22b are simplified flow diagrams of methods according to various embodiments of the invention.

FIG. 22a depicts a hydrolysis method indicated generally as 2200 and including placing 2210 a hydrolysis substrate comprising hemicellulose in a reactor vessel and removing 2220 at least 90% of available hemicellulose sugars from the vessel in solution in ≦7, 6, 5, 4, 3, 2, or 1 hours. According to various exemplary embodiments of the invention this method may be practiced, for example, in a reactor as depicted in FIG. 1 and/or 17. In some embodiments, increasing a height of port 140 or 1740 relative to a total height of substrate in the reactor contributes to an ability to remove hemicellulose sugars from the vessel quickly.

FIG. 22b depicts a hydrolysis method indicated generally as 2201 and including placing hydrolyzing 2240 a cellulose containing substrate to produce a sugar mixture having less than 100 ppm furfural or other sugar degradation products prior to subsequent purification. Optionally, method 2201 includes placing 2230 a hydrolysis substrate in a reactor vessel. According to various exemplary embodiments of the invention this method may be practiced, for example, in a reactor as depicted in FIG. 1 and/or 17. In some embodiments, increasing a height of port 140 or 1740 relative to a total height of substrate in the reactor contributes to a reduction in sugar degradation products such as furfurals (e.g. furfural and/or hydroxymethyl furfural).

In some embodiments, these methods are performed in a reactor with no heater.

Exemplary Hydrolyzates:

In some embodiments, use of equipment and/or practice of methods, described above produces a hydrolyzate including hemicellulose derived sugars with furfurals or other sugar degradation products at a concentration≦100 ppm. Optionally, such a hydrolyzate may include at least one member selected from the group consisting of an acid, an enzyme, and a solvent.

Exemplary Considerations for Configuration Selection

Data presented below in Examples 3, 4 and 5 illustrates how laboratory experiments can be used to simulate the upper and lower zones of a reactor of the type depicted in FIG. 17. The results presented in the Examples suggest that, for the assayed pine wood samples, a configuration of the general type depicted in FIG. 17 is suitable. However, it is known that lignocellulosic substrates vary in their composition according to type (e.g. eucalyptus wood has low mannose content relative to pine) and/or source (e.g. pine wood from one geographic area may have a different sugar profile than pine wood from another geographic area) and/or time (e.g. pine wood harvested in a single geographic area may vary from year to year, or even season to season) and/or growth cycle (e.g. pine wood harvested every 10 years may have a different sugar profile than pine wood harvested every 7 years).

In some exemplary embodiments of the invention, a hydrolysis reaction vessel is provided in modules and the height at which zone interface module 1760 is installed is predetermined based upon a preliminary analysis of the substrate to be processed. In some exemplary embodiments of the invention, the preliminary analysis performed according to examples 3 and/or 4 and/or 5 or using similar techniques. Alternatively or additionally, the preliminary analysis includes quantitative profiling of specific sugars present in the substrate.

Exemplary Dimensions:

Referring again to FIG. 17, according to various exemplary embodiments of the invention the assembly of modules depicted as apparatus 1700 can be 7, 10, 12, 14, 16 or 18 meters tall or intervening or greater heights. Alternatively or additionally, each module can have an internal diameter of 4.5, 5, 5.5, 6 or 6.5 meters or intervening or greater diameters.

Exemplary Recirculation Rates:

In some exemplary embodiments of the invention, a rate of flow of re-circulated liquid delivered at port 110 is 1 gal./min/ft² (roughly 40 L/min/m²). In other embodiments of the invention, recirculation flow rates are 5, 10 or even 20 times higher than this. In some exemplary embodiments of the invention, increasing the recirculation flow rate contributes to a decrease in residence time of solids and/or liquids in the upper trickling bed portion of the reactor and/or to a decrease in unwanted degradation of sugars.

Increasing the recirculation flow rate can be limited to some degree by viscosity of the liquid to be re-circulated. High acid and/or sugar concentrations can each independently contribute to an increase in viscosity. Alternatively or additionally, an increase in temperature can contribute to a reduction in viscosity. However, an increase in temperature may also contribute to an increase in unwanted sugar degradation.

### Additional Exemplary Method:

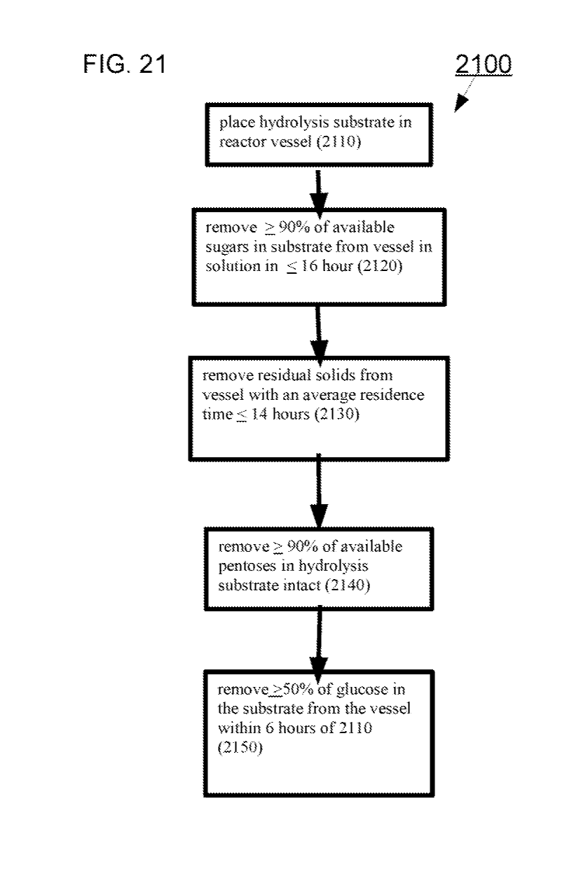

FIG. 21 depicts an additional exemplary hydrolysis method indicated generally as method 2100. Depicted embodiment 2100 includes placing 2110 a hydrolysis substrate comprising cellulose in a reactor vessel and removing 2120 at least 90% of available sugars in the substrate from the vessel in solution in ≦16 hours. In some cases, method 2100 includes removing 2130 residual solids from the vessel with an average residence time≦14 hours. As described above, these solids include primarily un-hydrolyzed lignin. Optionally, method 2100 includes removing 2140 ≧90% of available pentoses in the hydrolysis substrate intact. These pentoses are removed in the hydrolyzate as described above. Optionally, method 2100 includes removing 2150 ≧50% of glucose in the substrate from the vessel with a residence time≦6 hours (e.g. within 6 hours of placing 2110 on average).

As used in this specification and the accompanying claims the term “intact” indicates sugars which are detectable by an accepted assay for the sugar, or for oligomers containing the sugar. A measure of “intact” sugars indirectly indicates a degree of degradation which will be inversely proportional. For example, a 90% yield of pentoses indates that 10% or less of pentoses are degraded (e.g. to furfurals).

Overview of Exemplary Simulated Moving Bed System:

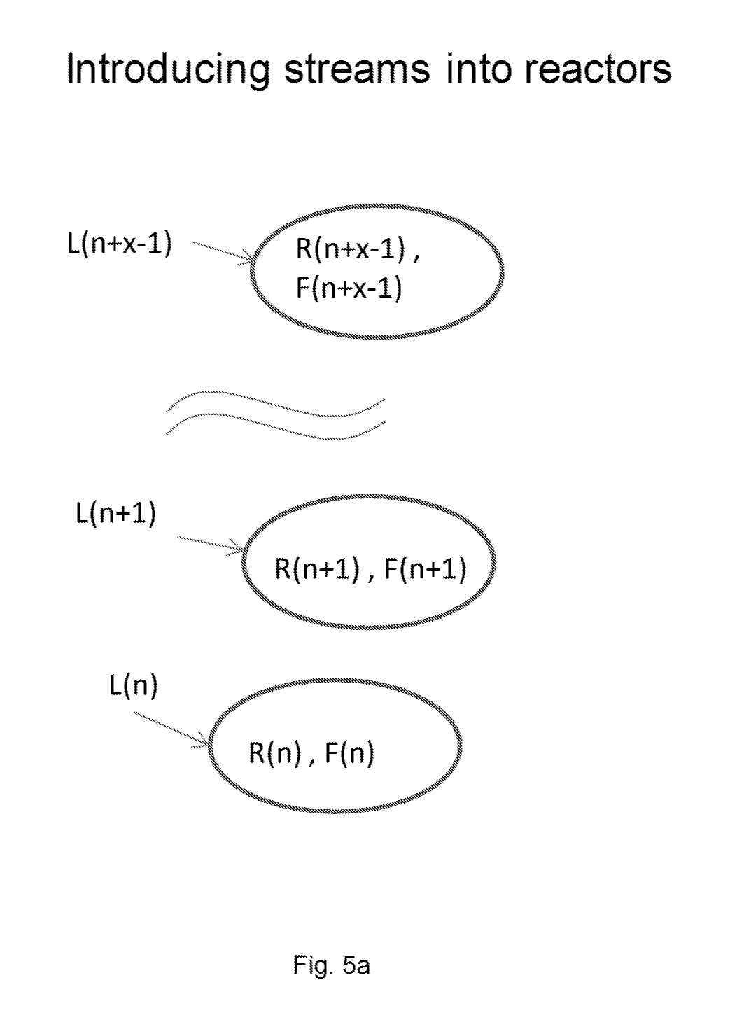

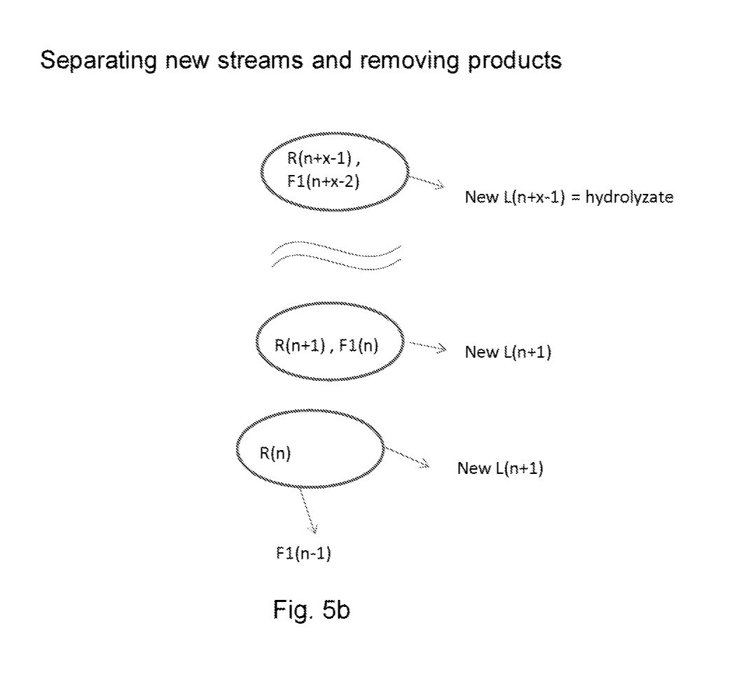

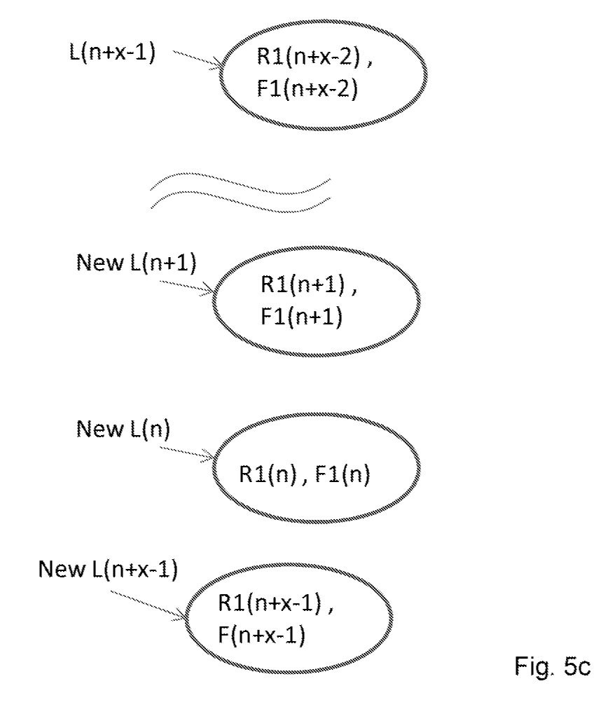

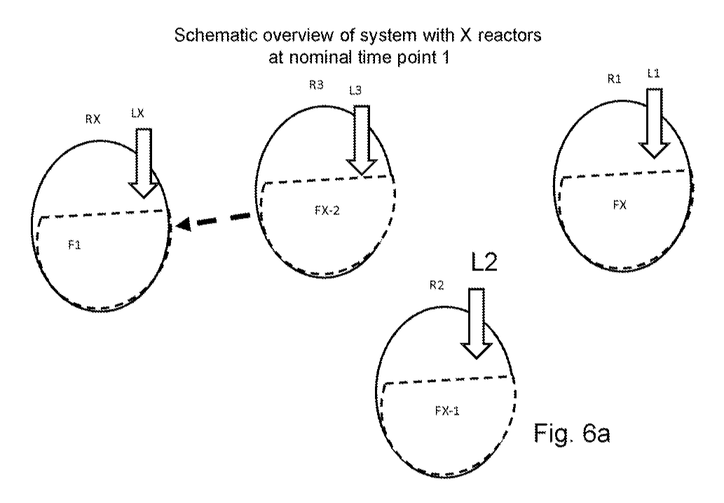

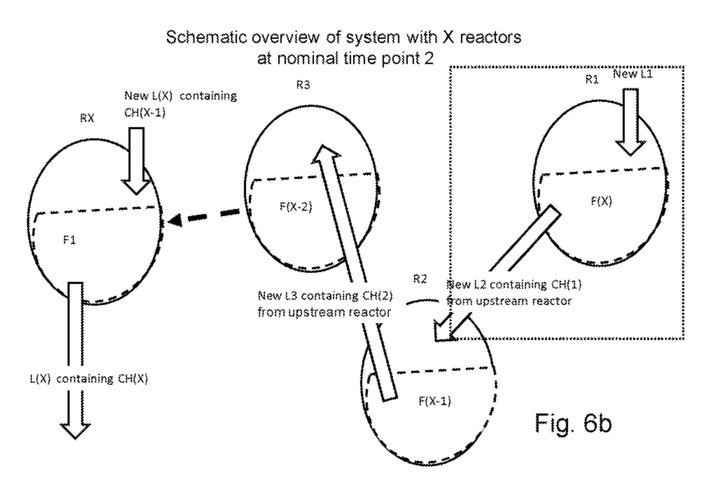

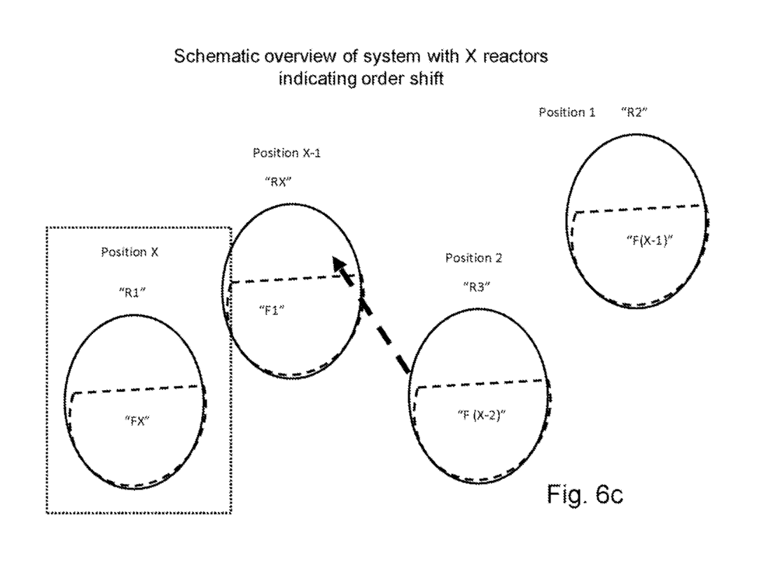

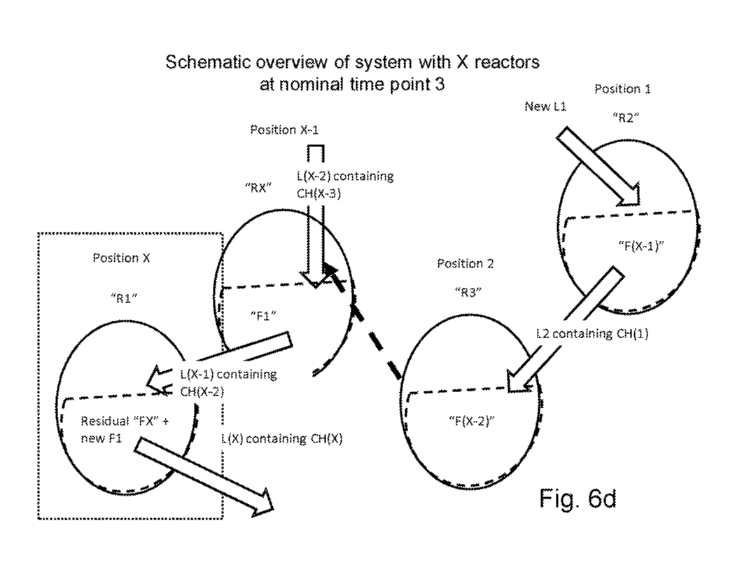

FIGS. 6a through 6d are schematic representations of a system with X reactors according to an exemplary embodiment of the invention in various stages of operation. For ease of comprehension, only four reactors, numbered R1, R2, R3 and RX are pictured in FIGS. 6a-6d. This nomenclature is simplified relative to the nomenclature used to describe FIGS. 5a to 5c for ease of comprehension. In the following description, the designation “downstream” indicates left or leftwards and the designation “upstream” indicates right or rightwards. “Downstream” in this context is from the point of view of the acid, which is introduced into the system at the upstream point so as to contact the most hydrolyzed substrate. As the acid flows downstream it becomes progressively more dilute due, at least in part, to release of water by hydrolysis of the substrate. Alternatively or additionally, the concentration of sugars dissolved in the acid increases as it moves downstream.

In FIGS. 6a through 6c the leftward pointing dashed arrow represents any reactors which may be present between R3 and RX. If no additional reactors are present in the system RX=R4. If 1 additional reactor is present RX=R5. If 2 additional reactors are present RX=R6, and so on.

For typical woody substrates (e.g. pine chips) a number of reactors between 4 and 10, for example 6 to 8 can be used. Optionally 7 reactors are employed. In FIGS. 6a to 6d the substrate is indicated as “F” for feedstock. Different aliquots of F are indicated by numerals from 1 to X, indicated how long they have been in the system, from 1 to X.

Referring now to FIG. 6a, the schematic overview of the system with X reactors is depicted at a nominal time point 1 at which the system has already been in operation for some time. In this view, and subsequent views, the HCl containing liquid aliquot (L) moves downstream from right to left. In some exemplary embodiments of the invention, the solid containing aliquot (F) remains stationary in a specific reactor for a relatively long period of time and is successively washed by aliquots of (L) as they are transferred from reactor to reactor. Periodically, the most upstream reactor (R1 in FIG. 6a) is moved to the most downstream position “X” and an additional aliquot of F is introduced into it (see FIG. 6d). In some exemplary embodiments of the invention, the most hydrolyzed substrate “residual FX,” is removed prior to introduction of new F1. In this way the solid containing aliquot F moves upstream, becoming progressively more hydrolyzed as it goes. In some exemplary embodiments of the invention, the rate of upstream flow of solids is slower than the rate of downstream flow of liquids.

Residence time (RT) in the system can be determined for various components of the system as described hereinbelow. In some exemplary embodiments of the invention increasing RT (Lignin):RT (L) can contribute to an increase in efficiency of hydrolysis. In some cases, this increase in efficiency can be realized as an increase in total yield of soluble carbohydrates (CH) per unit of F and/or an increase in yield of soluble carbohydrates (CH) per unit of applied acid.

Referring again to FIG. 6a, the most recently added aliquot of L, designated L1, is present in reactor R1 at the most upstream position in the system. The concentration of acid in L1 is the highest concentration present in the system. Reactor R1 also contains aliquot FX of the solid aliquot containing the hydrolysis substrate. Although all aliquots of F are depicted as being the same size, acid hydrolysis tends to decrease the volume and mass of F as it moves upstream.

For example, aliquot FX has already been washed with (X−1) aliquots of acid containing solution (L). As a result, much of insoluble polysaccharide (IPS) originally present in FX has been hydrolyzed to produce soluble sugars (CH) and removed. As a result, the volume and mass of FX are reduced relative to the time when FX was introduced into the system. Of the mass remaining in FX, the fraction of lignin relative to total solids is increased relative to the time when FX was introduced into the system, although the amount of lignin has not increased.

The next most recently added aliquot of L, designated L2, is present in reactor R2 one position downstream in the system. The concentration of acid in L2 is lower than L1 due to dilution by soluble carbohydrates and water released from FX by hydrolysis. Reactor R2 also contains aliquot FX−1 of the solid aliquot containing the hydrolysis substrate. Aliquot FX−1 has already been washed with (X−2) aliquots of acid containing solution (L). The effect is similar to that described for FX, but to a slightly lower degree.

The next most recently added aliquot of L, designated L3, is present in reactor R3 one additional position downstream in the system. The concentration of acid in L3 is still lower than L2 due to dilution by soluble carbohydrates and water extracted from FX and FX−1. Reactor R3 also contains aliquot FX−2 of the solid aliquot containing the hydrolysis substrate. Aliquot FX−2 has already been washed with (X−3) aliquots of acid containing solution (L). The effect is similar to that described for FX−1, but to a slightly lower degree.

At the extreme downstream side of the system, the oldest aliquot of L in the system, designated LX, is present in reactor RX. The concentration of acid in LX is the lowest in the system due to dilution by soluble carbohydrates and water produced by hydrolysis of FX through FX−(X−1). For example if L1 contains 42% HCl by weight when it is introduced into the system, LX may contain 30% HCl by weight. Reactor RX also contains the most recently added aliquot F1 of the solid aliquot containing the hydrolysis substrate. Aliquot F1 has not been washed by any previous aliquots of acid containing solution (L). As a result, the lignin concentration is relatively low, although the amount of lignin is similar to that found in other reactors in the system. The amount of soluble carbohydrate in F1 is the lowest of any aliquot of F in the system and the amount of insoluble polysaccharides (primarily celluloses and hemicellulose) is the highest.

Referring now to FIG. 6b, a schematic overview of the same system depicted in FIG. 6a is depicted at a later time point 2 in which a new L1 aliquot is introduced. In order to permit this introduction, the oldest aliquot of L (LX) is removed from reactor RX. LX contains the majority of the soluble carbohydrates present in RX, although much of this material may be the result of hydrolysis in upstream reactors. Some soluble carbohydrates may remain trapped in F1 when L(X) is removed. Alternatively or additionally, some fine particles of lignin may leave with the liquid stream LX. In some exemplary embodiments of the invention, the total amount of lignin in LX is less than 2, less than 1, less than 0.5 or even less than 0.1% by weight.

L(X) is removed from the system and processed to separate and recover the dissolved carbohydrates, water and acid (and lignin if present). In some exemplary embodiments of the invention, L(X) is used to pre-hydrate a new aliquot of F prior to its introduction into the system (not depicted). It is important to note that not all soluble sugars [CH(X)] in LX have the same residence time. Those sugars release by hydrolysis under relatively low acid concentrations (e.g. pentoses from hemicellulose) have a shorter residence time than those sugars released by hydrolysis at higher acid concentrations in the upstream part of the system.

It is now possible to add aliquot L(X−1) from the reactor immediately upstream of RX [indicated as “new L(X)” in the drawing]. This process is repeated successively upstream as indicated by the hollow arrows. When the aliquot of L previously resident in R1 has been transferred to R2, a new L1 aliquot is added to R1.

At the same time, additional solids (F) are added to the system to provide additional substrate for hydrolysis. In some exemplary embodiments of the invention, the order of the reactors is changed as indicated in FIG. 6c. In some embodiments of the invention, the most upstream reactor R1 is moved to the most downstream position “X”. Although this move is depicted as a physical change of position for clarity, in actual practice it may be accomplished by changing flow paths of L and/or F. FIGS. 6c and 6d indicate reactor names and aliquots of F in quotation marks to show their identities from before the position switching. As a result, these names are no longer reflective of position within the system.

Referring now to FIG. 6d, a new F1 aliquot is added to reactor “R1” at position X. In some exemplary embodiments of the invention, the residual FX in the reactor is removed prior to this addition. In some embodiments, the residual FX is substantially all lignin at this stage. In some embodiments of the invention, the lignin is processed to recover soluble sugars and/or acid and/or water. This processing can be, for example, as described in co-pending PCT application IL 2011/000424 which is fully incorporated herein by reference. L (X−1) is harvested from R(X−1) (i.e.“R3”) and transferred to “R1”. After a suitable amount of hydrolysis time, L(X) is removed from the reactor at position X and processed to recover soluble polysaccharides, water and acid as described above in the context of FIG. 6b. Each successive upstream reactor is emptied of the relevant aliquot of L, which is passed to the nearest downstream reactor as described above in the context of FIG. 6b. A new L1 aliquot is added to reactor “R2” which is now in the most upstream position in the system.

Optional Alternative Lignin Treatment Strategy

In some exemplary embodiments of the invention, the residual FX is contacted with an S1 containing extractant to remove HCl. One or more rounds of contacting may be conducted. Optionally, contacting is in a countercurrent mode. Separation of solid lignin from the extractant may include filtration and/or centrifugation.

In some exemplary embodiments of the invention, a ratio between the S1 extractant and FX is at least 0.2, at least 0.3 or at least 0.4 on a weight basis. Alternatively or additionally, a ratio between the S1 extractant and FX is less than 5, less than 4, than 3, less than 2 or even less than 1.1 on a weight basis. In some exemplary embodiments of the invention, a single contacting stage between FX and the S1 extractant removes 70%, 75%, 80% or 85% or intermediate or greater percentages of the HCl from the lignin

The degree (yield) of HCl removal from the lignin can vary with the efficiency of separating the liquid from the solid lignin. In some exemplary embodiments of the invention, separating a liquid, including S1, HCl and water from solid lignin is easier than separating lignin solids from an aqueous solution of HCl.

In some exemplary embodiments of the invention, separated lignin solids after extraction with an S1 extractant, are at least 25% wt dry matter, at least 30% wt, at least 34% wt or at least 38% wt or intervening or greater percentages.

Exemplary Simulated Moving Bed Residence Time Calculations:

Optionally, residence time (RT) in hours of HCl containing liquid (L) in the system can be calculated as:

RT (L)=[total volume of (L) system]/[volume of added aliquot of (L)/hours between aliquots of (L)].

Optionally, residence time (RT) in hours of soluble carbohydrates (CH) in the system can be calculated as:

RT (L)=[total amount of (CH) system]/[amount of (CH) removed in L(X)/hours between aliquots of (L)].

Optionally, residence time (RT) in hours of Lignin in the system can be calculated as:

RT (Lignin)=[total amount of Lignin in system]/[average amount of Lignin removed].

In some exemplary embodiments of the invention RT (L) is less than 30 hours. For example, for a system with 4 to 10 reactors, RT (L) can be in the range of 12 to 20 hours, in some cases 15.5 to 16.5 hours, optionally about 16 hours.

In some exemplary embodiments of the invention RT (CH) is similar to or less than RT (L). In some exemplary embodiments of the invention, RT (CH) is less than 30 hours. For example, in a system with 4 to 10 reactors, RT (CH) can be in the range of 10 to 18 hours, in some cases 13.5 to 14.5 hours, optionally about 14 hours. In some exemplary embodiments of the invention RT (Lignin) is greater than 20 hours. For example, in a system with 4 to 10 reactors, RT (Lignin) can be in the range of 20 to 36 hours.

Exemplary Simulated Moving Bed Hydrolysis Method:

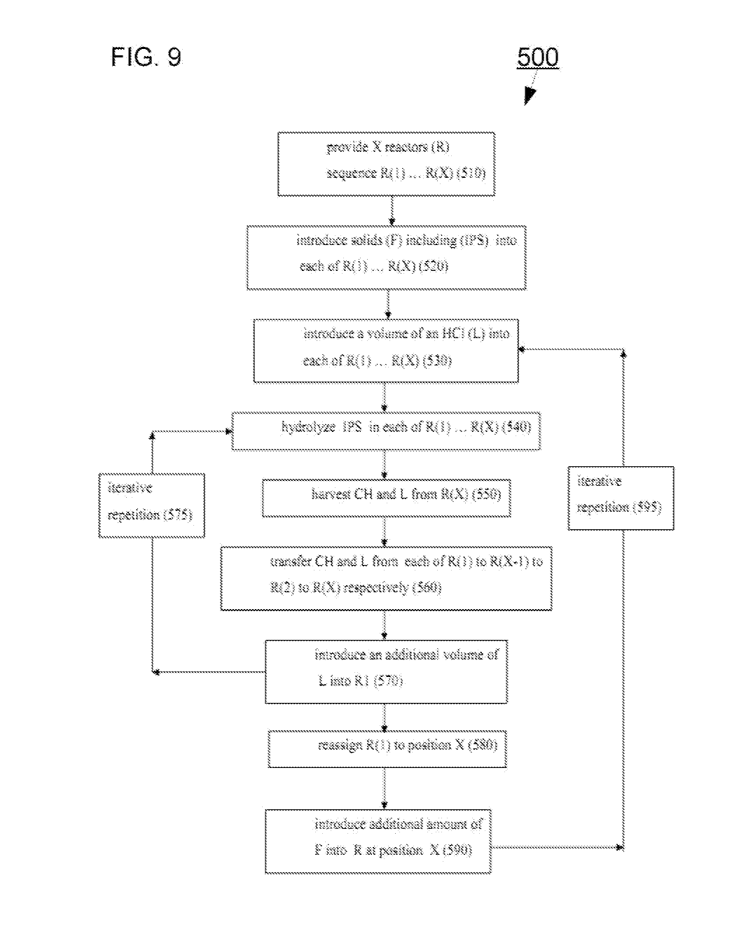

FIG. 9 is a simplified flow diagram indicating events associated with an exemplary method for production of water soluble carbohydrates according to some exemplary embodiments of the invention indicated generally as 500. The depicted method begins with providing 510 a plurality of X reactors (R) in a nominal sequence R(1). R(X). An amount of solids (F) comprising water insoluble polysaccharides (IPS) is then introduced 520 into each of R(1). R(X). A volume of an HCl-comprising liquid (L) is then introduced 530 into each of R(1). R(X). In some exemplary embodiments of the invention, introducing 530 of L is conducted by applying drops of said HCl-comprising liquid onto F. In some exemplary embodiments of the invention, the drops create a trickling bed effect as they flow downwards through F.

Hydrolysis 540 is then conducted on at least a portion of the IPS in each of R(1). R(X) by means of L to produce water soluble carbohydrates (CH) and residual solids. In some exemplary embodiments of the invention, hydrolysis 540 is conducted for at least 1 hour. Alternatively or additionally, hydrolysis 540 is conducted for not more than 10 hours. In some exemplary embodiments of the invention, hydrolysis 540 is conducted for 3.5 to 4.5 hours, in some cases about 4 hours, or up to 5, 4, 3, 2, or 1 hours.

In some exemplary embodiments of the invention, L is recycled through F during hydrolysis 540. In some exemplary embodiments of the invention, the recycling is conducted by applying drops of L onto F. In some exemplary embodiments of the invention, F floats on L within R so that application of the drops is on an upper surface of F and a trickling bed effect is created. In some exemplary embodiments of the invention, a recirculation flow rate of L within a single reactor R is 10, 20, 50, 60 or 100 or more times greater than a downstream flow rate of L between reactors R in the system.

In the depicted exemplary embodiment, at least a portion of CH and L are then harvested 550 from R(X). At least a portion of CH and L are then transferred 560 from each of reactors R(1) to R(X−1) to reactors R(2) to R(X) respectively.

In some exemplary embodiments of the invention, any solid residue which remains after said solids have progressed sequentially through the reactors from R(X) to R(1) is harvested. In some exemplary embodiments of the invention, a weight/weight ratio of HCl:(HCl+water) in the solid residue is at least 0.32, at least 0.35, at least 0.37, at least 0.39 or at least 0.40.

Alternatively or additionally, in some exemplary embodiments of the invention, a weight/weight ratio of carbohydrates to solids in the solid residue is less than 0.1, less than 0.075, less than 0.05 or less than 0.03. In some exemplary embodiments of the invention, the solid residue contains primarily lignin, optionally with inorganic ash and/or un-hydrolyzed cellulose. According to various exemplary embodiments of the invention the residual solid is removed as a slurry with a solid content of 5, 10, 15, 20, 25, 30, 35, 40, 45% or 50% or more by weight. The liquid portion of the slurry comprises HCl, water and dissolved sugars. In some exemplary embodiments of the invention, the slurry is processed to recover these components of the liquid portion of the slurry.

In the depicted exemplary embodiment, an additional volume of L is then introduced 570 into R1. In some exemplary embodiments of the invention, one or more iterative repetitions 575 of 540 to 570 are conducted.

In some exemplary embodiments of the invention, R(1) is reassigned 580 to position X in said nominal sequence. This results in reassignment of each of R(X) to R(2) to positions (X−1) to 1 respectively in said nominal sequence. In some cases, the majority of F in R(1) has been broken down at the time of this reassignment. In some exemplary embodiments of the invention, the majority of solid material remaining in R(1) at this stage is lignin. In some cases, substantially only lignin remains.

Following this reassignment, an additional amount of F can be introduced 590 into R situated in position X. In some exemplary embodiments of the invention, iterative repetitions 595 of 530 to 580 are conducted.

It will be appreciated that after a large number of repetitions 595, method 500 can be described as providing (510) a plurality of X reactors (R) in a nominal sequence R(1). R(X) where each reactor contains an amount of solids (F) comprising water insoluble polysaccharides (IPS) and a volume of an HCl-comprising liquid (L) into each of R(1). R(X). At this stage of operation, depicted exemplary method 500 continues with hydrolyzing 540, harvesting 550 transferring 560 introducing 570, reassigning 580 and introducing 590 followed by iterative repetitions 595 substantially as described hereinabove.

Method 500 can also be described as a method for production of water soluble carbohydrates which involves providing 510 a plurality of X reactors (R) in a nominal sequence R(1). R(X), causing solids (F) comprising water insoluble polysaccharides (IPS) to progress (580 and 590) sequentially from R(X). R(1) and causing an HCl-comprising liquid (L) to progress sequentially from R(1). R(X) (530, 540, 550, 560, 570 and 575). In some exemplary embodiments of the invention, a rate of progression of L is greater than a rate of progression of F.

Exemplary Trickling Bed Recirculation:

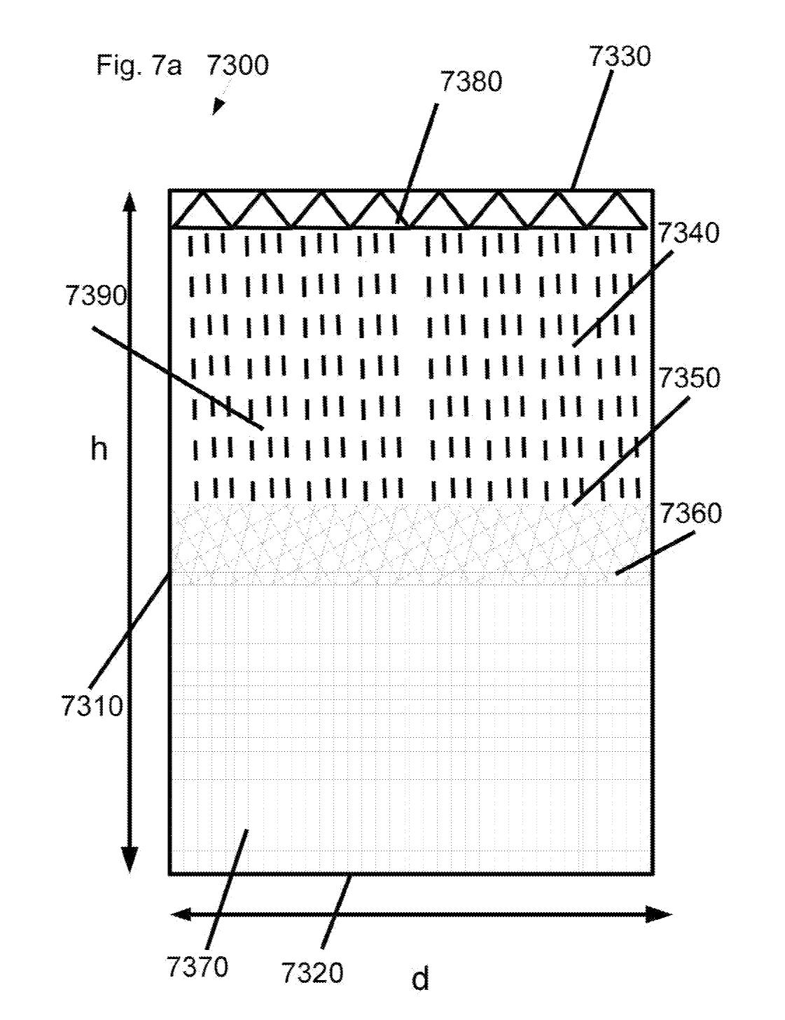

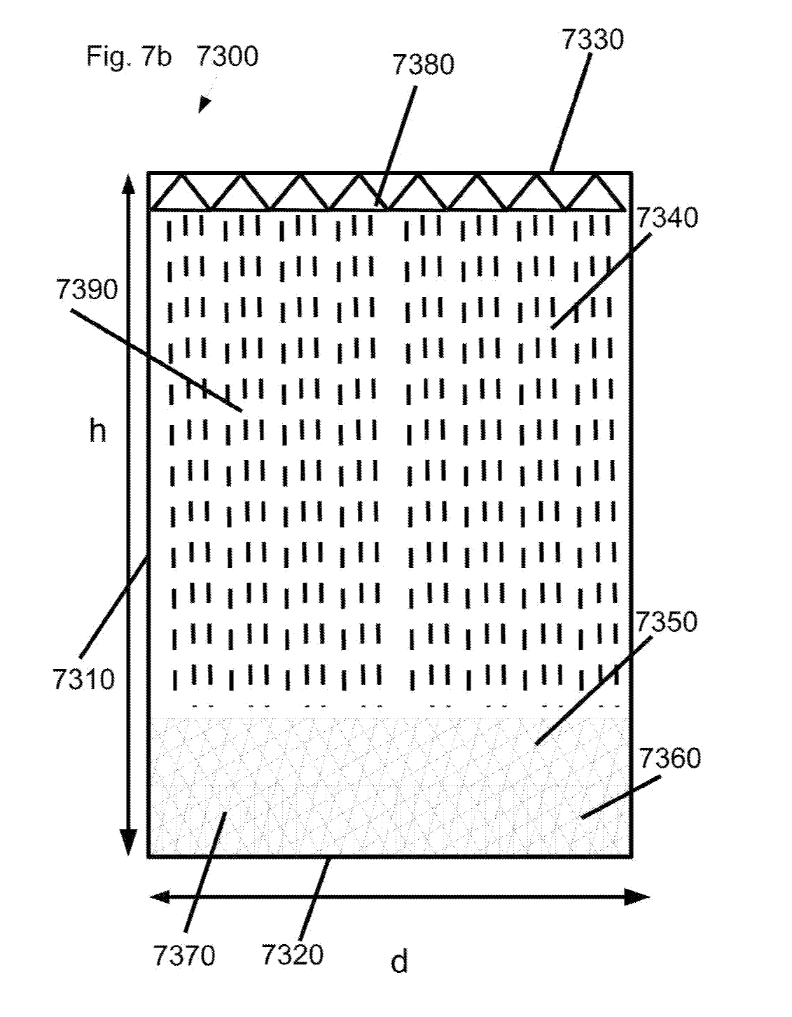

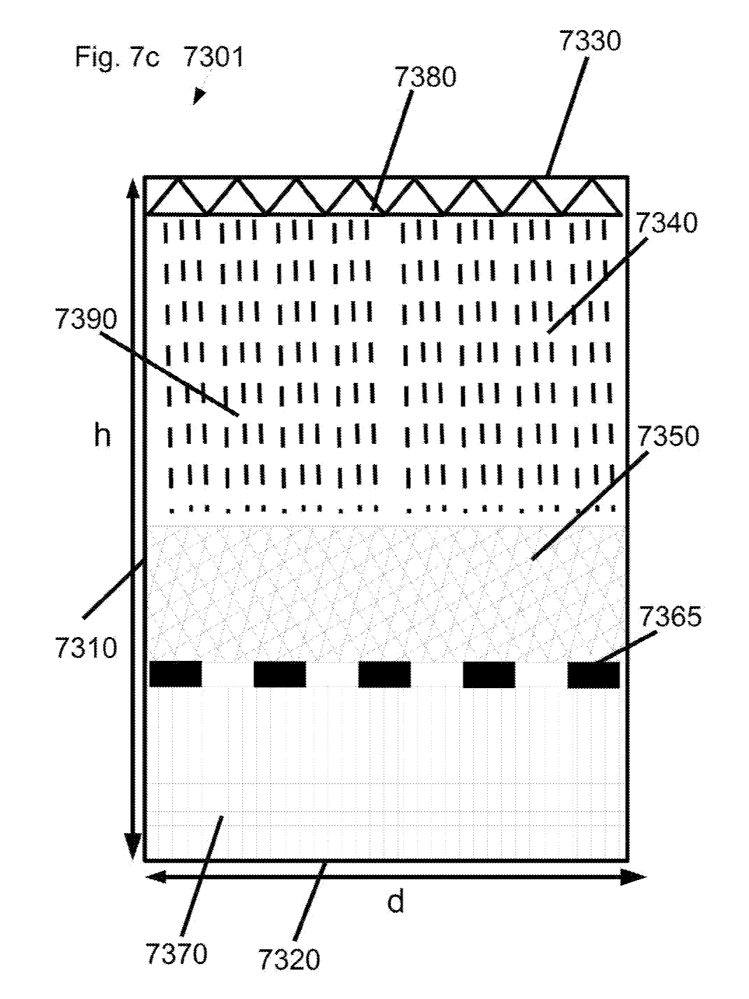

FIG. 7a is a schematic representation of an exemplary embodiment of a trickling bed reactor (R) indicated generally as 7300 suitable for use in systems according to some embodiments of the invention. Depicted reactor 7300 is defined by a cylindrical wall 7310, a base 7320 and an optional cover 7330 to prevent escape of fumes during use. The structural elements define an internal volume 7340.

The cylinder is characterized by a height h and a diameter d. In some exemplary embodiments of the invention, an aspect ratio h:d is greater than 3, greater than 4, or about 5 or more. In some exemplary embodiments of the invention, the trickling effect varies with the aspect ratio.

Depicted exemplary reactor 7300 includes a set of drippers 7380 configured to produce an aliquot of drops 7390 which covers substantially all of a cross sectional area of the cylinder at an upper surface of solids F(7350) provided in 7340. Acid containing liquid 7370 is depicted as being present in a lower portion of 7340.

In some exemplary embodiments of the invention, the volume of liquid 7370 is 30 to 50%, optionally about 40%, of internal volume 7340. In other exemplary embodiments of the invention, the volume of liquid 7370 is 25 to 33% of internal volume 7340. Alternatively or additionally, the volume of solids 7350 is about 10 to 30%, 15 to 20%, optionally about 17%, of internal volume 340. Since the specific gravity of liquid 7370 is greater than 1, and the specific gravity of solids 7350 is less than 1, solids 7350 float on liquid 7370 creating an interface layer 7360. The trickling bed effect is reduced as the size of interface layer 7360 increases.

FIG. 7b depicts a reactor 7300 which is identical to that of FIG. 7a in every respect. However, in the depicted operational state, solids 7350 have become saturated with liquid 7370 so that the difference in specific gravities is decreased. In order to compensate for this change, a smaller volume of liquid 7370 may be employed so that the trickling bed effect is maintained.

FIG. 7c depicts a reactor 7301 which is similar to that of FIG. 7a in most respects but includes a liquid permeable barrier 7365 to support solids 7350. Barrier 7365 may be provided, for example, as a stainless steel screen or plate with holes of a predetermined size. This configuration assures that at least some of solids 7350 will remain exposed to drops 7390 so that the trickling bed effect is maintained even as the volume of solids 7350 decreases due to hydrolysis. In the depicted embodiment, barrier 7365 is depicted above the level of liquid 7370. In alternate exemplary embodiments of the invention, barrier 7365 may be positioned slightly below the upper surface of liquid 7370. In some exemplary embodiments of the invention, this will insure that the most acid resistant portions of solid 7350 remain submerged in acid all the time.

Mechanical Explanation of Exemplary Simulated Moving Bed System:

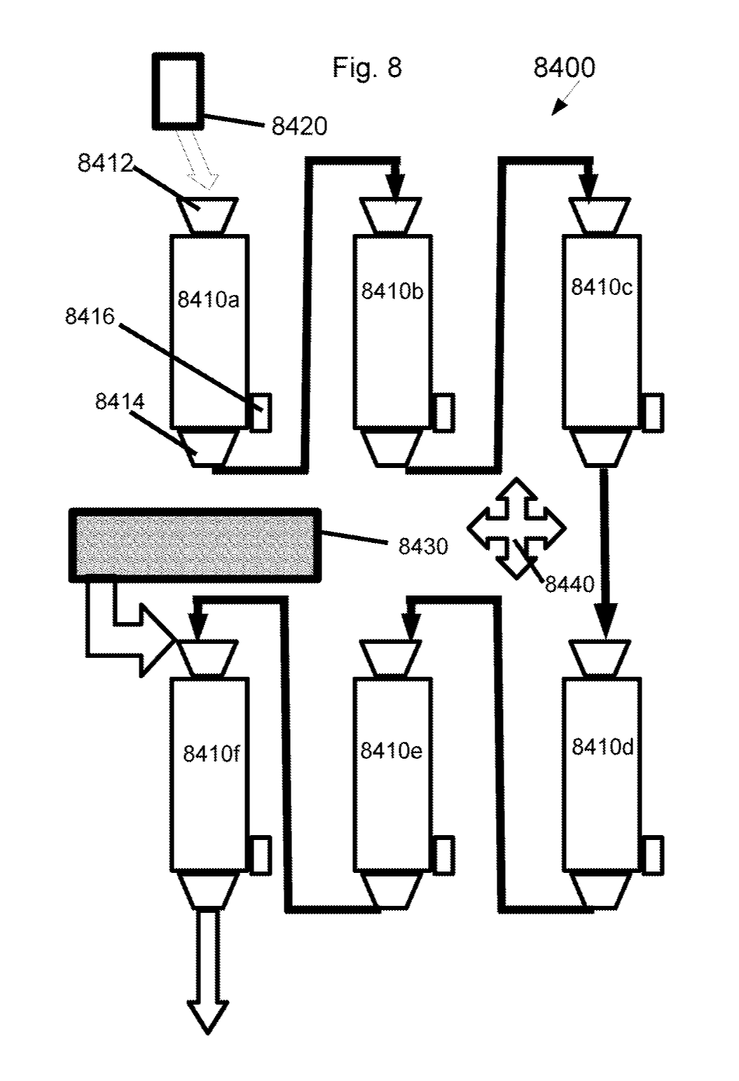

FIG. 8 is a schematic representation of a system for acid hydrolysis according to exemplary embodiments of the invention, depicted generally as 8400, including control components

Depicted exemplary system 8400 includes an acid reservoir 8420 adapted to contain fuming hydrochloric acid.

System 8400 also contains a plurality of X reactors R placed in positions 1 . . . X designated as 8410a to 8410f. Although six reactors are depicted in the figure, the actual number employed may be varied according to various operational considerations. Each reactor 8410 includes 8412 an inlet port, an outlet port 8414 and a recirculation mechanism 8416. The recirculation mechanism 8416 includes a pump. Optionally, recirculation mechanism 8416 includes a sprinkler such as 7380 of FIG. 7a.

Channels of fluid communication (depicted as bold arrows) are arranged to conduct a liquid from an outlet port 8414 of one reactor to an inlet port 8412 of a different reactor. The flow of liquids is in a “downstream direction” as explained in the context of FIGS. 6a to 2d hereinabove.

Depicted system 8400 includes a controller 8440 depicted generically as a four headed hollow arrow. According to various exemplary embodiments of the invention controller 8440 is adapted to perform one or more of several functions.

In some exemplary embodiments of the invention, one function of controller 8440 is to periodically empty a liquid content of R(X) from its outlet port, and empty liquid contents of R(1) to R(X-1) from their outlet ports and direct these contents to inlet ports of R(2) to R(X) respectively and introduce new acid to the R(1) inlet port.

In some exemplary embodiments of the invention, another function of controller 8440 is to occasionally move R(1) to position X, and each of R(X). R(2) to positions (X−1) . . . 1 respectively. In some exemplary embodiments of the invention, these occasional position switches occur after several of the liquid emptying and transfer events described in the previous paragraph. Optionally, the occasional position switches occur about every X±2 emptying and transfer events. As indicated above, this switching can be by altering of one or more relevant flow paths, as opposed to a change in physical location.

Alternatively or additionally, in some exemplary embodiments of the invention, controller 8440 operates recirculation mechanisms 8416.

In some exemplary embodiments of the invention, all of the parts of system 8400 are resistant to fuming HCl, optionally 42% HCl. For example, resistance can be achieved by construction from resistant materials and/or shielding from contact with the acid.

In some exemplary embodiments of the invention, system 8400 includes a solids hopper 430 adapted to deliver a hydrolysis substrate to R(X) (8410f in the figure).

Optionally, system 8400 includes a pretreatment vessel (not pictured) adapted for at least one pre-treatment selected from thermomechanical disruption (e.g. steam explosion and/or a plug screw feeder) solvent extraction (e.g. with acetone and/or a weak acid) and hydration.

In some exemplary embodiments of the invention, each of reactors 8410 is cylindrical and is characterized by an aspect ratio height:diameter of 4.5 to 5.5.

Exemplary Simulated Moving Bed System Behavior Parameters:

After the system has been running through many iterative repetitions 575 and/or 595 one or more of the following characteristic behaviors may be observed (see FIG. 9).

In some cases at least one of the reactors contains L:F at a weight ratio greater than 3 at some point during hydrolysis 540.

Alternatively or additionally, at least one of L is characterized by an HCl:(HCl+water) weight ratio greater than or equal to 0.35.

Alternatively or additionally, the solid residue may be characterized by an HCl:(HCl+water) weight ratio greater than or equal to 0.32, 0.35, 0.37 or 0.40.

Alternatively or additionally, a CH:solids ratio in the solid residue may be less than 0.1, less 0.05 or less than 0.03 on a weight basis.

Alternatively or additionally, at the end of at least x iterative repetitions 575, a ratio of CH:(CH+water) in a hydrolyzate in at least one of reactors R is at least 0.20 by weight.

Alternatively or additionally, at the end of at least x iterative repetitions 575, degradation of carbohydrates to a furfural produces a ratio of CH:furfural of at least 30 in the hydrolyzate on a weight basis in the hydrolyzate in at least one of the reactors. Alternatively or additionally, a ratio of CH:furfural is at least 30 on a weight basis in the at least a portion of CH and L harvested from R(X). Optionally, the furfural includes hydroxymethyl furfural.

Exemplary Aliquot Behavior Parameters in a Simulated Moving Bed System:

In some exemplary embodiments of the invention, after the system has been running through many iterative repetitions 575 and/or 595 certain characteristic behaviors may be observed (see FIG. 9).

The term “aliquot” as used in this specification and the accompanying claims refers to an amount of material introduced into the system and/or withdrawn from the system and/or transferred from one compartment (and/or position) within the system. In the case of liquid and/or solid materials, aliquots can optionally be described in terms of volume or mass. It is stressed that an aliquot of a specific component can change as it moves through the system.

For example, an aliquot of solid substrate F1 introduced into RX is typically reduced in both mass and volume as it is progressively moved upstream to position 1 in the system. In some exemplary embodiments of the invention, F1 is a divided solid substrate, for example wood chips. This reduction is primarily the result of acid hydrolysis. Alternatively or additionally, intermixing of aliquots may occur. For example F1 (see FIG. 6b) may carry with it a portion of L and/or CH nominally belonging to L(X) and CH(X) respectively as it migrates upstream.

Concurrently, an aliquot of acid containing liquid L1 introduced into R1 is typically increased in both mass and volume as it is progressively moved downstream to position X in the system. This increase is primarily the result of acid hydrolysis which results in the addition of CH and or water to L. In some embodiments, addition of water is reduced by pre-treating of F to remove water prior to introduction into the system. This increase may be offset to some degree by a tendency of F to retain L, thereby trapping CH.

Aliquots of CH are not introduced into the system but are “born” as a result of acid hydrolysis. Aliquots of CH are first detectable in L moving from R1 to R2. Typically, aliquots of CH are permitted to accumulate in L as they flow downstream to position X where they are harvested from RX. This accumulation contributes to an increase in CH aliquot size as CH moves downstream. In some embodiments, degradation of CH contributes to a decrease in CH aliquot size.

Exemplary Deviations from Theoretical Aliquot Behavior in a Simulated Moving Bed System:

Referring again to FIG. 6b and introduction of new L2 into R2: In theory, the new L2 includes all of L1 introduced in R1 in a previous cycle. In actual practice, some portion of L1 introduced in R1 in a previous cycle will remain in F(X) in R1. Similarly some of (CH1) from R1 will remain in F(X) in R1. This means that as each aliquot of L and/or CH moves downstream, it leaves behind a “tail”, extending through one or more upstream reactors, which follows the corresponding aliquot to which it belongs as the aliquot moves downstream.

Thus, although F1 contains primarily solid substrate when it is introduced into the system in RX, it becomes mixed with L and or CH as it moves upstream. In some exemplary embodiments of the invention, this contributes to a lengthening of the tail described above.

Alternatively or additionally, reduction of an amount of solid substrate present in any specific aliquot of F as it moves upstream can contribute to a decrease in the amount of L and or CH trapped in F. Typically, this reduction is a result of the hydrolysis reaction. In some embodiments, an outflow of solids with a removed aliquot of L can contribute to this reduction. In some exemplary embodiments of the invention, this reduction contributes to a shortening of the tail described above.

For simplicity, the above description describes the aliquots of various system components as moving in their entirety, although system behavior related to tails can have importance in actual implementation.

Exemplary Simulated Moving Bed System Control Parameters:

In some exemplary embodiments of the invention, hydrolysis 540 (FIG. 9) is conducted at a temperature≦50, ≦45, ≦40, ≦35° C. or less than 30° C. throughout all X reactors (R). Optionally, hydrolysis 540 in reactor X is conducted at a temperature≦20, ≦17, ≦15 or ≦12° C.

Alternatively or additionally, hydrolysis 540 in reactor 1 is conducted at a temperature≦50, ≦45, ≦40, ≦35° C. or less than 30° C. In some exemplary embodiments of the invention, there is a gradient of increasing hydrolysis temperatures from R1 to RX.

In some exemplary embodiments of the invention, the number of reactors X is less than 15 and/or greater than 2. In some exemplary embodiments of the invention, X is 4 to 8. In other exemplary embodiments of the invention, X is 3 to 4.

In some exemplary embodiments of the invention, a residence time of L is shorter than a residence time of F.

Exemplary Optional Upstream Processing:

In some exemplary embodiments of the invention, CH and L from R(X) are used to hydrate the additional amount of F prior to its introduction 590.

In some exemplary embodiments of the invention, F is extracted with an organic solvent prior to its introduction 590 (and/or 530) to remove an extractable fraction. Optionally, the extractable fraction comprises at least one tall oil. In some exemplary embodiments of the invention, the organic solvent includes acetone. Optionally, a weak acid, such as sulfurous acid or acetic acid is added to the acetone. This pre-extraction process is described in greater detail in co-pending applications U.S. 61/524,350; U.S. 61/539,196; U.S. 61/539,239; U.S. 61/528,257 and U.S. 61/539,272 each of which is fully incorporated herein by reference. In some embodiments, pre-extraction contributes to an improved flow of liquids during hydrolysis and/or filtration. Optionally, the pre-extraction includes steam explosion.

Exemplary Asymmetric Simulated Moving Bed

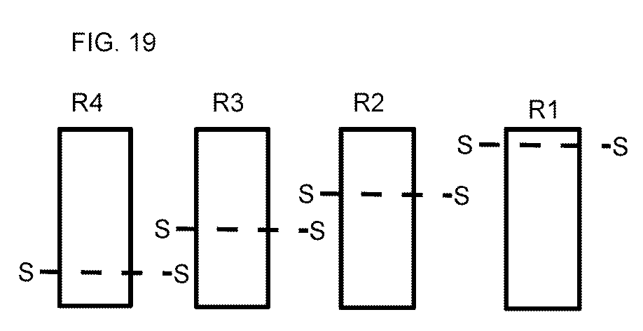

FIG. 19 is a simplified schematic representation of simulated moving bed reactor system as described in the context of FIGS. 6a through 6d with four reactors (R1 to R4). As in FIG. 6, the flow of solid substrate is from left to right and the flow of liquids is from right to left. For each reactor in FIG. 19 line S-S indicates relative amount of solid substrate submerged in reaction liquid in the specific reactor

According to various exemplary embodiments of the invention a change in volume of solid and/or a volume of liquid in the reactor can contribute to a difference in the height of S-S in each depicted reactor.

Exemplary Theoretical Explanation of Simulated Moving Bed Process:

Terminology used in this section is more detailed than that used in preceding sections and may not be completely linguistically consistent with those sections.

In some exemplary embodiments of the invention, a method for the high-yield production of carbohydrates from insoluble polysaccharides is provided comprising (i) providing a plurality of x reactors R(n), . . . R(n+x−1) ordered in a cyclic sequential order, having a changeable nominal first reactor in the reactor sequence along the cyclic order, wherein x is a predetermined number of reactors and n is a designation of said nominal first reactor, (ii) introducing a solid containing aliquot F in each of said x reactors R(n) . . . R(n+x−1) wherein each respective aliquot is designated F(n) . . . F(n+x−1) according to the reactor into which it is introduced, said aliquot containing hydrolysable insoluble polysaccharides, the latter being designated as IPS(n) . . . IPS(n+x−1) according to the reactor into which it is introduced respectively, (iii) introducing HCl-comprising liquid aliquot designated L(n) . . . L(n+x−1) into reactors R(n) . . . R(n+x−1) respectively, (iv) performing a reaction step comprising (a) contacting liquid aliquot L(n) . . . L(n+x−1) with said solid containing aliquot F(n) . . . F(n+x−1), in each of the respectively designated reactors R(n) . . . R(n+x−1), whereby fractions of said hydrolysable polysaccharides are hydrolyzed into soluble carbohydrates designated CH(n+1) . . . CH(n+x), forming new liquid aliquot designated L(n+1) . . . L(n+x), containing less than 2% wt solids, said liquid aliquot comprising hydrochloric acid and said soluble carbohydrates CH(n+1) . . . CH(n+x), and forming new solid-containing aliquot designated F1(n−1) . . . F1(n+x−2) in each of said designated reactors R(n) . . . R(n+x−1), respectively, said new solid-containing aliquot comprising insoluble polysaccharide designated IPS1(n−1) . . . IPS1(n+x−2), respectively, followed by (b) separating L(n+1) . . . L(n+x) from R(n), . . . R(n+x−1), respectively, (c) removing the new solid aliquot F1(n−1) from R(n), thereby forming a removed solid aliquot, (d) removing the separated new liquid aliquot L(n+x) from R(n+x−1) thereby forming a carbohydrate-containing hydrolyzate product and optionally separating carbohydrate from said hydrolyzate product, (e) introducing a new HCl comprising liquid aliquot L(n) into the reactor R(n+1) newly designated as new first sequential reactor R1(n) and introducing the separated liquid aliquot L(n+1) . . . L(n+x−1) from step (iv)a, according to the cyclic order, into the reactors R(n+2) . . . R(n+x−2) and R(n) newly designated as reactors R1(n+1) . . . R1(n+x−1) and R1(n+x−1), respectively, and (f) introducing a new solid-containing aliquot designated F1(n+x−1) into the reactor in the cyclic sequence newly designated reactor R1(n+x−1), wherein F1(n+x−1) comprises at least 5% weight solid, said solid containing insoluble hydrolysable polysaccharides designated as IPS1(n+x−1), and (v) optionally performing another reaction step according to step (iv) in said newly designated reactors R1(n) . . . R1(n+x−1), re-designated as R(n) . . . R(n+x−1), comprising F1(n) . . . F1(n+x−1), re-designated as F(n) . . . F(n+x−1), and IPS1(n). IPS1 (n+x−1), re-designated as IPS1(n) . . . IPS(n+x−1), wherein (a1) at the end of at least x reaction steps the weight amounts of insoluble polysaccharides in said reactors are in the sequence IPS1(n−1)<=IPS1(n)<= . . . <=IPS1(n+x−1) and (b1) at the end of at least x reaction steps, the net weight ratio of the amount of insoluble polysaccharides in IPS1(n+x−1) relative to the amount in IPS1(n−1) is greater than 10.

This weight ratio of >10 between the insoluble polysaccharide contents of those aliquot indicates that the hydrolysis yield according to these embodiments of the invention is greater than 90%. In some exemplary embodiments of the invention, the hydrolysis yield is greater than 93% and optionally greater than 95%.

According to an exemplary embodiment, contacting is for a residence time of at least 1 hour and according to another exemplary embodiment, it is for a residence time of not more than 10 hours. According to some exemplary embodiments, the residence time is between 1 hour and 10 hours, optionally between 2 hours and 8 hours and optionally between 3 hour and 7 hours.

According to various exemplary embodiments, the contacting comprises at least one of recycling of the liquid aliquot through the respective reactor, mixing, filtering and centrifugation and in said contact step in at least one of the reactors, the weight ratio between the introduced HCl-comprising liquid aliquot and the solid content of said reactor is larger than 3. According to an exemplary embodiment, said separating comprises at least one of filtering and centrifuging.

According to various exemplary embodiments, the weight/weight ratio of HCl to (HCl+water) in at least one introduced HCl-comprising liquid aliquot is ≧0.35, ≧0.39 or ≧0.42. According to another exemplary embodiment, the weight/weight ratio of HCl to (HCl+water) in said removed solid aliquot is ≧0.40, ≧0.42 or ≧0.44.

The new solid aliquot F1(n−1), removed from R(n), comprises solid composed essentially of lignin. That lignin is wetted with a solution highly concentrated with HCl. According to an exemplary embodiment, HCl is separated from said lignin in said solid aliquot and recycled to the hydrolysis. Optionally the lignin separated from the acid is used for various applications, where low acidity and high purity are required. According to various known methods of hydrolysis, the solid aliquot comprises carbohydrates resulting from the hydrolysis of said polysaccharides. Those carbohydrates are difficult to separate from the lignin, resulting in carbohydrate product losses and/or in the formation (due to carbohydrate degradation) of impurities (e.g. furfurals) in the separated lignin. The method of the present invention solves that problem. Thus, according to an exemplary embodiment, the weight/weight ratio of carbohydrates to solids in the removed solid aliquot is less than 0.03, less than 0.02 or less than 0.01.

According to an exemplary embodiment, the contacting is conducted at a temperature of less than 25° C.

The exemplary method described enables the formation of hydrolyzate with high carbohydrate concentration, saving much on further treatment, such as recovery of the acid and separation of the carbohydrates from the hydrolyzate. Thus, according to an exemplary embodiment of the invention, at the end of at least x reaction steps, in said hydrolyzate, the weight/weight ratio of total carbohydrates to (total carbohydrates+water) is at least 0.20, at least 0.25 or at least 0.30.

One of the challenges of hydrolyzing insoluble polysaccharides in a lignocellulosic substrate in highly concentrated HCl is avoiding the degradation of the formed carbohydrates. For example, C6 carbohydrates (e.g. glucose, mannose or galactose) tend to react and form hydroxymethyl furfural, while C5 carbohydrates (e.g. xylose and arabinose) tend to react and form furfural. The degradation reduces sugar yields and the degradation products are impurities in the resultant sugar mixture, which in some cases present inhibitors for further use, e.g. in fermentation. The higher the concentration of the acid and/or the temperature and/or the residence time, the higher is hydrolysis yield and the higher is that degradation. Thus, it is difficult to reach high hydrolysis yield without causing major degradation of the product sugars. Various exemplary embodiments of the invention solve this problem to varying degrees.

Thus, according to an exemplary embodiment, degradation of carbohydrates to hydroxymethyl furfural takes place and, at the end of at least x reaction steps, in said hydrolyzate, the weight/weight ratio of total carbohydrates to hydroxymethyl furfural is at least 30. According to another exemplary embodiment, degradation of carbohydrates to furfural takes place and, at the end of at least x reaction steps, in said hydrolyzate, the weight/weight ratio of total carbohydrates to furfural is at least 30.

According to an exemplary embodiment, the ratio between IPS1(n−1) and IPS1(n) is in the range between 0.95 and 1.0. According to another exemplary embodiment, after at least x reaction steps, the difference between CH(n+x−1) and CH(n+x) is greater than the difference between IPS1(n+x−1) and IPS1(n+x−1). According to still another exemplary embodiment, after at least x reaction steps, for at least one reactors pair {R(n+t), R(n+t+1)}, wherein t ranges from 0 to x−2, the difference between CH(n+t) and CH(n+t+1) is greater than the difference between IPS1(n+t) and IPS(n+t)

According to an exemplary embodiment, at the end of at least x reaction steps, the amounts of HCl (in the respective liquid aliquot L(n+1) . . . L(n+x−1) is according to the sequence HCl(n+1)≧1(n+2)≧ . . . ≧HCl(n+x−1). According to another exemplary embodiment, at the end of at least x reaction steps, the amounts of carbohydrates in the respective liquid aliquot L(n+1) . . . L(n+x−1) is according to the sequence CH(n+1)≦CH (n+2)≦ . . . ≦CH(n+x−1).

According to different exemplary embodiments, the number of reactors, x, is less than 15 and more than 3, for example between 4 and 12, in some cases between 5 and 10, for example 6.

According to an exemplary embodiment, removing the new solid aliquot F1 (n−1) from R(n) comprises contacting a solvent-comprising aliquot with the solid aliquot F1(n−1) to form a solid suspended in a suspending solvent. According to an exemplary embodiment, said new solid aliquot comprises solid lignin suspended in an aqueous HCl solution at total solid content of between 1% and 20%, between 3% and 15% or between 3% and 12%. The solid lignin swells in the aqueous solution, which increases its volume and complicates its removal from the reactor. Introducing said solvent-comprising aliquot forms a suspension that is more easily removed from the reactor. According to an exemplary embodiment, said contacting with said solvent-comprising aliquot forms a solid suspended in a suspending solvent, wherein the solid content is in the range between 1% and 15%, or between 2% and 12%.

As indicated above, due to the tendency of lignin to adsorb HCl, the concentration of HCl in the reactor prior to the contacting with the solvent-comprising aliquot, when measured as HCl weight divided by the combined weight of HCl and water, is high. As a result, minor changes in temperature results in increased HCl vapor pressure, which further complicates the removal from the reactor. Said contacting with solvent-comprising aliquot solves that problem as part of the HCl transfers into the suspending solvent. Thus, according to an exemplary embodiment said suspending solvent is enriched in HCl compared with said solvent-comprising aliquot and said suspended solid is depleted in HCl compared with the solid in F1 (n−1). According to an exemplary embodiment, the suspending solvent is a two-phase system comprising an aqueous medium (optionally comprising dissolved solvent) and solvent medium comprising dissolved water. According to another exemplary embodiment, the suspending solvent is of a single phase.

As used here, suspending solvent enriched in HCl compared with said solvent-comprising aliquot, means that the medium in which the solid is suspended—whether of a single phase or comprising multiple phases—has higher HCl/water ratio than the solvent comprising aliquot.

According to an exemplary embodiment, the removed solid aliquot is further treated for the separation of the solid from HCl. According to an exemplary embodiment, said separation of solid from HCl comprises contacting with a washing solvent and/or a displacing solvent. Details of separation protocols may be found, for example, in IL 211020 and PCT/IL2011/000424; each of which is fully incorporated herein by reference. According to an exemplary embodiment, the solvent in said solvent-comprising aliquot is essentially the same solvent as said washing solvent or said displacing solvent.

According to an exemplary embodiment, the insoluble polysaccharide-comprising feed is a lignocellulosic material further comprising extractable compounds (also referred to herein as extractables), such as tall oils and pitch. According to an exemplary embodiment, the method further comprises the steps of providing a feed material comprising hydrolysable insoluble polysaccharides and extractables, extracting said extractables from said feed material with an organic solvent to form an extractables-depleted feed material and using said extractables-depleted feed material as said solid-containing aliquot. According to related embodiment, said extractables comprise tall oil and said organic solvent comprises acetone. The inventors have found that said extracting said extractables facilitates the production of carbohydrates according to the method of the present invention.

It is to be understood that FIGS. 1a, 1b and, 1c provide flow plans of an exemplary embodiment of the processing of the lignocellulosic material illustrated in two frames of the reaction steps according to an exemplary method of the invention after at least x steps.

Several embodiments of the first aspect of the invention are described with reference to FIGS. 1a, 1b and 1c; according to the first aspect of the invention, the method comprises (i) providing a plurality of x reactors R(n) . . . R(n+x−1) ordered in a cyclic sequential order, having a changeable nominal first reactor in the reactor sequence along the cyclic order, wherein x is a predetermined number of reactors and n is a designation of said nominal first reactor, as is illustrated in FIG. 5a, (ii) introducing a solid containing aliquot F in each of said x reactors R(n) . . . R(n+x−1) wherein each respective aliquot is designated F(n) . . . F(n+x−1) according to the reactor into which it is introduced, wherein said solid aliquot are represented in the drawings as already being in the reactors, said aliquot containing hydrolysable insoluble polysaccharides, the latter being designated as IPS(n) . . . IPS(n+x−1) not separately shown, according to the reactor into which it is introduced respectively, (iii) introducing HCl-comprising liquid aliquot designated L(n) . . . L(n+x−1) into reactors R(n) . . . R(n+x−1), respectively, introducing said aliquot into respective reactors is illustrated in FIG. 5a, (iv) performing a reaction step comprising (a) contacting liquid aliquot L(n) . . . L(n+x−1) with said solid containing aliquot F(n) . . . F(n+x−1), in each of the respectively designated reactors R(n) . . . R(n+x−1), whereby fractions of said hydrolysable polysaccharides are hydrolyzed into soluble carbohydrates designated CH(n+1) . . . CH(n+x), forming new liquid aliquot designated L(n+1) . . . L(n+x), shown in FIG. 1b containing less than 2% wt solids, said liquid aliquot comprising hydrochloric acid and said soluble carbohydrates CH(n+1) . . . CH(n+x), and forming new solid-containing aliquot designated F1(n−1) . . . F1(n+x−2) in each of said designated reactors R(n) . . . R(n+x−1), respectively, as the new solid-containing aliquot replace the solid containing aliquot in the reactors the formed aliquot are shown in separate FIG. 5b, said new solid-containing aliquot comprising insoluble polysaccharide designated IPS1(n−1) . . . IPS1(n+x−2), respectively, followed by (b) separating L(n+1) . . . L(n+x) from R(n) . . . R(n+x−1), respectively (c) removing the new solid aliquot F1(n−1) from R(n), thereby forming a removed solid aliquot (d) removing the separated new liquid aliquot L(n+x) from R(n+x−1) thereby forming a carbohydrate-containing hydrolyzate product, separating said formed new aliquot and removing of products is illustrated in FIG. 5b, (e) introducing a new HCl comprising liquid aliquot L(n) into the reactor R(n+1) newly designated as new first sequential reactor R1(n) and introducing the separated liquid aliquot L(n+1) . . . L(n+x−1) from step (iv)a, according to the cyclic order, into the reactors R(n+2) . . . R(n+x−1) and R(n) newly designated as reactors R1(n+1) . . . R1(n+x−2) and R1(n+x−1), respectively, and (f) introducing a new solid-containing aliquot designated F1(n+x−1) into the reactor in the cyclic sequence newly designated reactor R1(n+x−1), wherein F1(n+x−1) comprises at least 5% weight solid, said solid containing insoluble hydrolysable polysaccharides designated as IPS1(n+x−1), the introducing of the formed aliquot into (consecutive) reactors and the introducing of new aliquots being shown in FIG. 5c with respect to the new designation of the reactors wherein the illustrative positioning of the reactor now designated R1(n+x−1) distant from reactor R1(n+x−2) is intended to emphasize the cyclic/repeatable usage of the reactors in the reaction process, and (v) optionally performing another reaction step according to step (iv) in said newly designated reactors wherein R1(n) . . . R1(n+x−1) is re-designated as R(n) . . . R(n+x−1), comprising F1(n) . . . F1(n+x−1), re-designated as F(n) . . . F(n+x−1), and IPS1(n) . . . IPS1(n+x−1), re-designated as IPS(n) . . . IPS(n+x−1) etc.

The term “cyclic” as used herein is not intended to denote the physical positioning array of the sequential reactors and instead is intended to refer to the cyclic nature of the usage of the reactors in the reaction scheme

In an exemplary embodiment the lignocellulosic material introduced into the reactors to form said solid aliquot comprises less than 20% water. In an exemplary embodiment, said solid aliquots introduced in each reactor comprise dried material, the drying of which may be performed by contacting of the solid with an organic solvent to form an extractant comprising water and additional extracts.

In an exemplary embodiment, the method comprises steps of providing a feed material comprising hydrolysable insoluble polysaccharides and extractables, extracting said extractables from said feed material with an organic solvent to form an extractables-depleted feed material and using said extractables-depleted feed material as said solid-containing aliquot. In an exemplary embodiment said extractables comprise tall oil, turpenes or resins that may have added value. In an exemplary embodiment the organic solvent comprises acetone. In an alternative embodiment the solvent comprises a mixture of several solvents. According to the method, the solid aliquots are contacted with liquid aliquots and the solid material typically absorbs water and other components of the respective liquid aliquots, consequently the amount of water in the solid aliquots increases with each performance of the reaction.

At the upstream end, a newly introduced liquid aliquot includes primarily aqueous acid solution. In some embodiments, this solution has been recycled and may include small residual amounts of CH from a previous use. Further downstream, each liquid aliquot includes aqueous acid solution and CH resulting from one or more previous contacting (i.e. hydrolysis) events. In some exemplary embodiments, the liquid aliquot introduced into reactor R(n) is a fresh aqueous acid solution. When the term “fresh aqueous acid solution aliquot” is used, said aliquot may nevertheless comprise previously unused acid, regenerated acid or a mixture.

The liquid introduced into reactor R(n), resides in the reactor in contact with the solid aliquot for a certain, effective, residence time, to provide for hydrolysis of insoluble polysaccharides. In an exemplary embodiment, residence time is determined by the longest residence time of liquid aliquots L(m) . . . L(m-x) in contact with IPS aliquots F(m, x) . . . F(m−x, 0), respectively. In an exemplary embodiment residence time of a fraction of an aliquot, or the majority of the aliquot, is greater than 1 hour, greater than 2 hours or greater than 4 hours. In an exemplary embodiment residence time of a fraction of an aliquot or the majority of the aliquot is less than 10 hours or less than 6 hours.

In an exemplary embodiment said contacting comprises at least one of recycling of the liquid aliquot through the respective reactor, mixing, filtering and centrifugation. In an exemplary embodiment the liquid is introduced from the bottom or the top of the reactors flowing from the bottom (or top) of the reactor towards the top (or bottom) passing through and in contact with the IPS. In an exemplary embodiment separating of the IPS and the outgoing aliquot and the contacting liquid from the IPS is performed by centrifugation.

In an exemplary embodiment, within each contact step in at least one of the reactors, the weight ratio between the contacting liquid aliquot and solid comprising aliquot is larger than 3.

According to several embodiments, separating and/or introducing the liquid aliquots from (or to) the reactors may be performed in step wise mode, and may comprise the use of an intermediate containers holding the separated or introduced liquids. According to other embodiments the liquid aliquots are continuously or semi-continuously or step-wise separated or introduced to or from the reactors, using a pipeline system to direct the liquids between the reactors, using connecting and disconnecting of sections of the pipeline to control the flow of the liquid aliquots between respective reactors.

According to the method, in each of the reactors, insoluble polysaccharide, contacted with an HCl-comprising liquid aliquot is hydrolyzed in a hydrolysis medium to form a carbohydrate enriched liquid aliquot product. According to an exemplary embodiment, said hydrolysis medium is of high HCl concentration. According to an exemplary embodiment, the weight/weight ratio of HCl to (HCl+water) in said hydrolysis medium is at least 0.35, at least 0.39 or at least 0.41.

According to an exemplary embodiment, said hydrolysis is conducted at a relatively low temperature, typically of less than 25° C. Preferably, during at least a fraction of the time the hydrolysis is conducted at even lower temperature, typically of less than 20° C. or of less than 15° C.

As described above, according to the method of the present invention, said hydrolysis is conducted in a counter-current mode of operation. According to an exemplary embodiment a low-carbohydrate HCl solution is contacted with the lignocellulosic material after the majority of its polysaccharides are hydrolyzed, while a carbohydrate-rich HCl solution is contacted with the fresh lignocellulosic material still comprising the majority of its polysaccharides. Optionally, fresh recycled reagent HCl aliquot is added in any of the stages and/or at least a fraction of the hydrolyzate is removed at any of the stages to form an intermediate hydrolyzate.

According to the method hydrolysis of lignocellulosic material is performed in three, partially separated phases; in the first phase the significant portion of the hydrolyzed material in hemicelluloses forms a hydrolyzate with an increased amount of pentoses, in a second phase amorphous and crystalline cellulose are the significant portion of the hydrolyzed material forming a hydrolyzate with increasing amounts of glucose, and in a third phase residual cellulose is hydrolyzed and carbohydrates previously un-extracted from the solid aliquot are extracted by the contacting with the acid-containing liquid aliquots.

In some exemplary embodiments of the invention, the concentration of the acid in the contacted solid and liquid aliquots is increasing with the advancement of the hydrolysis steps, i.e. the combined amount of acid in solid aliquots F(n+i) and L(n+i) in reactor R(n+i) is higher than the combined amount of acid in solid aliquots F(n+j) and L(n+j) in reactor R(n+j), wherein i and j are non-negative integers smaller than x and i≦j. This may be a result of adsorption of acid onto the solid material and, accordingly, acid accumulates in the solid aliquot.

According to an exemplary embodiment the weight/weight ratio of HCl to (HCl+water) in said removed solid aliquot is at least 0.40.

According to the method, the steps of the method may be repeated to allow for continuous forming of products, wherein in each contacting step some of the insoluble polysaccharides are hydrolyzed and accordingly, at the end of at least x reaction steps the net weight amount (weight percent) of insoluble polysaccharides in each reactor is represented by the formula IPS1(n−1)≦IPS1(n)≦ . . . ≦IPS1(n+x−1). According to several embodiments, at the end of at least x reaction steps, the net weight ratio of the amount of insoluble polysaccharides in IPS1(n+x−1) relative to the amount in IPS1(n−1), in the removed solid steam, is greater than 10. In an exemplary embodiment the weight/weight ratio of carbohydrates to solids in said removed solid aliquot is less than 0.03.

The hydrolyzate comprises soluble carbohydrates formed upon the hydrolysis of the polysaccharides of the lignocellulosic material. According to an exemplary embodiment, the relative amounts of hydrolyzing medium and lignocellulosic material and the moisture of the latter are selected so that the concentration of the carbohydrate in the hydrolyzate is relatively high. Thus, according to an exemplary embodiment, in said HCl-comprising hydrolyzate [liquid aliquot L (n+x−1)], the weight/weight ratio of total carbohydrates to (total carbohydrates+water) is at least 0.20, at least 0.25 or at least 0.30.

As is described with respect to the third phase of the hydrolysis, the contacting of the liquid serves also to extract carbohydrates from the solid aliquot to the liquid aliquot and the increase in the of carbohydrates content in the liquid aliquots is greater than the decrease in the amount of insoluble solids in consecutive solid aliquots. According to an exemplary embodiment the ratio between IPS (n−1) and IPS (n) is between 0.95 and 1.0.

According to an exemplary embodiment, after at least x reaction steps the difference between CH(n+x−1) and CH(n+x) is greater than the difference between IPS1(n+x−1) and IPS1(n+x−1). Without limiting to theory this may be the result of washing of adsorbed carbohydrates from the solid aliquot.

According to another exemplary embodiment after at least x reaction steps, for at least one reactor pair [R(n+t), R(n+t+1)], wherein t ranges from 0 to x−2, the difference between CH (n+t) and CH (n+t+1) is greater than the difference between IPS (n+t) and IPS (n+t+1).

According to an exemplary embodiment fresh aqueous acid is added to liquid aliquots to adjust their composition and a fraction of carbohydrate-enriched liquid aliquot L is removed to allow for adjusting quantities or earlier processing of an intermediate aliquot.

According to an exemplary embodiment liquid aliquots L(n+1) . . . L(n+x−1) comprise amounts of acid which, as a result of various processes, such as water adsorption by the liquid aliquots and acid adsorption by the insoluble material, are at least non-increasing. Thus, the relation between the amounts of HCl (n+1) . . . HCl (n+x−1) in the respective liquid aliquots L (n+1) . . . L (n+x−1) is represented by the formula HCl (n+1)≧HCl (n+2)≧ . . . ≧HCl(n+x−1).

In an exemplary embodiment, at the end of at least x reaction steps the relation between the amounts of CH (n+1) . . . CH (n+x−1) in the respective liquid aliquots L (n+1) . . . L (n+x−1) is represented by the formula CH (n+1)≦CH (n+2)≦ . . . ≦CH (n+x−1).

In various exemplary embodiments the number of reactors, x, is less than 15, or less than 8 and/or more than 2 or more than 3.

In some exemplary embodiment, the number of reactors that are disconnected for emptying and reloading, or general maintenance, yet participating in the cyclic reaction steps, is higher than one.

Removing of the new solid aliquot F1(n−1) from reactor R1(n−1) involves opening of a reactor and pipeline system comprising large amounts of HCl (e.g. as residual liquid comprising acid or acid adsorbed to the solid, to the ambient). According to an exemplary embodiment removing the new solid aliquot F1(n−1) from reactor R1(n−1) comprises a step of reduction of the acid content in the new solid aliquot F1(n−1).

According to an exemplary embodiment, the removing of the new solid aliquot F1(n−1) from R(n) comprises contacting an HCl comprising solvent with the solid aliquot F1(n−1) to form at least one acid enriched liquid and an acid-depleted solid aliquot. According to another exemplary embodiment this step is followed by additional steps of washing of the formed lignin aliquot.

According to the method, the new solid aliquot F(n−1) is contacted with a solvent-containing aliquot comprising a first solvent (S1) and also referred to as S1-containing aliquot or extractant, wherein S1 has a solubility in water of less than 15% wt, less than 5% wt, less than 2% wt or less than 1% wt.

According to an exemplary embodiment, solvent-containing liquid aliquots are contacted with the solid containing aliquots by at least one of recycling, mixing or centrifugation.

According to an exemplary embodiment, the method comprises multiple separation steps. Any method of separation is suitable. According to an exemplary embodiment, said separation comprises at least one of filtration and centrifugation. Separating according to the method of the present invention optionally comprises forming a separated acid depleted solid aliquot in which lignin is a major solid component, and which therefore is also referred to hereinafter as lignin aliquot or lignin composition, and a separated liquid aliquot.

In preferred embodiments, the ratio between the solid aliquot and the S1-containing aliquot in said contacting is controlled as it affects several processing aspects; inter alia, the degree of solid de-acidification and the cost of the overall de-acidification process. On the one hand, larger proportions of the S1-containing aliquot contribute to a better contact and thus to better transfer of water and HCl and thus to better de-acidification.

Furthermore, the lignin composition formed on said contacting needs to be further treated, including separation of the solid lignin, transfeR (e.g. pumping) to a means where such separating takes place, etc. Treating such an aliquot that contains relatively small particles of swellable (and possibly highly swelled) solid is difficult and a larger liquid volume formed by a larger proportion of the S1-comprising aliquot appears to be preferable. Yet, increasing the proportion of the S1-containing aliquot increases costs related to total volumes handling and the amount of separated liquid aliquot (formed after the separation of solid lignin) to be treated for HCl recovery therefrom, e.g. heated for HCl distillation. Furthermore, on separating HCl from said separated liquid aliquot, an HCl-depleted aliquot is formed and splits into an HCl-depleted heavy aliquot and an HCl-depleted light aliquot. That heavy phase could be used, as such, in the formation of the hydrolysis medium. The larger the amount of HCl and water in that heavy phase, the lower are the costs related to the regeneration of the S1-containing aliquot for further de-acidification of lignin (less of those to be removed from the HCl-depleted light aliquot). However, the larger is the proportion of the S1-containing aliquot in contacting with the lignin aliquot, the smaller is the fraction of water and HCl separating into said HCl-depleted heavy aliquot. The inventors have surprisingly found that high de-acidification yield and suitable handling of the solid-comprising aliquots could be reached at relatively low ratios between the S1-containing aliquot and the lignin (solid) aliquot, avoiding the above-described drawbacks of the high proportions. Thus, according to an exemplary embodiment, the ratio between the S1-containing aliquot and the lignin aliquot is in the range between 0.2 and 5, between 0.25 and 3, between 0.3 and 2 or between 0.4 and 1.1. According to an exemplary embodiment of the invention, in a single stage, comprising contacting the lignin aliquot with the S1-comprising aliquot followed by the separation of the solid lignin, at least 70%, at least 75%, at least 80% or at least 85% of the initial HCl is removed from the lignin aliquot.

The degree (yield) of HCl removal from the lignin aliquot is also dependent on the efficiency of separating the liquid from the solid lignin in said formed lignin composition. It was surprisingly found that separating said liquid, which comprises S1, HCl and water, from the lignin solids of the lignin composition is much easier than separating lignin solids from the aqueous solution, which comprise water and HCl, of the lignin aliquot. Thus, according to an exemplary embodiment, after the acid removal steps, the separated solids, which are still wetted, are of at least 25% wt, at least 30% wt, at least 34% wt or at least 38% wt dry matter.

According to an exemplary embodiment, the separated solid lignin F1(n−1) is wetted with an S1-containing liquid. According to an exemplary embodiment, the method further comprises a step of S1 removal from said solid lignin aliquot by means selected from the group consisting of decantation, filtration, centrifugation, distillation, extraction with another solvent and combinations thereof to form separated S1 and de-solventized solid lignin.

As indicated earlier, S1 solubility in water is limited, e.g. less than 15% wt, less than 5% wt, less than 2% wt or less than 1% wt. According to an exemplary embodiment, in the separated liquid aliquot the water/solvent weight/weight ratio is greater than 0.35, greater than 0.40 or greater than 0.45. Therefore, it was surprisingly found that, according to an important embodiment, said separated liquid aliquot comprises a single liquid phase. The number of phases may depend on the temperature. According to an exemplary embodiment, the separated liquid aliquot comprises a single liquid phase when at 25° C. As indicated earlier, the lignin aliquot comprises solid lignin surrounded with or dispersed in an aqueous solution highly concentrated with HCl. Without wishing to be limited by theory, it is suggested that on said contacting with an S1-containing aliquot at the conditions and compositions of the method of the present invention, the aqueous solution and the S1-containing aliquot, which is essentially organic, are combined into a single liquid phase, which single phase is rich in S1, water and HCl. It is further suggested that said combining into a single liquid phase strongly facilitates the de-acidification of the lignin.

According to an exemplary embodiment the separated S1-containing aliquot may be further treated for recycling and re-use by means of filtration of residual solid impurities, evaporation of acid and water, mixing with HCl, water or S1 of at least a fraction of said aliquot, to control for respective concentrations and for treatments of impurities removal.

According to an exemplary embodiment, the method of the present invention comprises further treating of the removed solid aliquots. According to various embodiments, further treating comprises removal of residual HCl, neutralization of said residual HCl, de-solventization and additional purification. According to an exemplary embodiment, de-solventization comprises centrifugation.

Considerations for materials suitable for use in reactors R of the simulated moving bed system are similar to those set forth hereinabove for the single tower system.

Exemplary Differences Between System Types:

Simulated moving bed systems (e.g. FIGS. 6a to 6d and/or FIG. 8 can be more flexible in terms of operational parameters than the single tower reactors (e.g. FIG. 1 and/or FIG. 17). However each reactor R in a simulated moving bed system typically uses 2 pumps and 12 valves. In contrast, a single tower system typically uses two valves and two pumps. As a result, it can be significantly less expensive to construct and/or maintain a single tower system than a simulated moving bed system with a similar processing capacity.

Additional Exemplary Method:

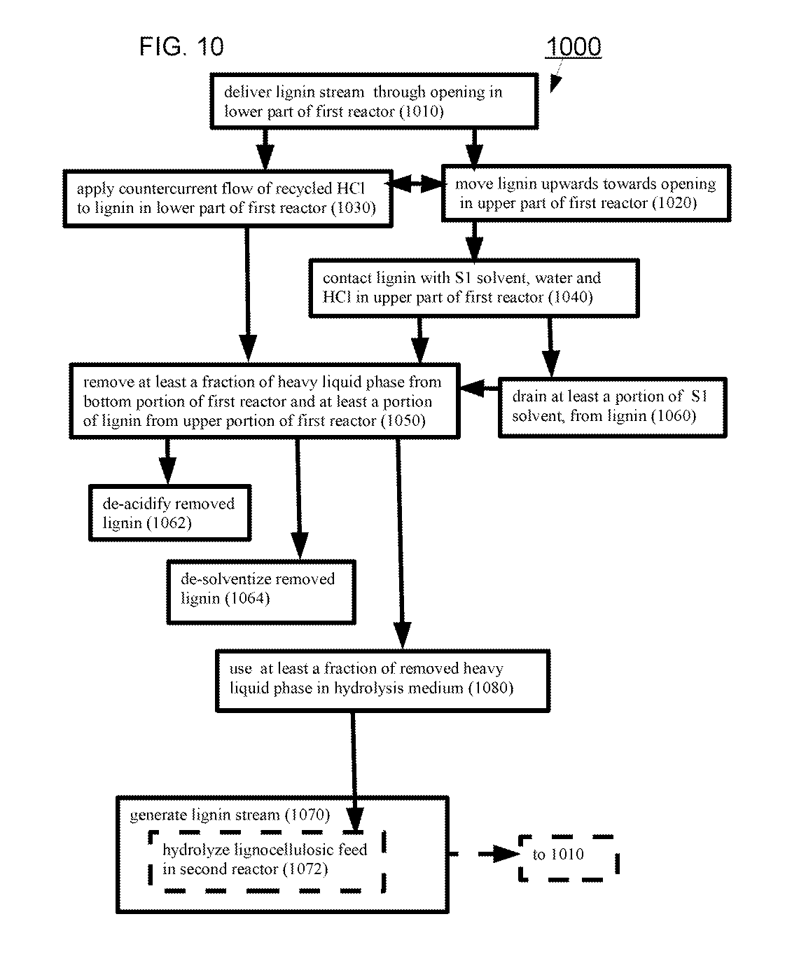

FIG. 10 is a simplified flow diagram of a method for reducing an amount of HCl associated with lignin produced by acid hydrolysis of a lignocellulosic substrate depicted generally as method 1000.

Depicted exemplary method 1000 includes delivering 1010 a lignin stream comprising solid lignin through at least one opening located at a lower part of a first reactor. According to various exemplary embodiments of the invention the amount of solid lignin in the stream varies. In some embodiments, the amount of solid lignin is greater than 3, greater than 5, greater than 10, greater than 15 or greater than 20%. Alternatively or additionally, the amount of solid lignin in the stream is less than 30, less than 25, less than 20, or less than 15% in some embodiments.

Depicted exemplary method 1000 includes moving 1020 the solid lignin upwards towards at least one opening located at an upper part of the first reactor and applying 1030 a countercurrent flow of recycled HCl to the solid lignin in the lower part of the first reactor. In some exemplary embodiments of the invention, HCl is recycled from a previously treated lignin stream and/or a previously treated acid hydrolyzate of a lignocellulosic substrate.

Depicted exemplary method 1000 also includes contacting 1040 the solid lignin with a light organic liquid phase. The light organic liquid phase includes an S1 solvent and may include water and/or HCl dissolved in the S1 solvent. Due to a difference in specific gravities, the light organic liquid phase tends to float upwards so that contacting 1040 occurs in the upper part of the first reactor.

Depicted exemplary method 1000 also includes removing 1050 at least a fraction of a heavy liquid phase from the bottom portion of the first reactor and removing 1050 at least a portion of the solid lignin from the upper portion of the first reactor.

In some exemplary embodiments of the invention, contacting 1040 prior to removing 1050 reduces an amount of acid associated with the solid lignin. Alternatively or additionally, in some exemplary embodiments of the invention, at least a fraction of a heavy liquid phase removed (1050) is used 1080 in hydrolysis of lignocelluloses. In some embodiments, this hydrolysis occurs in one or more additional reactors.

Depicted exemplary method 1000 also includes draining 1060 at least a portion of the light organic liquid phase from the solid lignin prior to removing 1050. Optionally, draining 1060 includes lifting the solid lignin through a headspace in the first reactor which is empty of liquid. In these exemplary embodiments of the invention, additional lignin moving upwards in the reactor pushes some solid lignin above the liquid level into the headspace. Liquid associated with the solid lignin above the liquid level tends to drain downwards.

Some exemplary embodiments of method 1000 include generating 1070 the lignin stream. Optionally, generating 1070 includes hydrolyzing 1072 a lignocellulosic feed in at least one second reactor. In some exemplary embodiments of the invention, this hydrolysis forms both a lignin stream and an acidic hydrolyzate containing soluble sugars.

According to various exemplary embodiments of the invention the lignin stream is essentially free of cellulose or contains varying degrees of un-hydrolyzed cellulose.

In some exemplary embodiments of the invention, the lignin stream is provided as a suspension of solid lignin in recycled acid.

In the first reactor an additional recycled acid stream is introduced via at least one acid introduction port located above the point where the lignin stream enters the reactor, but below the point where the lignin stream exits the reactor.

Alternatively or additionally, the first reactor includes at least one drain for removing 1050 at least a fraction of the heavy liquid phase. In some exemplary embodiments of the invention, increasing a height difference between the acid introduction port and the drain contributes to an increase in hydrolysis of residual cellulose associate with lignin in the lignin stream.

In some embodiments, heavy liquid phase removed at 1050 is enriched with at least one soluble sugar relative to the additional recycled acid stream and/or removed solid lignin may have less cellulose associated with it than when it entered the reactor.

In some exemplary embodiments of the invention, the heavy liquid phase comprises HCl/water at a weight/weight ratio greater than 0.5.

In some exemplary embodiments of the invention, a weight ratio of carbohydrates to lignin in the removed solid lignin is less than 90% of a same ratio in said lignin stream which flows through at least one opening located at a lower part of said first reactor.

In some exemplary embodiments of the invention, hydrolyzing 1072 includes contacting the lignocellulosic feed with a hydrolysis medium in at least one second reactor in a countercurrent mode.

In some embodiments, the lignocellulosic feed moves down and the hydrolysis medium moves up in the at least one second reactor. In some exemplary embodiments of the invention, at least a fraction of the removed heavy liquid phase is used 1080 the hydrolysis medium.

In some exemplary embodiments of the invention, the at least one second reactor can be a single continuous flow reactor (e.g. of the type depicted in FIG. 1). In some embodiments, the lignin stream comprises cellulose. In other exemplary embodiments of the invention, the at least one second reactor is provided as a simulated moving bed reactor (e.g. of the type depicted in FIGS. 6a to 6d and/or 7a to 7c and/or 8).

In some embodiments, method 1000 includes de-acidifying 1062 the removed solid lignin. According to various exemplary embodiments of the invention de-acidifying 1062 may include additional contacting with an S1 solvent containing liquid and/or evaporation of HCl and/or distillation of HCl. In some exemplary embodiments of the invention, de-acidifying 1062 is conducted at a pressure greater than 0.7 bar and/or at a temperature lower than 140° C.

In some embodiments, method 1000 includes de-solventizing 1064 the removed solid lignin. According to various exemplary embodiments of the invention, de-solventizing 1064 may include evaporation and/or distillation of the solvent. In some exemplary embodiments of the invention, de-solventizing 1064 is conducted at a pressure greater than 0.7 bar and at a temperature lower than 140° C.

Additional Exemplary System:

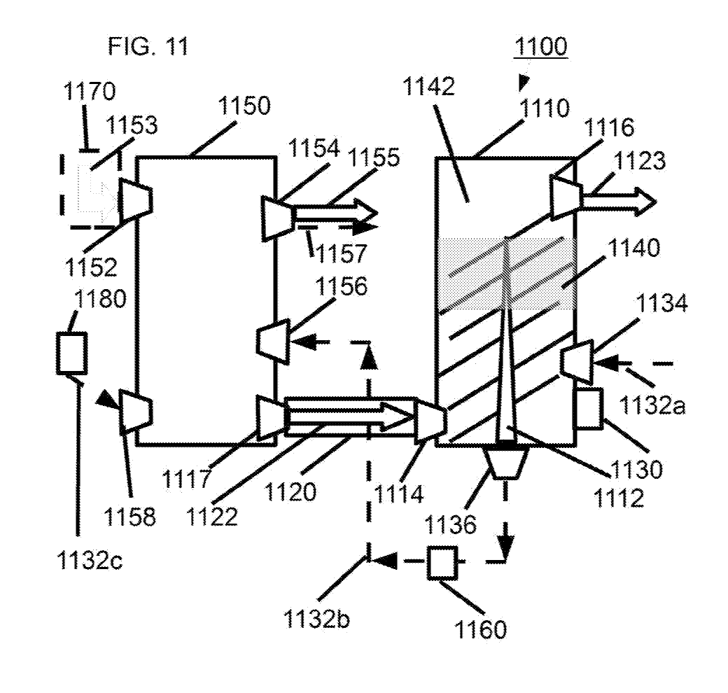

FIG. 11 is a schematic diagram of a lignin processing apparatus indicated generally as 1100. Apparatus 1100 is suitable for the practice of method 1000 described hereinabove, although method 1000 may also be practiced using other apparatus. Depicted exemplary apparatus 1100 includes a (first) lignin wash vessel 1110. In the depicted embodiment, vessel 110 is equipped with a lignin lifting mechanism 1112 adapted to convey solid lignin from a lignin introduction port 1114 to a lignin evacuation port 1116. Mechanism 1112 is depicted in the drawing as an auger, although other types of mechanisms, such as conveyor belts or rotating wheels with protruding fins could be employed.

Depicted exemplary apparatus 1100 also includes a lignin delivery mechanism 1120 adapted to convey a lignin stream 1122 including the solid lignin into wash vessel 1110 via lignin introduction port 1114. The nature of lignin delivery mechanism 1120 may vary according to the amount of solid lignin in lignin stream 1122.

For dilute streams 1122, mechanism 1120 may be a simple pipe or conduit. According to various exemplary embodiments of the invention, flow of a dilute stream 1122 through such a pipe may be due to gravity, or aided by a pump.

For more concentrated streams 1122, which are more viscous due to a high solids content, mechanism 1120 may include an auger or conveyor.

Depicted exemplary apparatus 1100 also includes acid wash mechanism (depicted here as pump 1130) adapted to cause an acidic wash stream 1132a to flow from an acid introduction port 1134 to a drain 1136. Acidic wash stream 1132a can be provided as a recycled acid stream. Recycling of HCl is described hereinabove in the context of absorber 192 and/or in co-pending application PCT/IL2011/000424 which is fully incorporated herein by reference.

Depicted exemplary apparatus 1100 also includes a solvent wash layer 1140. Wash layer, or cushion, 1140 includes an S1 solvent. In some embodiments, water and/or HCl are dissolved in the solvent. Layer 1140 is situated above acid introduction port 1134 and below lignin evacuation port 1116.

As lifting mechanism 1112 raises solid lignin above wash layer 1140 into headspace 1142, liquid associated with the lignin flows back down to layer 1140. Washed lignin stream 1123 exits via port 1116. In theory, there is no loss of S1 solvent from wash layer 1140. In actual practice, some losses may occur. In some embodiments, S1 solvent in wash layer 1140 is replenished to compensate for these losses.

In the depicted exemplary embodiment, wash vessel 1110 is provided as part of a system which includes a hydrolysis reactor 1150 adapted to provide lignin stream 1122 to lignin delivery mechanism 1120.

Hydrolysis reactor 1150 is depicted as a single continuous flow reactor (e.g. of the type depicted in FIG. 1). In some exemplary embodiments of the invention, reactor 1150 is provided as a simulated moving bed reactor (e.g. of the type depicted in FIGS. 6a to 6d and/or 7a to 7c and/or 8).

In the depicted exemplary system, recirculation pump 1160 conveys an effluent 1132b from drain 1136 to a recirculation port 1156 in hydrolysis reactor 1150. Effluent 1132b is similar in composition to acidic wash stream 1132a except that it may be enriched in soluble sugars and/or diluted in terms of acid concentration. Such enrichment and/or dilution can stem, at least in part, from hydrolysis of cellulose present in lignin stream 1122.

In the depicted exemplary system, hydrolysis reactor 1150 includes a feed mechanism 1170 adapted to deliver a lignocellulosic substrate 1153 thereto via feed port 1152. Mechanism 1170 may include, for example a conveyor belt and/or an auger.

In the depicted exemplary embodiment, hydrolysis reactor 1150 includes a hydrolysis medium supply mechanism 1180 adapted to deliver a flow 1132c of ≧35% HCl to the reactor. According to various exemplary embodiments of the invention the concentration of HCl/[HCl+H2O] in flow 1132c is 37, 39, 41, 43, 45 or 47% or intermediate or greater percentages. In some exemplary embodiments of the invention, flow 1132c includes recycled HCl as described above in the context of 1132a.

During operation, lignocellulosic substrate 1153 moves downwards in reactor 1150 while acid streams 1132b and 1132 c move upwards. As a result of this countercurrent flow, cellulose in substrate 1153 is hydrolyzed to release soluble sugars and water, which begin to flow upwards.

The result of this process is that lignin stream 1122 containing solid lignin exits reactor 1150 at the bottom (e.g. via port 1117) while soluble sugars 1155 and relatively dilute acid 1157 exit reactor 1150 near the top of reactor 1150, e.g. via port 1154. Soluble sugars 1155 and relatively dilute acid 1157 are depicted separately for clarity, although the sugars are dissolved in the aqueous acid. According to various exemplary embodiments of the invention relatively dilute acid 1157 may still be 28, 30, 32, or 34% HCl/[HCl+water] or intermediate or greater percentages.

In some exemplary embodiments of the invention, sugars 1155 are separated from acid 1157 and the acid may be concentrated and recycled (e.g. at 1132a and/or 1132c. Separation of acid from sugars may involve contacting with an extractant containing an S1 solvent and/or distillation.

In an industrial context, recycling of S1 solvent can be an important consideration. Exemplary S1 recycling methods are described in co-pending application PCT/US2011/46153 which is fully incorporated herein by reference.

Exemplary Other Considerations

In some exemplary embodiments of the invention, sugar yield is intentionally reduced by 2, 3, 4, 5 or even 10% in order to increase a capacity to process the lingo-cellulosic substrate. According to these exemplary embodiments of the invention, the increase in processing capacity compensates for a sugar yield below what is theoretically possible if the hydrolysis reaction is complete. In some embodiments, increased processing rate contributes to a reduced capital expenditure per unit of sugar received. Alternatively or additionally, residual cellulose and/or hemicellulose on the lignin can contribute to an increased value of the lignin.

As used herein the term “about” refers to ±10%; optionally; ±5%; optionally ±1%; optionally ±0.1%.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims. Specifically, the invention has been described in the context of hydrolysis of lignocellulosic substrates with HCl but might also be used with other acids and/or other substrates amenable to acid hydrolysis.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

Additional objects, advantages, and novel features of various embodiments of the invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following example, which together with the above descriptions; illustrate the invention in a non limiting fashion.

### MATERIALS AND METHODS

The following materials and methods are used in performance of experiments described in examples hereinbelow:

HCl: 42% HCl (W/W) prepared from commercially available 37% HCl enriched with HCl gas. Once the system is running, HCl is recycled.

Hydrolysis substrate: Chips of pine wood of roughly 1.25 cm largest dimension.

### Example 1

### Pilot Scale Simulated Moving Bed System

In order to confirm the viability of systems of the type depicted in FIGS. 6a to 6d and 4 using trickling bed reactors of the type depicted in FIG. 7, a pilot system was constructed and tested.

The pilot system included 7 reactors 7300 and an upstream “hydration vessel”. Each reactor was a vertical cylinder with height (h) of 228.6 cm and diameter (d) of 45.72 cm. This configuration gives an approximate internal volume of 375.3 liters and a horizontal cross-sectional area of approximately 1641.7 cm². The aspect ratio h:d of the reactor is 5.0.

Hydration was conducted by loading the hydration vessel with 31.8 kilos of pine wood chips and submerging it in acidic effluent from the most downstream reactor.

During hydrolysis 540 (FIG. 9), L is circulated in each reactor at a rate of 17.8 liters/minute.

L provided in the most upstream reactor was cooled to a temperature of 12° C. During system operation, a temperature gradient formed so that a temperature in the most downstream reactor stabilized at about 22° C.

During system operation, each new volume of L introduced 570 into reactor 300 was 151.4 Liters. New introductions were conducted every 4 hours. Liquid phase L progressed downstream through the reactors at an average rate of 37.85 liters/hour. Under these conditions, the average residence time of liquid in the system is about 16 hours.

At any given moment, the volume of liquids in a downstream reactor may be greater due to addition of CH released by hydrolysis and/or water released from solids F.

Introduction 590 of additional amounts of substrate F was conducted every 4 hours in the most downstream reactor using 31.8 kilos of pine wood chips. Assuming a specific gravity of roughly 0.5, this represents about 63.6 liters of solids.

This Example illustrates that systems and methods according to exemplary embodiments of the invention can be used to efficiently recover soluble carbohydrates from available woody and/or cellulose based substrates. In addition, these results establish that acid hydrolysis of such substrates can be conducted at or below room temperature under conditions of normal atmospheric pressure.

### Example 2

### Theoretical Scale Up Calculation For Simulated Moving Bed System

In order to expand the capacity of the system described in Example 1 from 7.95 kilos of woody substrate per/hour to 60000 kilos of substrate per hour, a scale up of 7547.2 times is needed. This means that the desired reactor volume is 2832453 liters.

Assuming that the h:d aspect ratio of 5 is to be retained, a reactor with a diameter of about 896.8 cm and a height of about 4484 cm should be constructed. This reactor will have a cross sectional area of 631656 cm². It is believed that a recirculation rate increased in proportion to this area is desired in order to preserve the trickling bed effect described in Example 1. Calculation suggests that a recirculation rate of 6848 liters/minute is appropriate for the proposed scaled up reactor.

It is believed that this structure will preserve the desirable effects of the trickling bed design during scale-up.

### Example 3

### Kinetics of Hydrolysis of Wood with 35% HCl at 35° C.

In order to simulate reaction conditions in the trickling bed portion of an exemplary reactor (i.e. above line S-S in FIG. 1) hammer milled yellow pine was steam exploded and extracted with acetone then hydrolyzed with 35% HCl for different periods of time (2, 4, 6, 8, and 10 h) at 35° C. while stirring. These conditions are similar to some exemplary embodiments of the trickling bed portion of the reactor in terms of temperature and acid concentration.

However, in this simulation, the ratio of acid to wood was 10:1. The stirring in a large excess of acid simulates to some extent removal of acid via port 140 in FIG. 1.

The content of dissolved sugars in the liquid was determined at different time points and the percentage of sugars remaining on the wood as insoluble carbohydrates (e.g. cellulose and/or hemicellulose) was calculated by difference.

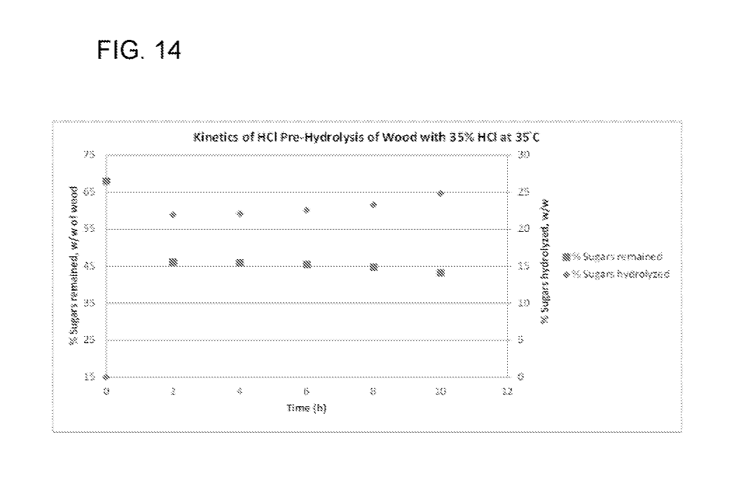

Results are summarized graphically in FIG. 14. After 2 hours in 35% HCl, about 22% of the original wood weight has been hydrolyzed to soluble sugars. Assuming the wood was originally about 68% polymeric carbohydrates, this is roughly a 32% hydrolysis yield relative to a theoretical maximum.

Continuing the reaction for an additional 8 hours under the same conditions increases the yield of soluble sugars only marginally.

These results suggest that a relatively short residence time of solids (e.g. 1, 2, 3, or 4 hours or intermediate times) in the trickling bed portion of the reactor is sufficient to produce a significant yield of soluble sugars. Alternatively or additionally, the majority of these sugars are expected to be hemicellulose sugars (e.g. arabinose, mannose and xylose) which are prone to degradation. The proposed trickling bed mechanism offers the possibility of removing these sugars only a short time after they go into solution so that they can be de-acidified prior to degradation.

### Example 4

### Kinetics of Hydrolysis of Wood in 42% HCl

In order to simulate reaction conditions in a counter current flow portion of an exemplary reactor (i.e. below line S-S in FIG. 1) wood was hydrolyzed with 42% HCl for different periods of time at 11° C. with stirring. The acid to wood ratio was 10:1.

The wood was hammer milled yellow pine, steam exploded and extracted with acetone as in an Example 3. This wood was either used “as is” or hydrolyzed with 35% HCl at 25° C., for 8 h or with 35% HCl at 35° C., for 6 h while stirring. These “pre-hydrolysis” conditions were selected to simulate some exemplary embodiments of the trickling bed portion of the reactor in terms of temperature and acid concentration as indicated above.

TABLE 1
NMR analysis of solid phase after hydrolysis at various
times showing % residual Sugars (w/w of total sugars)

| | Substrate | | |
|---|---|---|---|
| Time | Wood | Pre-hydrolysis: | Pre-hydrolysis: |
| (h) | “as is” | 35% HCl, 25° C., 8 h | 35% HCl, 35° C., 6 h |
| 0 | 100 | 65 | 66 |
| 2 | 40 | 13 | 12 |
| 4 | 26 | — | — |
| 6 | — | 4 | 7 |
| 10 | — | 1 | — |
| 12 | 3 | — | — |
| 16 | 1 | 1 | 1 |
| 20 | 1 | 0 | 1 |
| 24 | 1 | — | — |
| 28 | 1 | — | — |

The solid was analyzed by solid-state ¹³C NMR spectroscopy for residual sugars at different time points. This method is semi-quantitative and the numbers should not be taken as absolute values. They are relative to the original amount of sugars in wood.

The NMR analysis was done on wood, and the area between 80-68 ppm, which represents C2, 3, and 5 of cellulose, was integrated. The integral area was set to 68%, which is the amount of carbohydrates in wood. The same was done to all other samples and the integral values were calculated relative to the 68%.

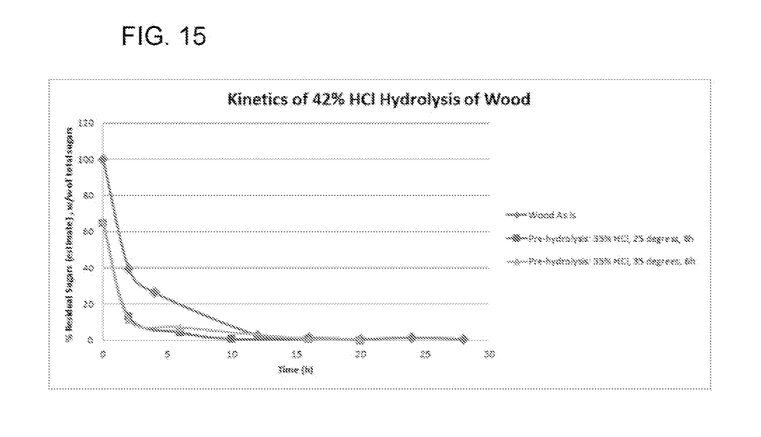

FIG. 15 graphically summarizes the kinetics of HCl hydrolysis of the various wood samples. For the pre-hydrolyzed samples time 0 represents the end of the pre-hydrolysis. The same data is presented numerically in Table 1.

The “as is” wood was rapidly hydrolyzed in the first two hours, followed by a decrease in the hydrolysis rate. Since there was no “pre-hydrolysis” of the “as is” sample, it is presumed that much of the sugars released in the first two hours originates from hemicellulose, and that the hydrolysis kinetics slow as greater amounts of amorphous cellulose and crystalline cellulose are hydrolyzed.

Surprisingly, the two pre-hydrolyzed samples, which are presumably free of hemicellulose sugars, exhibit hydrolysis kinetics similar to those of the “as is” wood during the first two hours in 42% HCl.

These results suggest that “pre-hydrolysis” of wood somehow alters the properties of amorphous and/or crystalline cellulose. The cellulose in pre-hydrolyzed wood appears to be more easily hydrolyzed as a result of this alteration.

### Example 5

Kinetics of Sugar Degradation in 35% HCl

The results presented in Example 3 indicated that there are a significant amount of sugars released from wood by hydrolysis in 35% HCl during the first two hours of incubation at 35° C., but that a small amount of additional sugars are released during eight additional hours. In order to determine if there is any degradation of the released sugars, the hydrolysis of Example 3 was repeated and furfural concentration in the liquid phase was measured. The percentage of furfurals in solution and total sugar percentage in wood are plotted as a function of time in FIG. 16.

These results indicate that about 2% furfurals are present at two hours and that this concentration increases slightly over time. Since there are about 68% sugars in wood, 2% furfurals relative to the weight of wood is about 3.3% of total sugars. Assuming that the majority of furfurals come from degradation of hemicellulose sugars, 2% furfurals represents about 10-12% of hemicellulose sugars.

These results suggest that it may be advantageous to shorten the residence time of liquids in the trickling bed portion of the reactor as a way to limit undesired degradation of hemicellulose sugars to furfurals.

1. A hydrolysis system comprising:
(a) a reactor vessel including a sprinkler at an upper portion thereof and a drain;
(b) a pump re-circulating a flow of an acidic reaction liquid from a selected height in said vessel to said sprinkler;
(c) an acid supply mechanism delivering a supply of HCl at a concentration≧39% to a lower portion of said reactor vessel; and
(d) a flow splitter diverting a portion of the acidic reaction liquid so that a level of liquid in the vessel remains in a predetermined range.

2. The system of claim 1, comprising a substrate delivery module delivering a hydrolysis substrate to said vessel.

3. The system of claim 1, comprising a cooling module to cool said supply of HCl.

4. The system of claim 4, wherein said cooling module cools said supply of HCl to ≦18° C.

5. The system of claim 1, further comprising a controller adapted to maintain a maximum temperature in said vessel in a predetermined range.

6. The system of claim 5, wherein said predetermined range includes only temperatures≧20° C.

7. A hydrolysis method comprising:
(a) placing a hydrolysis substrate comprising cellulose in a reactor vessel;
(b) removing at least 90% of available sugars in said substrate from said vessel in solution with a residence time≦16 hours.

8. The method of claim 7, further comprising removing residual solids from said vessel with an average residence time≦14 hours.

9. The method of claim 7, further comprising removing ≧90% of available pentoses in said hydrolysis substrate intact.

10. The method of claim 7, further comprising removing ≧50% of available glucose in the substrate from the vessel with a residence time≦6 hours.

11.-12. (canceled)

13. An apparatus comprising:
(a) a reactor vessel comprising a substrate delivery module adapted to deliver a hydrolysis substrate to an upper portion of said vessel;
(b) an acid delivery system configured to deliver a stream of concentrated HCl to a lower portion of said vessel;
(c) a recirculation pump configured to provide a flow of acidic reaction liquid from a single selected height in said vessel to a location in the upper portion of said vessel; and
(d) a drain.

14. The apparatus of claim 13, wherein said flow from said recirculation pump is directed to a sprinkler.

15. The apparatus of claim 13, further comprising a flow splitter which directs a portion of said flow to a downstream processing module.

16. The apparatus of claim 13, further comprising a cooling module adapted to cool said stream of concentrated HCl.

17. The apparatus of claim 16 wherein said cooling module is adapted to cool said stream of HCl to ≦18° C.

18. The apparatus of claim 13, further comprising a controller adapted to regulate said substrate delivery module and said drain to maintain an amount of substrate in said vessel in a pre-determined range.

19. The apparatus of claim 13, further comprising a controller adapted to maintain a maximum temperature in said vessel in a predetermined range.

20. The apparatus of claim 19, wherein said predetermined range includes only temperatures≧20° C.

21. The apparatus of claim 13, further comprising an upstream hydration module.

22. The apparatus of claim 21, further comprising a substrate controller adapted to control a flow of substrate through said hydration module and said reactor vessel.

23.-92. (canceled)
